(19) United States
(12) Patent Application Publication
(10) Pub. No.: US 2025/0222324 A1
(43) Pub. Date: Jul. 10, 2025

(54) METHOD AND SYSTEMS FOR MANUFACTURING A GOLF CLUB HEAD

(71) Applicant: Cobra Golf Incorporated, Carlsbad, CA (US)

(72) Inventors: Ryan L. Roach, Encinitas, CA (US); Linqing Huang, GuangDong Province (CN); Michael S. Yagley, Carlsbad, CA (US); Michael T. McDonnell, Carlsbad, CA (US); Bryce W. Hobbs, Escondido, CA (US)

(21) Appl. No.: 19/093,814

(22) Filed: Mar. 28, 2025

Related U.S. Application Data
(63) Continuation-in-part of application No. 18/593,055, filed on Mar. 1, 2024.
Application No. 18/593,055 is a continuation-in-part of application No. 18/139,294, filed on Apr. 25, 2023.
(60) Provisional application No. 63/441,550, filed on Jan. 27, 2023.
(60) Provisional application No. 63/542,984, filed on Oct. 6, 2023.

(51) Int. Cl. A63B 53/04

(52) U.S. Cl. CPC A63B 53/0475; A63B 2053/0491

(57) ABSTRACT

A golf club includes a body defining an internal cavity and includes a toe side, a heel side, a top side, a bottom side, a front side, and a rear side. A first support structure is disposed within the internal cavity and includes a plurality of beams. A second support structure is disposed within an external cavity that is positioned on the rear side of the body and is visible from an exterior of the body. A first pocket and a second pocket are formed on the bottom side. The first pocket is at least partially defined by a first wall and the second pocket is at least partially defined by a second wall. A first aperture and a second aperture are in fluid communication with the internal cavity. The first aperture extends through the first wall and the second aperture extends through the second wall.

### CROSS REFERENCE TO RELATED APPLICATIONS

The present application is a continuation-in-part of U.S. patent application Ser. No. 18/593,055, filed on Mar. 1, 2024, which is a continuation-in-part of U.S. patent application Ser. No. 18/139,294, filed on Apr. 25, 2023, which claims the benefit of and priority to U.S. Provisional Application No. 63/441,550, filed on Jan. 27, 2023, and further claims the benefit of and priority to U.S. Provisional Application No. 63/542,984, filed on Oct. 26, 2023, which are herein incorporated by reference in their entirety.

### REFERENCE REGARDING FEDERALLY SPONSORED RESEARCH OR DEVELOPMENT

Not applicable

### SEQUENCE LISTING

Not applicable

### BACKGROUND

### 1. Field of the Disclosure

The present disclosure relates to golf clubs, and more specifically to a golf club, a golf club head, and/or components thereof that include pockets and apertures.

### 2. Description of the Background

Different types of golf clubs (e.g., irons, drivers, fairway woods, utility irons, hybrid irons/woods, wedges, putters, etc.) are used to effect different types of shots, based on a golfer's location and ball lie when playing a hole on a golf course. Typically, conventional golf club heads are formed by a forging process, a casting process, a metal injection molding process, or a machining process (e.g., milling), and then machined, ground, and/or polished to a factory finish standard (e.g., dimensions, loft, lie, weight, offset, surface finish, aesthetics, etc.).

A need exists for golf club heads to include weights by injecting materials into pockets. Further, a need exists to remove internal powdered material from the manufacturing process.

### SUMMARY

The present disclosure is directed to golf club heads and/or components.

In some aspects, a method for producing a golf club component includes receiving a selection of at least one parameter from a user via a user interface. The at least one parameter is selected from a plurality of parameters. The method further includes generating a design model of the golf club component based on the selected parameter, providing the design model of the golf club component to an additive manufacturing device, and forming the golf club component via the additive manufacturing device.

In some aspects, a method for producing a golf club component includes outputting golf club options to a user via a user interface, receiving a selection of one or more of the golf club options from the user, and generating a design model of a golf club component based on the selection. The method can further include updating the design model of the golf club component based on performance data of the user, providing the updated design model of the golf club component to an additive manufacturing machine, and forming the golf club component via the additive manufacturing machine.

In some aspects, a system for producing golf club components includes a processor and a computer-readable storage medium containing instructions. The instructions contained within the computer-readable storage can, when executed by the processor, cause the system to: receive information from a user, compare the information to a database correlating information and golf club options, output golf club options to the user, receive golf club selections, and generate golf club design models based on golf club selections. The instructions can, when executed by the processor, cause the system further to: mint non-fungible tokens to a blockchain ledger that are associated with virtual objects and metadata, including golf club component design models, and output golf club component design models associated with non-fungible tokens.

In some aspects, a non-transitory computer-readable medium storing instructions for an additive manufacturing machine can, when executed by the additive manufacturing machine, cause the additive manufacturing machine to form a golf club head of a golf club. The golf club head can include a body and a lattice structure formed in an interior void of the body such that the lattice structure is entirely enclosed within the body.

In some aspects, a golf club includes a golf club head. The golf club head can include a body. The body can define an internal cavity. The body can include a toe side, a heel side, a top side, a bottom side, a front side, and a rear side. A first support structure can be disposed within the internal cavity of the body. The first support structure can include a plurality of beams. A second support structure can be disposed within an external cavity that can be positioned on the rear side of the body. The second support structure can be visible from an exterior of the body. A first pocket and a second pocket can be formed on the bottom side of the body. The first pocket can be at least partially defined by a first wall and the second pocket can be at least partially defined by a second wall. A first aperture and a second aperture can be in fluid communication with the internal cavity of the body. The first aperture extends through the first wall of the first pocket and the second aperture extends through the second wall of the second pocket.

In some aspects, a golf club includes a golf club head. The golf club head can include a body. The body can define an internal cavity. The body can include a toe side, a heel side, a top side, a bottom side, a front side, and a rear side. A first support structure can be disposed within the internal cavity of the body. The first support structure can include a plurality of beams. A second support structure can be disposed within an external cavity that can be positioned on the rear side of the body. The second support structure can be visible from an exterior of the body. A toc pocket and a heel pocket can be formed on the bottom side of the body. The toe pocket can be at least partially defined by a first wall and the heel pocket is at least partially defined by a second wall. A first aperture and a second aperture can be in fluid communication with the internal cavity of the body. Each of the first aperture and second aperture can extend through the first wall of the first pocket.

In some aspects, a golf club includes a golf club head. The golf club head can include a body. The body can define an internal cavity. The body can include a toe side, a heel side, a top side, a bottom side, a front side, and a rear side. A first support structure can be disposed within the internal cavity of the body. The first support structure can include a plurality of beams. A second support structure can be disposed within an external cavity that can be positioned on the rear side of the body. The second support structure can be visible from an exterior of the body. A first pocket and a second pocket can be formed on the bottom side of the body. The first pocket can be at least partially defined by a first wall and the second pocket is at least partially defined by a second wall. A toe cap can be configured to be attached to the toe pocket to retain a first weight element and a heel cap that is configured to be attached to the heel pocket to retain a second weight element. The top cap has a top cap opening that can be in fluid communication with the toe pocket and a heel cap has a heel cap opening that can be in fluid communication with the heel pocket.

### BRIEF DESCRIPTION OF THE DRAWINGS

FIG. 1 is a rear, bottom, toe isometric view of a golf club head, according to an embodiment of the present disclosure;

FIG. 2 is a front elevational view of the club head of FIG. 1;

FIG. 3 is a rear, top, left isometric view of a golf club head as-printed, according to another embodiment of the present disclosure;

FIG. 4 is a top plan view of the golf club head of FIG. 3;

FIG. 5 is a bottom plan view of the golf club head of FIG. 3;

FIG. 6 is a left side elevational view of the golf club head of FIG. 3;

FIG. 7 is a right side elevational view of the golf club head of FIG. 3;

FIG. 8 is a front elevational view of the golf club head of FIG. 3;

FIG. 9 is a rear elevational view of the golf club head of FIG. 3;

FIG. 10 is a front, top, and right isometric view of the golf club head, according to another embodiment of the present disclosure;

FIG. 11 is a rear, top, and left isometric view of the golf club head of FIG. 10;

FIG. 12 is a top plan view of the golf club head of FIG. 10;

FIG. 13 is a bottom plan view of the golf club head of FIG. 10;

FIG. 14 is a left side elevational view of the golf club head of FIG. 10;

FIG. 15 is a right side elevational view of the golf club head of FIG. 10;

FIG. 16 is a front elevational view of the golf club head of FIG. 10;

FIG. 17 is a rear elevational view of the golf club head of FIG. 10;

FIG. 18 depicts a flowchart showing a method for attaching a weight to a body of the golf club of FIG. 3;

FIG. 19 is a detail view of an external lattice structure of FIG. 10;

FIG. 20 is a cross-sectional view of the golf club head taken along plane 20-20 of FIG. 10;

FIG. 21 is a detail view of a portion of the cross-sectional view of the golf club of FIG. 20;

FIG. 22 is a cross-sectional view of the golf club head taken along plane 22-22 of FIG. 4;

FIG. 23 is a cross-sectional view of the golf club head taken along plane 23-23 of FIG. 10;

FIG. 24 is a cross-sectional view of the golf club head taken along plane 24-24 of FIG. 10;

FIG. 25 is a cross-sectional view of the golf club head taken along plane 25-25 of FIG. 10;

FIG. 26 is a cross-sectional view of the golf club head taken along plane 26-26 of FIG. 10;

FIG. 27 is a cross-sectional view of the golf club head taken along plane 27-27 of FIG. 10;

FIG. 28 is a top, front, right isometric view of a lattice environment for use with the golf club heads discussed herein;

FIG. 29 is a first view of the golf club head of FIG. 3 inlaid within the lattice environment taken along a plane that is parallel with respect to the YZ-plane of FIG. 28;

FIG. 30 is a second view of the golf club head of FIG. 3 inlaid within the lattice environment taken along a plane that is parallel with respect to the XY-plane of FIG. 28;

FIG. 31 is a cross-sectional view of the golf club head of FIG. 3 inlaid within the lattice environment taken along a plane that is parallel with respect to the XZ plane of FIG. 28;

FIG. 32 is a perspective view of the golf club head of FIG. 3 including lattice structures formed from a lattice array of the lattice environment of FIGS. 29-31;

FIG. 33 depicts a flowchart for an example method of providing a golf club component in accordance with some embodiments of the present disclosure;

FIG. 34 depicts an example of a flowchart for another method of providing a golf club component in accordance with some embodiments of the present disclosure;

FIG. 35 depicts a flowchart for yet another method of providing a golf club component in accordance with some embodiments of the present disclosure;

FIG. 36 depicts a flowchart for still another method of providing a golf club component in accordance with some embodiments of the present disclosure;

FIG. 37 depicts a schematic representation of a system for providing a golf club component in accordance with some embodiments of the present disclosure;

FIG. 38 depicts an example user display of the system to FIG. 37;

FIG. 39 depicts a flowchart for an example process of providing a golf club component in accordance with some embodiments of the present disclosure;

FIG. 40 depicts a schematic representation of an additive manufacturing system for use with the methods and systems described herein;

FIG. 41 depicts an example user display, according to another embodiment of the present disclosure;

FIG. 42 is a front, top, and right isometric view of a golf club head, according to another embodiment of the present disclosure;

FIG. 43 is bottom plan view of the golf club head of FIG. 42;

FIG. 44 is a cross-sectional view of the golf club head taken along plane 44-44 of FIG. 42;

FIG. 45 is a cross-sectional view of the golf club head taken along plane 45-45 of FIG. 42;

FIG. 46 is a cross-sectional view of the golf club head taken along plane 46-46 of FIG. 42;

FIG. 47 is a cross-sectional view of the golf club head taken along plane 47-47 of FIG. 42;

FIG. 48 is a front, top, and right isometric view of a golf club head, according to another embodiment of the present disclosure;

FIG. 49 is a cross-sectional view of the golf club head taken along plane 49-49 of FIG. 48;

FIG. 50 is a front, top, and right isometric view of a golf club head, according to another embodiment of the present disclosure;

FIG. 51 is a cross-sectional view of the golf club head taken along plane 51-51 of FIG. 48;

FIG. 52 is a bottom, rear, and left isometric view of a golf club head, according to another embodiment of the present disclosure;

FIG. 53 is a rear view of a golf club head, according to another embodiment of the present disclosure;

FIG. 54 is another rear view of a golf club head of FIG. 53;

FIG. 55 is a rear view of a golf club head, according to another embodiment of the present disclosure;

FIG. 56 is an isometric view of a medallion of the golf club head of FIG. 52;

FIG. 57 is a detailed, cross-sectional view of a golf club head having an internal support structure, according to another embodiment of the present disclosure;

FIG. 58 is a detailed, cross-sectional view of a golf club head having an internal support structure, according to another embodiment of the present disclosure;

FIG. 59 is a detailed, cross-sectional view of a golf club head having an internal support structure, according to another embodiment of the present disclosure;

FIG. 60 is a detailed, cross-sectional view of a golf club head having an internal support structure, according to another embodiment of the present disclosure; and

FIG. 61 is a detailed, cross-sectional view of a golf club head an internal support structure, according to another embodiment of the present disclosure.

### DETAILED DESCRIPTION OF THE DRAWINGS

The following discussion and accompanying figures disclose various embodiments or configurations of a golf club that includes a grip, a shaft, a golf club head, and golf club components. Although embodiments are disclosed with reference to an iron-type golf club, concepts associated with embodiments of the iron-type golf club may be applied to a wide range of golf clubs. For example, embodiments disclosed herein may be applied to a number of golf clubs including driver-type clubs, hybrid clubs, fairway wood clubs, putter-type clubs, utility-type golf clubs, wedge-like golf clubs, and the like.

The term “about,” as used herein, refers to variation in the numerical quantity that may occur, for example, through typical measuring and manufacturing procedures used for articles of manufacture that may include embodiments of the disclosure herein. Throughout the disclosure, the terms “about” and “approximately” refer to a range of values+5% of the numeric value that the term precedes. As noted herein, all ranges disclosed herein are inclusive of the outer bounds of the range. Additionally, the term “horizontal” should be understood to refer to a general heel-to-toe direction and the term “vertical” should be understood to refer to a general crown-to-sole direction (topline-to-sole direction), allowing for curvature, and not being construed so as to be limited to strict linear dimensions between those respective endpoints. As used herein, the terms “mass” and “weight” are used interchangeably, although it is understood that these terms refer to different properties in a strict physical sense. Additionally, the terms “remove” or “removed” should be understood to refer to substantially all or everything.

As noted herein, any of the disclosure described herein can be used for a golf club head, a golf club, components of a golf club head, and/or components of a golf club. As will be discussed in further details herein, components of a golf club head and/or a golf club can be produced using an additive manufacturing process and then added to the golf club head and/or the golf club.

The present disclosure is directed to golf club heads that are produced using an additive manufacturing process (e.g., printed layer by layer). In particular, a golf club head of the present disclosure includes a club head body that is manufactured using an additive manufacturing process and may be fabricated from a metal material, a metal alloy, or a non-metallic material. In some embodiments, the club head body may include a segmented or lattice portion that is created during the additive manufacturing process and, therefore, is formed integrally with the club head body (i.e., the lattice portion and the club head body are a unitary component). In general, the incorporation of a segmented or lattice portion enables various material and/or performance characteristics of a golf club head to be selectively manipulated to achieve, for example a desired Center of Gravity (CG) location, Moment(s) of Inertia (MOI), mass property, face flex, distance variability, launch condition(s), aesthetic(s), among other things.

The use of the terms “segmented portion,” “lattice portion,” or “lattice structure,” herein refer to portions of a golf club head that are formed by one of a plurality of interconnected segments, interconnected shapes, or connected surfaces. In some embodiments, the plurality of interconnected segments, interconnected shapes, or connected surfaces may be formed integrally with a club head body by an additive manufacturing process. In some embodiments, the lattice portion may define at least one cutout, or absence of material, that is formed within a unit cell (e.g., a repeated pattern defined by the lattice structure). The use of a lattice portion within a golf club head may allow various manufacturing and performance characteristics to be modified or customized. For example, a lattice portion may define a substantially reduced weight or density when compared to a solid material. As such, the placement of a lattice portion within a golf club head may be varied using an additive manufacturing process to selectively locate the CG of a golf club head in a desired location. In addition, the incorporation of a lattice portion into a golf club head may reduce the overall volume of material needed to manufacture the golf club head. In some embodiments, the golf club head may include one or more lattice portions that reinforce a thin metallic or non-metallic face.

The golf club heads disclosed herein may be manufactured using one or more of a variety of additive manufacturing processes. For example, a golf club head according to the present disclosure may be at least partially fabricated using a metal powder bed fusion additive manufacturing process that fuses, melts, or bonds metal powder particles layer by layer along a build plane. In some embodiments, the metal powder particles may be melted or fused by a laser that forms cross-sections of a golf club head layer by layer along a build plane. In some embodiments, the metal powder particles may be melted or fused by an electron beam or ultrasonic energy to form cross-sections of a golf club head layer by layer along a build plane. In some embodiments, the metal powder particles may be bonded to form cross-sections of a golf club head layer by layer along a build plane via the deposit (e.g., printing) of a binder.

The various methods of additive manufacturing used to manufacture a golf club heads according to the present disclosure may include binder jetting, direct energy deposition, selective laser melting (SLM), direct metal laser sintering (DMLS), fused deposition modeling (FDM), electron beam melting, laser powered bed fusion (LPBF), ultrasonic additive manufacturing, material extrusion, material jetting, Joule printing, electrochemical deposition, cold spray metal printing, DLP metal printing, Ultrasonic Consolidation or Ultrasonic Additive Manufacturing (UAM), LENS laser-based printing, electron beam freeform fabrication (EBF3), laser metal deposition, or carbon fiber additive manufacturing.

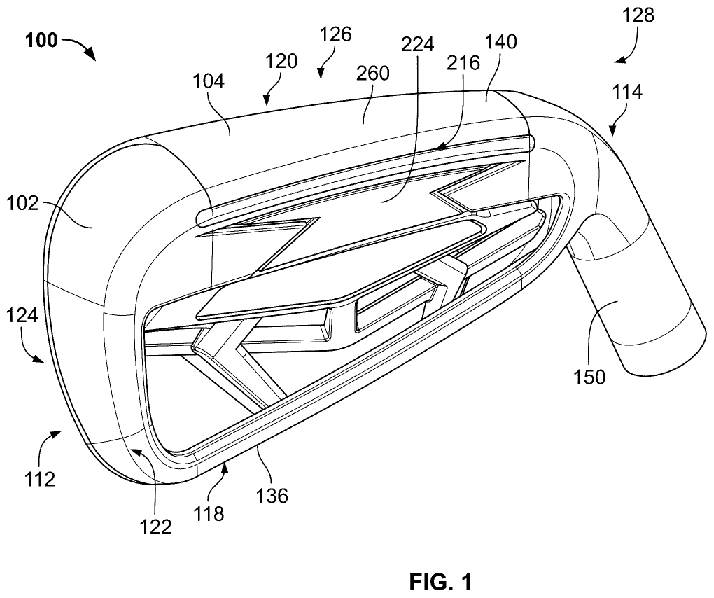

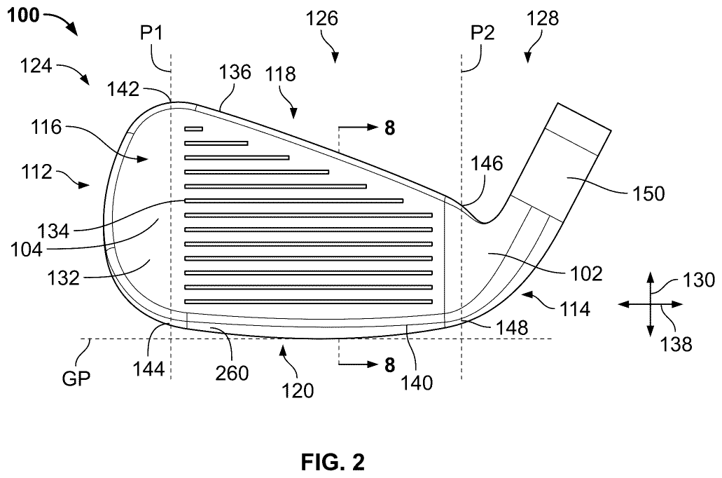

Referring now to FIGS. 1 and 2, a golf club head 100, for example, an iron-type golf club head, is shown in accordance with an embodiment of the present disclosure. The iron-type golf club head 100 includes a body 102 and a face insert 104, which may be coupled to one another after or before machining of the body 102. In some embodiments, the face insert 104 may be manufactured from a different material than the body 102. For example, the body 102 and the face insert 104 may be manufactured from different metal or non-metallic materials (e.g., different types of stainless steel, polymer, or carbon composite).

The iron-type golf club head 100 defines a toe side 112, a heel side 114, a front side 116 (see FIG. 2), a top side 118, a bottom side 120, and a rear side 122 (see FIG. 1). The iron-type golf club head 100 further includes a toe region 124, a medial region 126, and a heel region 128. Referring specifically to FIG. 2, the toe region 124, the medial region 126, and the heel region 128 may be defined by lines or planes P1 and P2 that extend through the iron-type golf club head 100 in a vertical or sole-topline direction 130, as indicated by the directional coordinate in FIG. 2. The toe region 124 and the heel region 128 are arranged at laterally-opposing ends of the body 102, and the medial region 126 is arranged laterally between the toe region 124 and the heel region 128.

The face insert 104 is attached to the front side 116 of the body 102, the face insert 104 defining a face surface or front face 132 that extends from the toe region 124, through the medial region 126, and at least to a junction between the heel region 128 and the medial region 126. The front face 132 includes a plurality of laterally-extending grooves 134 that are spaced from one another in the sole-topline direction 130. In some embodiments, the front face 132 may define a striking face that makes contact with a golf ball.

The iron-type golf club head 100 defines a topline 136 extending in an inclined lateral or heel-toe direction 138 along the top side 118, and a sole 140 extending laterally in the heel-toc direction 138 along the bottom side 120. In some embodiments, the heel-toe direction 138 may be parallel to a ground plane GP that is defined as a plane that is parallel to the ground on which the iron-type golf club head 100 sits at address. The topline 136 may be formed by the top side 118 of the body 102, the face insert 104, or a combination of the body 102 and the face insert 104. Similarly, the sole 140 may be formed by the bottom side 120 of the body 102, the face insert 104, or a combination of the body 102 and the face insert 104.

In some embodiments, the plane P1 may be defined along or proximate a lateral edge of the grooves 134 formed in the front face 132 that is adjacent to the toe side 112. In the illustrated embodiment, the plane P1 may intersect the top side 118 of the body 102 or the face insert 104 at a toe-topline intersection point 142 along the topline 136 where the slope of a line tangent to the topline 136 is approximately zero (e.g., a point where a line tangent to the periphery of the top side 118 is approximately parallel to the ground at address). In this embodiment, the plane P1 may extend through the iron-type golf club head 100 in the sole-topline direction 130 to a toe-sole intersection point 144 along the bottom side 120.

In some embodiments, the plane P2 may be defined along or proximate a lateral edge of the grooves 134 formed in the front face 132 that is adjacent to the heel side 114. In some embodiments, the plane P2 may be defined by the intersection between a lateral edge of the face insert 104 adjacent to the heel side 114 and the body 102. In the illustrated embodiment, the plane P2 may intersect the top side 118 of the body 102 or the face insert 104 at a heel-topline inflection point 146 (e.g., a point where the periphery of the top side 118 transitions from concave down to concave up). In this embodiment, the plane P2 may extend through the iron-type golf club head in the sole-topline direction 130 to a heel-sole inflection point 148 along the bottom side 120.

The topline 136 may extend along the top side 118 from the toe-topline intersection point 142, along the medial region 126, to the heel-topline inflection point 146. The sole 140 may extend along the bottom side 120 from the toe-sole intersection point 144, along the medial region 126, to the heel-sole inflection point 148. In some embodiments, the topline 136 and the sole 140 may extend farther into the toe region 124 or the heel region 128, or both.

Referring still to FIG. 2, the body 102 may be formed as a unitary component (e.g., from a single piece of material). In some embodiments, the body 102 may be formed by a casting process, a forging process, or an additive manufacturing process (e.g., 3-D printing, such as DMLS). Accordingly, the body 102 may be made of a metal or metal alloy, such as, e.g., Grade 431 Stainless Steel. It is contemplated that the body 102 may be formed from a material having a hardness, as measured in accordance with suitable Rockwell Scale, of between about 65 HRB and about 60 HRC, or about 68 HRB, or about 50 HRC. In some embodiments, the body 102 has a hardness of between about 107 and 627 on the Brinell Scale. In some embodiments, the body 102 may undergo heat treatment, such that the hardness of the material of the body 102 increases or decreases during forming. The body 102 includes a hosel 150. The hosel 150 is arranged within the heel region 128 of the body 102 and extends from the heel region 128 at an angle (e.g., a lie angle formed between a plane parallel to the ground on which the club head rests at address and a center axis defined through the hosel 150) in a direction away from the toe region 124.

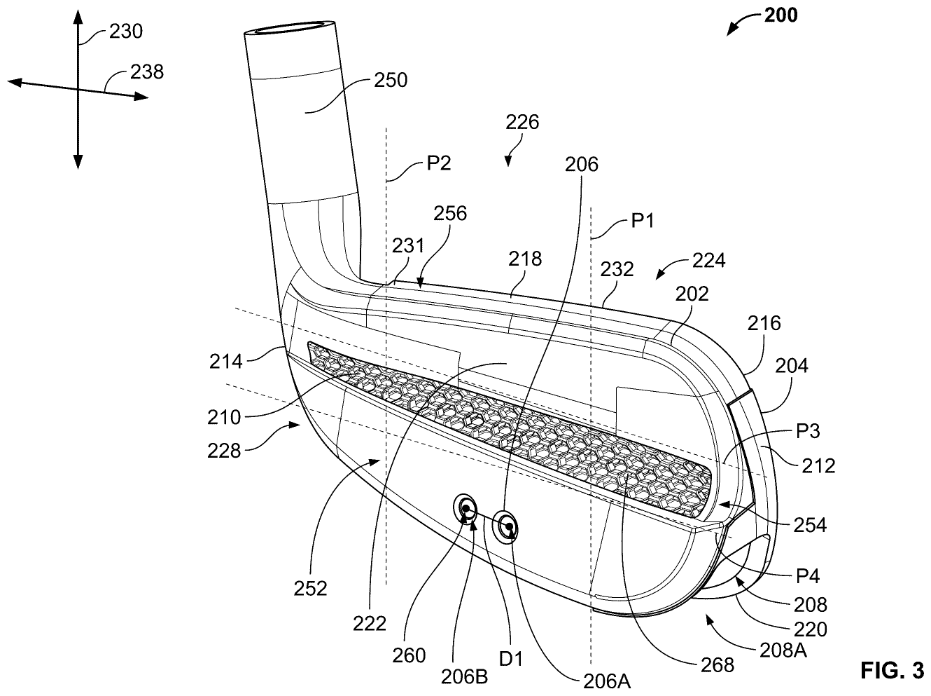

Now referring to FIGS. 3-9, a golf club head 200 is illustrated, which is one particular example of the golf club head 100 illustrated in FIGS. 1 and 2. To that end, features of the golf club head described below include reference numbers that are generally similar to those used in FIGS. 1 and 2. For example, the golf club head 200 is described below as having a body 202, just as the golf club head 100 has a body 102. As described above, the golf club head 200 described below is manufactured via additive manufacturing. For example, additive manufacturing method such as DMLS, binder jetting, and FDM mentioned above can be used to fabricate the golf club head 200. However, it is contemplated that the golf club can be manufactured from casting (e.g., molding) or other manufacturing methods. The golf club head 200 is formed from stainless steel, however, the golf club head 200 can be formed from various types of materials. For example, the golf club head can be formed from 17-4, 316, and/or 316L stainless steel (L=lower carbon content).

The golf club head 200 illustrated in FIGS. 3-9 is an as-printed (“AP”) part. In other words, FIGS. 3-9 illustrate the golf club head 200 after it has been 3D printed but before it is processed for commercial use. Referring to FIG. 3, the golf club head 200 includes a body 202 defining a toe side 212, a heel side 214, a front side 216, a top side 218, a bottom side 220, and a rear side 222. Each side of the body includes a corresponding wall (e.g., front side includes a front wall, a rear side includes a rear wall). The golf club head 200 further includes a toe region 224, a medial region 226, and a heel region 228. The toe region 224 and the heel region 228 are arranged at laterally opposing ends of the body 202, and the medial region 226 is arranged laterally between the toe region 224 and the heel region 228. The toe region, the medial region, and the heel region may be defined by lines or planes P1 and P2 that extend through the golf club head 200 in a vertical direction 230.

Still referring to FIG. 3, the body 202 further includes a lower region 252, a central region 254, and an upper region 256. The lower region 252 and the upper region 256 are arranged at vertically opposing ends of the body, and the central region 254 is arranged vertically between the lower region 252 and the upper region 256. The lower region 252, the central region 254, and the upper region 256 may be defined by lines or planes P3 and P4 that extends through the golf club head 200 in a horizontal direction 238, i.e., in a direction that is parallel to a ground plane when the club head is at address.

The golf club head 200 further includes apertures 206, cavities 208 and a channel 210 defined along the rear side 222 of the body 202. In the illustrated example, referring to FIG. 3, the apertures include a first aperture 206A and a second aperture 206B that is defined along the lower region 252 and the medial region 226 of the body. The first aperture 206A and the second aperture 206B can be spaced apart by a distance D1 (distance measured from center of the apertures). Alternatively, in some embodiments, the first aperture 206A and the second aperture 206B can intersect with each other (e.g., be tangential to each other or dissect each other). Furthermore, the first aperture 206A and the second aperture 206B are configured to be in communication with an internal volume 260 of the body 202. In other words, the first and second apertures 206A, 206B can partially reveal a portion of the internal volume 260 and can allow removal of excess materials that can be trapped within the internal volume 260.

Referring to FIG. 3, the first and second apertures 206A, 206B on the rear side 222 of the golf club head 200 can act as flow ports for injecting fluid and removing powder/material after the golf club head is printed. In some examples, the first and second apertures 206A, 206B are located on the rear side 222 to avoid placing them in any area that is highly polished (e.g., lower portion of the golf club head). In some examples, a periphery (e.g., radial area adjacent to the apertures) may be chamfered. As described above, the first and second apertures 206A, 206B are at least between about 3 mm and about 4 mm spaced apart (distance between closest edges of each aperture) and are sized to fit a nozzle. In some embodiments, the golf club head 200 may not include the first and second apertures 206A, 206B and the golf club head 200 may not require blow through holes. Further, in some embodiments, the golf club head 200 may only include a single aperture instead of two apertures. It is noted that the first and second apertures 206A, 206B can be positioned on any portion of the golf club head 200. Furthermore, in some embodiments, the aperture 206 can be placed on a hosel 250, and the aperture may extend into the internal volume 260 of the golf club head. Therefore, fluid may flow through the aperture(s) into the internal volume 260 of the golf club head 200 and out of the hosel 250.

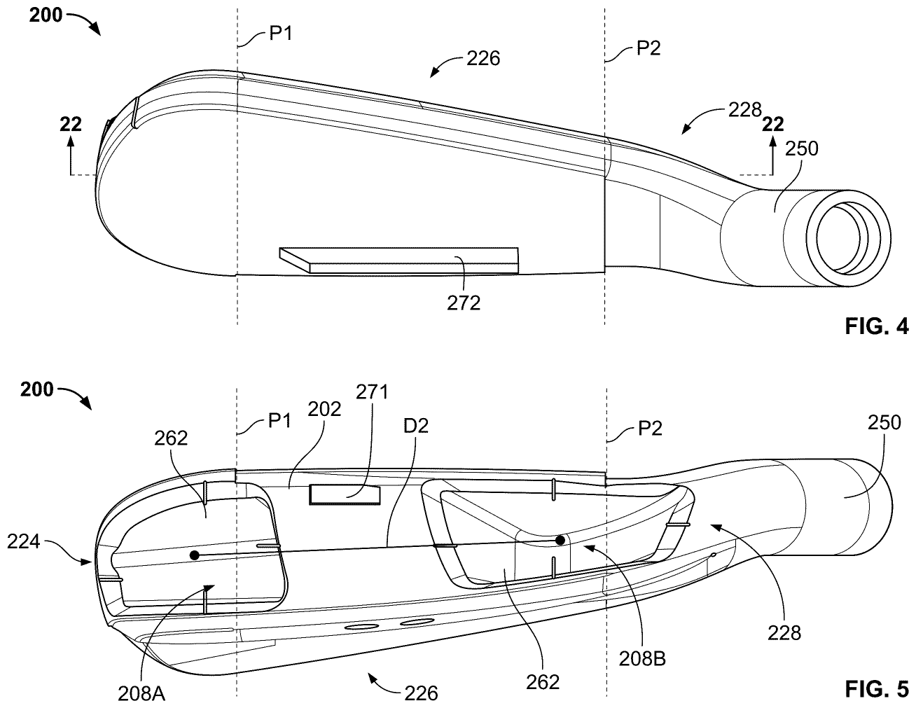

Referring now to FIG. 4, the plane P2 may be defined along or proximate to an inset edge 231 of the face plate 204 along a front face 232 of the body 202. The inset edge 231 can align with the plane P2 to define the boundary between the heel region 228 and the medial region 226. In some embodiments, a thickness of the front face 232 of the golf club head 200 is between about 0.5 mm and about 3 mm, or between about 1 mm and about 2 mm, or between about 1.3 mm and about 1.7 mm, or about 1.5 mm, or at least 1 mm, or at least about 1.5 mm.

Referring to FIG. 5, the body 202 of the golf club head 200 includes cavities 208. In the illustrated example, a first cavity 208A is defined along the toe region 224 and the lower region 252 of the body 202 and a second cavity 208B is defined along the heel region 228 and the lower region 252 of the body. In other words, the first and second cavities 208A, 208B are disposed laterally opposite one another. In some examples, the first cavity 208A may extend between the toe region 224 and the medial region 226 along the lower region 252 of the body 202. In some examples, the second cavity 208B may extend between the heel region 228 and the medial region 226 along the lower region 252 of the body 202. Alternatively, in some examples, the first cavity 208A may extend between the lower region 252 and the central region 254 along the toc region 224 of the body 202. In some examples, the second cavity 208B may extend between the lower region 252 and the central region 254 along the heel region 228 of the body 202.

Still referring to FIG. 5, the first and second cavities 208A, 208B are spaces apart by a distance D2 (distance is measured from the centroid of the first and second cavities). The first and second cavities 208A, 208B each include a cavity wall 262 that extends into the internal volume 260. The first and second cavities 208A, 208B are configured to receive a weight, which is described below. In some examples, the first and second cavities 208A, 208B may be beveled or chamfered to assist with welding, if the welding is used in the weight attachment process. In some embodiments, the cavities 208A, 208B can be disposed on either the toe side 212 or the heel side 214, or the cavities 208A, 208B can be disposed on both heel side 214 and the toe side 212 as illustrated in FIG. 5. In some embodiments, the cavities 208A, 208B can be disposed along the heel side 214 where the heel (e.g., edge of the heel side) adjoins the sole 240 and/or can be disposed along the toc side 212 where the toc (e.g., edge of the toe side) adjoins the sole 240. In some embodiment, the cavities can be disposed along the two opposite ends of the sole 240.

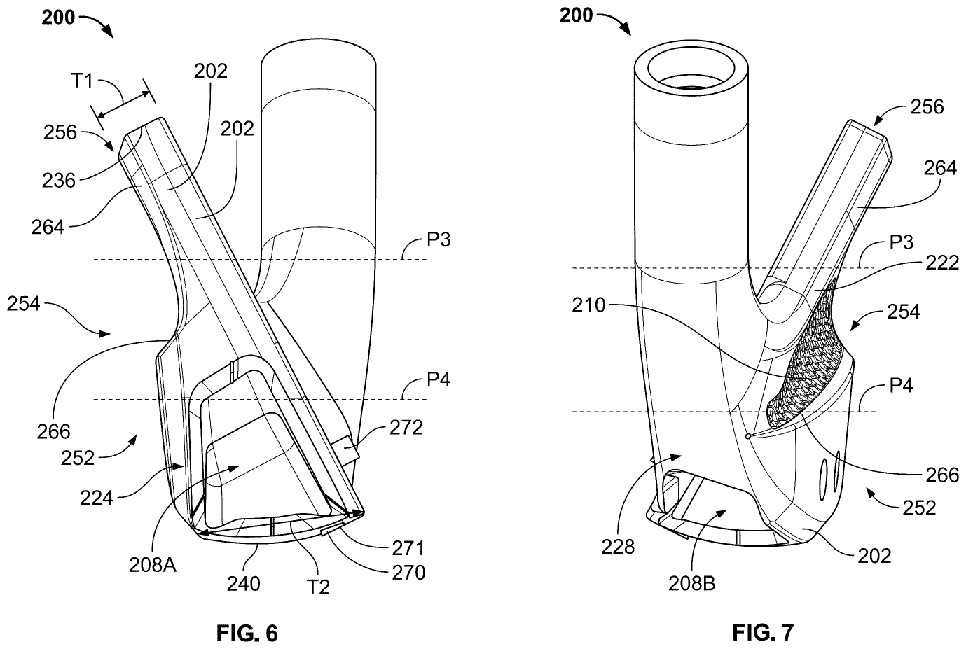

Referring again to FIGS. 6 and 7, a thickness of the golf club can be different along the vertical direction. More specifically, referring to FIG. 6, a topline 236 may include a first thickness T1 and a sole 240 may include a second thickness T2 and the second thickness T2 is greater than the first thickness T1. In the illustrated embodiment, the thickness of the golf club head increases gradually along the vertical direction from the topline 236 to the sole 240. In some examples, the upper edge 264 and the lower edge 266 of the channel 210 may have different thicknesses. Referring to FIG. 7, the lower edge 266 of the channel 210 is inset from the rear side 222 of the body 202 and extends between a heel side 214 and a toe side 212. In some embodiments, the distance or width of the inset portion can differ along the length L1 (see FIG. 9) of the channel 210 between the heel side 214 and the toe side 212. Alternatively, in some embodiments, the amount inset portion can have a continuous width along the length L1 of the channel 210 between the heel side 214 and the toe side 212.

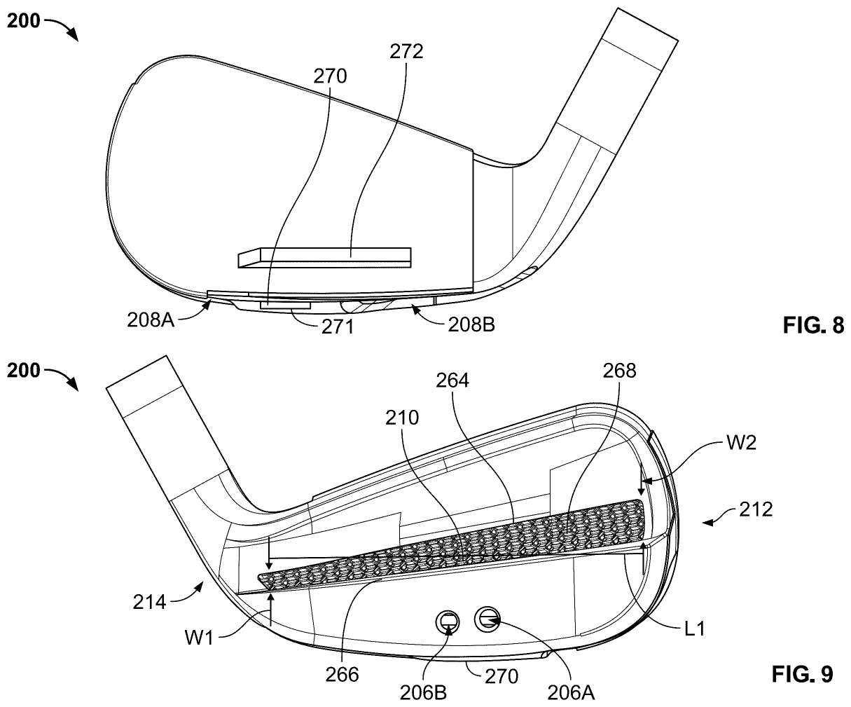

Referring now to FIG. 8, the golf club head 200 includes a protrusion or an excess material 270 (see rectangular feature between weights) that is added for processing and alignment of the golf club head 200. The excess material extends away from the bottom side 220 of the body 202 and includes a flat surface 271. Furthermore, the golf club head 200 also includes an alignment bar 272 that assists with processing and alignment of the golf club head 200 along the front side 216 of the body. The excess material 270 and the alignment bar 272 are parallel with each other when the golf club head is at address (See FIG. 6). More specifically, the flat surface 271 of the excess material is parallel with the alignment bar 272. Additionally, the alignment bar 272 and the excess material 270 between the first and second cavities 208A, 208B can aid in locating for machining. In other words, the alignment bar 272 and/or the excess material 270 between the first and second cavities 208A, 208B can aid in aligning/setting up/indexing the as printed (“AP”) part to make sure the golf club head 200 can be easily machined. In some embodiments, the alignment bar 272 and/or the excess material 270 between the first and second cavities 208A, 208B may not be included in the golf club head 200. The excess material 270 and alignment bar 272 may be extra material that is sacrificed or removed during manufacturing.

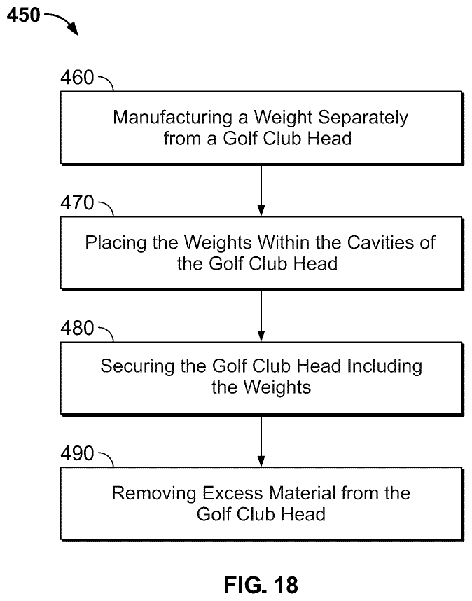

Referring to FIG. 9, the body 202 includes a channel 210 that extends between the heel side 214 and the toe side 212 along the central region 254 of the body 202. In the illustrated embodiment, a width W1 of the channel 210 at the heel region 228 is smaller than a width W2 of the channel 210 at the toe region 224. In other words, the width of the channel 210 can be different along a length L1 of the channel 210. In some examples, the width W2 along the toc region 224 can be twice the width W1 along the heel region 228. Alternatively, in some embodiments, the width along the heel region 228 can be greater than the width along the toe region 224. The channel 210 includes an upper edge 264 and a lower edge 266 extending transversely between the heel side 214 and the toe side 212. In some embodiments, the channel 210 can extend transversely between the heel side and the toe side. An external lattice structure 268 extends between the upper edge 264 and the lower edge 266 of the channel 210 and toward an internal wall (see FIG. 18), which is described in detail below.

Still referring to FIG. 9, the first and second apertures 206A, 206B can extend parallel to the direction of the channel between the heel side and the toe side. Alternatively, in some examples, the first and second apertures 206A, 206B can be disposed at an equal distance from the excess material 270 along the vertical direction 230. In some examples, the size of the first aperture 206A may be different from the size of the second aperture 206B.

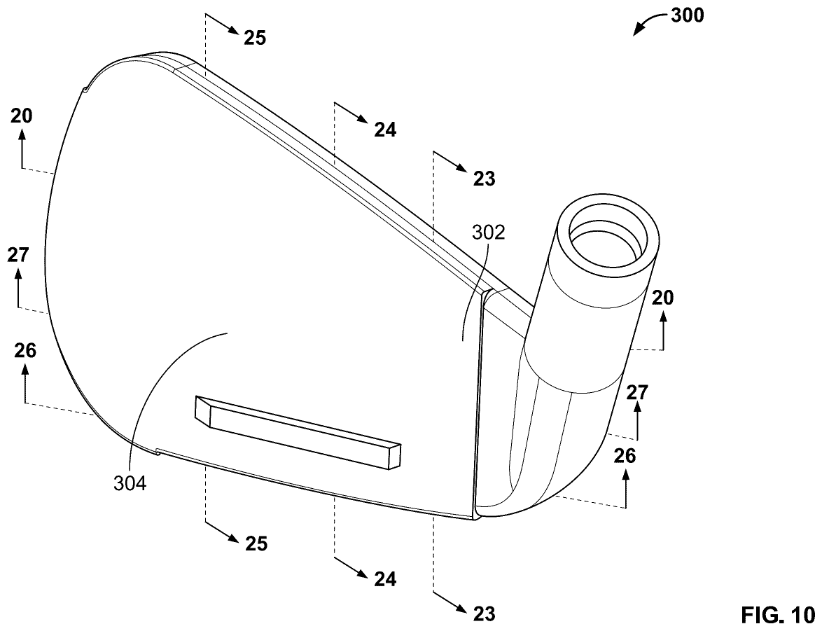

Referring now to FIGS. 10-17, an unfinished golf club head 300 is illustrated, which is similar to the golf club head shown and described in FIGS. 3-9, in an unfinished configuration. In other words, FIGS. 10-17 illustrate the golf club head with additional features (e.g., weights) that are added to the golf club head 200 that is formed as an as-printed (“AP”) part. Accordingly, additional finishes such as polishing and machining can be performed to the unfinished golf club head 300 to form a finished golf club head (FIGS. 1 and 2 illustrate a finished golf club head). To that end, features of the golf club head described below include reference numbers that are generally similar to those used in FIGS. 3 and 9. For example, referring to FIG. 10, the golf club head 300 includes a body 302 and a face plate 304.

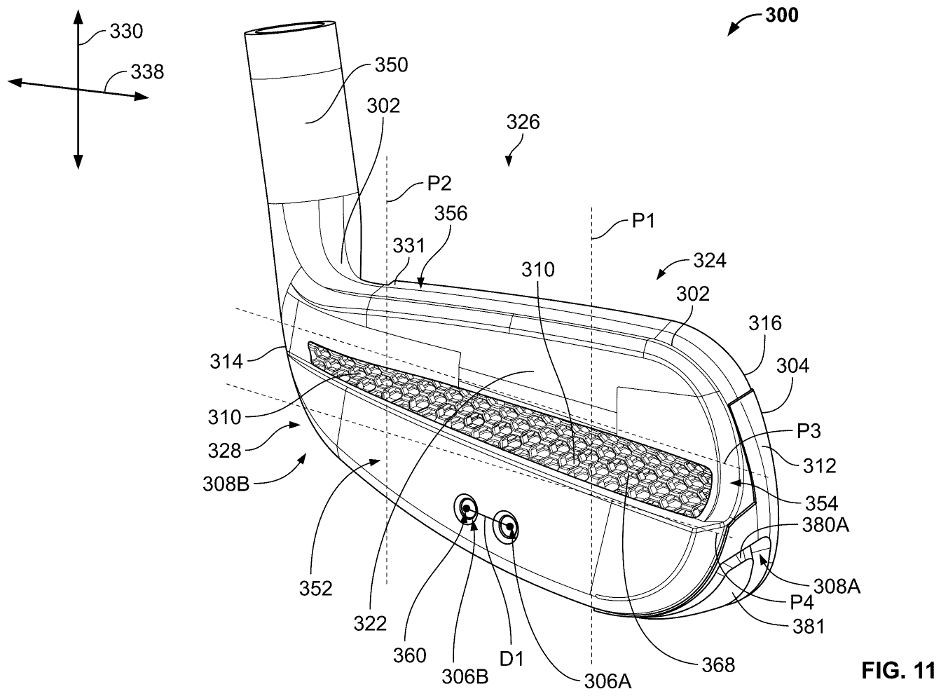

Referring in particular to FIG. 11, in the finished configuration, the golf club head 300 includes additional components. For example, in the finished configuration, the first and second apertures 306A, 306B are covered, e.g., filled and/or welded with material, and are polished down so that the first and second apertures 306A, 306B are concealed. Furthermore, the golf club head includes weights 380 installed within the first and second cavities 308A, 308B. The weights can include a heel tungsten weight 380A and a toe tungsten weight 380B (not shown, see FIG. 13). In some examples, the weights 380 can be formed from tungsten. In some embodiments, a different type of material may be used for the weights and the weights may not be made from tungsten. As described herein, the weights 380 are added to the golf club head 300 after the golf club head 300 is 3D printed. For example, the weights 380 can be formed using metal injection molding (“MIM”). In some embodiments, the weights 380 may have different densities. Further, in some embodiments, the weights 380 may be formed from titanium and/or steel (alloys) instead of tungsten.

In some examples, the weight of the heel tungsten weight and the toe tungsten weight can be different. In some embodiments, the heel tungsten weight and the toe tungsten weight may have the same weight. Each of the weights can weigh between about 20 grams and about 75 grams, or between about 30 grams and about 50 grams, or about 40 grams, or about 47.2 grams, or about 25 grams, or about 57.8 grams, or about 29.4 grams, or about 68.4 grams, or about 31.5 grams, or at least 20 grams, or at least 30 grams. In some embodiments, the hosel 350 may also include a weight therein. The hosel weight can be about 3.0, 4.0, 5.0, or 6.0 grams. Furthermore, in some embodiments, the hosel weight may be formed from plastic, ceramic, or other low-density or lightweight materials. In such an embodiment, the hosel weight may have a weight of about 1.0 gram and be injection molded, extruded, or formed from an additive manufacturing process. Still further, in some embodiments, the tungsten weights can have any shape.

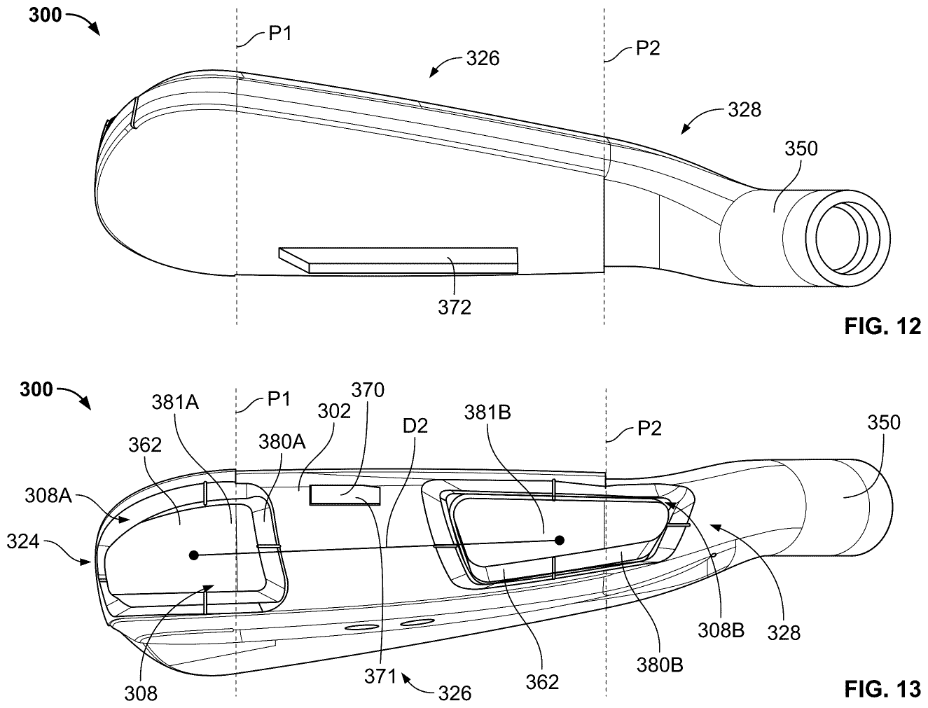

Referring to FIG. 12, an alignment bar 372 is shown along a front face. The alignment bar 372 is added for processing and alignment of the golf club head 300. In some embodiments, and referring to FIG. 13, a protrusion or excess material 370 that is disposed along the bottom surface of the golf club head 300 between the weights can be parallel with the alignment bar 372. More specifically, the protrusion may include a flat surface 371 that is parallel with the alignment bar 372.

Still referring to FIG. 13, during construction of the golf club head 300, the weights (e.g., tungsten weights) are added into the first and second cavities 308A, 308B of the golf club head 300. A cap 381 is added onto each of the tungsten weights to close the weights 380 within each of the respective cavities 308A, 308B. In some examples, the cap 381 is 3D printed with the golf club head 300 (integrally formed). In some embodiments, the cap 381 may be the same material as the body 302. As noted herein, in some embodiments, the caps 381 may or may not be printed with the body 302 of the golf club head 300. In some embodiments, the caps 381 can be formed integrally with the weights 380. In some embodiments, the caps 381 and the body 302 of the golf club head 300 may be printed separately, at separate times, and/or in separate machines.

In some embodiments, the caps 381 may be manufactured with MIM, casting, or forging. In some examples, refractory cement is used to secure the weights 380 and the caps 381 within the respective cavities 308A, 308B. As noted herein, the refractory cement is a high heat adhesive. The refractory cement can be beneficial over other cements since the refractory cement can withstand extremely high temperatures, making them suitable for applications where conventional cements and materials would break. Therefore, it would allow the refractory cement to withstand the heat of welding during formation of the golf club head 300.

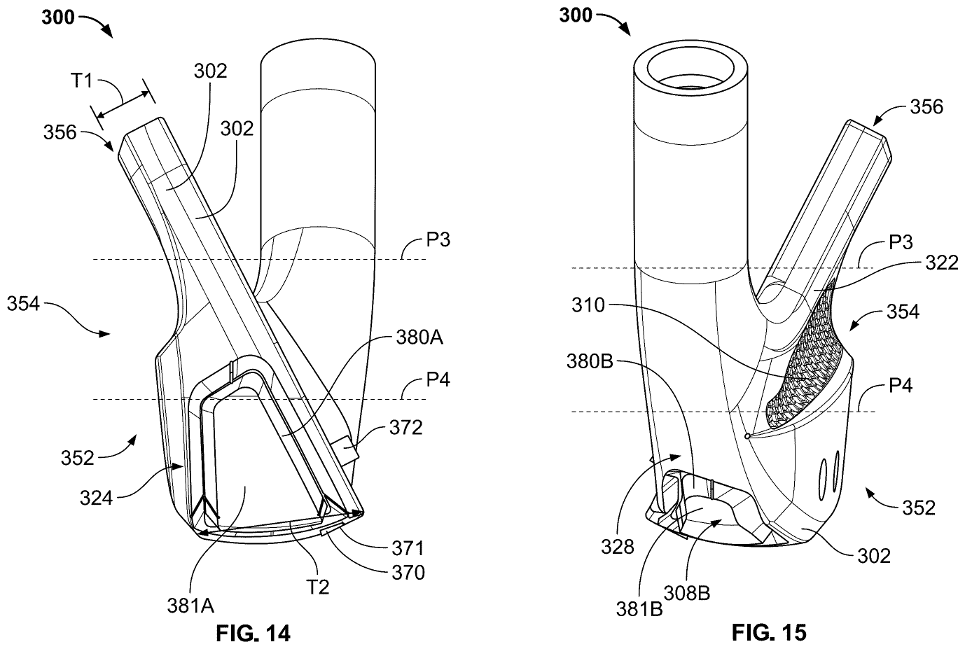

Referring to FIG. 14, the toe side 312 of the golf club head 300 includes the first cavity 308A that is configured to receive a first weight 380A. As described above, in some embodiments, a first cap 381A may cover the first weight 380A to contain the first weight 380A within the first cavity 308A. In some examples, the first cavity 308A is configured to includes one or more weights (e.g., weight plates). For example, the first cavity 308A may receive two weights that are contained by the first cap 381A.

Similarly, and referring to FIG. 15, the heel side 314 of the golf club head 300 includes the second cavity 308B that is configured to receive a second weight 380B. As described above, in some embodiments, a second cap 381B may cover the second weight 380B to contain the second weight 380B within the second cavity 308B. In some examples, the second cavity 308B is configured to include one or more weights. In some examples, a volume of the first cavity 308A can be identical to a volume of the second cavity 308B. Alternatively, in some examples, the volume of the first cavity 308A can be different than the volume of the second cavity 308B.

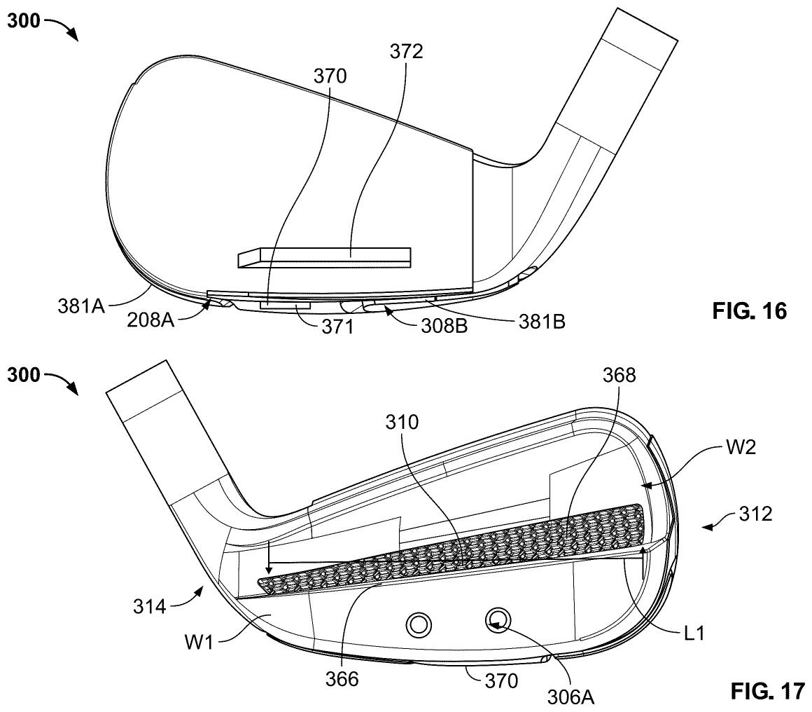

Referring to FIG. 16, the first cavity 308A can extend between the heel region 328 and the medial region 326. For example, the first cavity 308A can extend about ⅓ of a length of the golf club head. The second cavity 308B can extend about ⅓ of the length of the golf club head 300 between the toc region 324 and the medial region 326. In some embodiments, the alignment bar 372 may extend about ⅓ of the length of the golf club head 300 between the first and second cavities 308A, 308B. In some embodiments, the excess material 370 may be disposed closer to the first cavity 308A or the second cavity 308B. Alternatively, the excess material 370 can be positioned equidistant from the first and second cavities 308A, 308B (e.g., equidistant from the centroid of the cavities).

Referring to FIG. 17, in some embodiments, the internal volume 360 can be filled using a resin through the first and second apertures 306A, 306B. The internal lattice structure 374 is completely enclosed within the body 302 of the golf club head 300 in the finished configuration, i.e., an internal lattice structure 374 is not visible from an exterior of the golf club head 300 when the golf club head 300 is at address. Furthermore, as described and illustrated in FIG. 11, the first and second apertures 306A, 306B can be filled with material (e.g., resin, plastics) so that the first and second apertures 306A, 306B are concealed. For example, the internal volume 360 can be filled using a thermoplastic or resin to adjust the Center of Gravity of the golf club head 300. In some embodiments, only the lower region (e.g., below the centroid) of the internal volume 360 of the golf club head 300 may be filled. In some embodiments, the entirety of the internal volume 360 of the golf club head 300 may be filled.

As illustrated in FIG. 18, steps of a method 450 are shown for securing the weights to the golf club head 300. To secure the weights 380 to the golf club head 300, at a first step 460, the weights 380 are manufactured as separate pieces from the golf club head 300. In this example, the golf club head 300 is printed, i.e., 3D printed or manufactured, separately from the weights 380. However, in some examples, either the golf club head 300 or weights 380 can be manufactured via machining (e.g., CNC) or another type of manufacturing method. In some embodiments, the weights 380 can be of different size relative to the golf club head. For instance, the weights 380 can be manufactured specifically to control the weight distribution in accordance with the golf club head 300 of a specific set. For example, the weights 380 of a set of irons may include different sizes according to different flight characteristics and loft angle of the irons. Alternatively, in some examples, the weights 380 may include uniform size and/or weight. In some examples, the density or the material of the weights 380 can be controlled to match a desired weight distribution of the golf club head.

At a second step 470, the weights 380 are placed within the respective cavities 308A, 308B of the golf club head. Similarly, the size of the cavities can be different for different types or set of clubs in order to receive different sized weights 380. Alternatively, the sizes of the cavities can be the same. At a third step 480, the weights are secured to the golf club head. In some examples, refractory cement is poured into the printed golf club head, which is configured to secure the weights 380 within the respective cavities 308A, 308B, after the club head is placed within a sintering oven and sintered. The golf club head with cement poured in the cavities to fix the weights 380 is baked, causing the refractory cement surrounding the weights 380 to secure the weights 380 within the respective cavities 308A, 308B. Refractory cement has been found to have unexpected benefits when securing the weights to a golf club head. In particular, it has been determined through testing that the refractory cement is more beneficial than other adhesives since the refractory cement can withstand extremely high temperatures, making refractory cement suitable for applications where conventional cements and materials might break. In some examples, adhesives can be used to secure the weights 380 with the golf club head 300.

At a fourth step 490, the excess material (e.g., adhesives or cement) can be cleaned from the sintered golf club head 300. In some examples, the caps 381 can be further welded to provide additional bonding strength with the golf club head 300. Further, in some embodiments, a diffusion bonding (or vacuum hot press bonding) process may be used to secure the weights 380 to the golf club head 300. For example, a dynamic load may be added in a heated environment to secure the weights 380 to the golf club head 300. Lastly, the golf club head 300 can be polished to its final shape. Thus, in a final shape (ready for commercial use), the weights 380 and/or the cavities 308A, 308B may not be visibly detectable by an eye of the user. If necessary, nickel-chrome plating and other cosmetic touches may be added to the golf club head 300 to finalize it for commercial use.

As described above, the weights can be secured to the golf club head by applying adhesives into the first and second cavities 308A, 308B. Different adhesive may be used to secure the weights 380 and the caps 381 to the golf club head 300. In some embodiments, more than one type of adhesive may be used throughout the process. In some embodiments, a different adhesive may be used to secure the weights 380 in the respective cavities 308A, 308B before the refractory cement is added to the golf club head 300. In some embodiments, the weights 380 may be attached to the golf club head 300 through high frequency bonding, which is a brazing process that results in a clean bond with minimal extra material. In some embodiments, the weights 380 may be attached to the golf club head 300 through a sinter capturing or diffusion bonding. For example, the weights 380 may be previously sintered and added to the golf club head 300 before the golf club head 300 is sintered. Therefore, the two materials will be joined around the interfacing surfaces as they are sintered together, i.e., the steel shrinks around the tungsten providing a friction lock from an interface fit.

Accordingly, the refractory cement is a type of cement for furnace repair, a cement for sintering repair, and/or an extreme temperature furnace cement. The refractory cement helps with securing the weights 380 in the respective cavities 308A, 308B golf club head 300 and can withstand the high heat associated with welding the caps 381 onto the golf club head 300. In some embodiments, clips and/or clamps can used to hold the caps 381 and weights 380 in place while the refractory cement dries. Once the refractory cement, tungsten weights, and caps 381 are added to the golf club head, clamps can be used to set the features in place and allow the refractory cement to dry and secure the components. Once dried, the caps 381 can be welded onto the golf club head and the golf club head can be polished. As discussed above, in some embodiments, a different adhesive than refractory cement may be used to secure the tungsten weights and the caps to the golf club head.

As noted herein, the body 302 and caps 381 of the golf club head 300 are unique for each golf club type, i.e., 4 iron, 5 iron 6 iron, etc. In some embodiments, the heel and toe weights may come in 3 different size sets (set=heel tungsten weight and toe tungsten weight). In each set, the heel tungsten weight and the toe tungsten weight have different sizes. In some embodiments, the 4 iron and the 5 iron use the same size set, the 6 iron, the 7 iron, and the 8 iron use the same size set, and the 9 iron and the pitching wedge use the same size set. In some embodiments each golf club head has its own weight sizes, and in some embodiments, there is a universal (e.g., one-size) weight for an entire set of golf club heads. In some embodiments, the golf club head body and the caps are formed from 17-4 and/or 316L stainless steel.

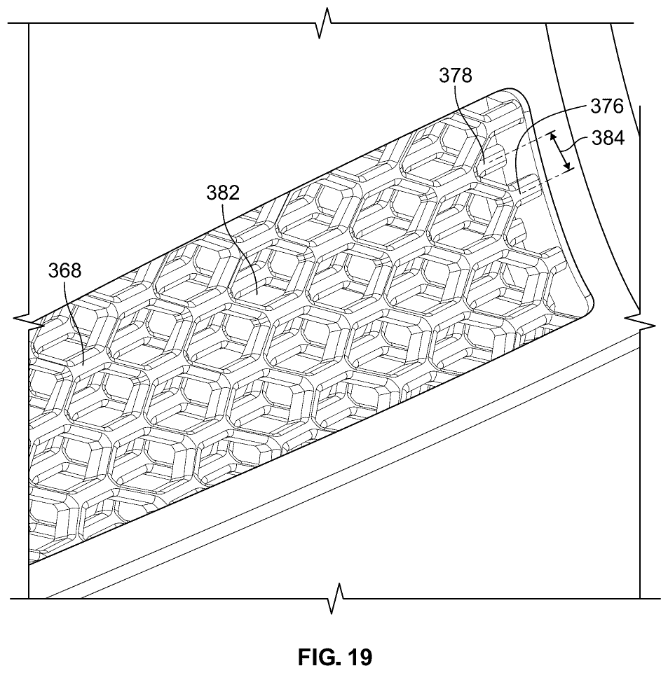

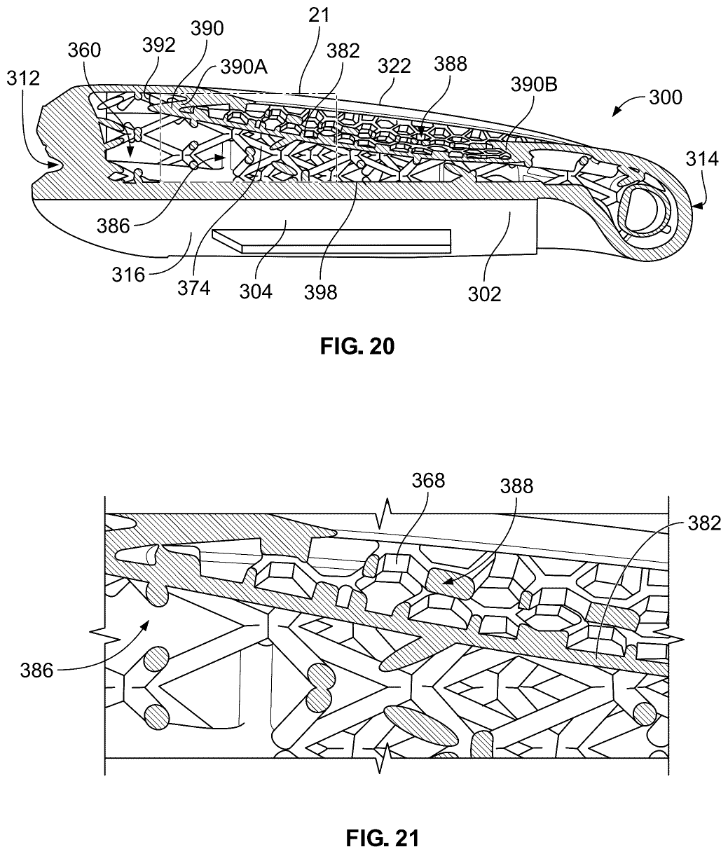

Referring to FIG. 19, the golf club head 300 includes an external lattice structure 368 extending between the channel 310 of the body 302. In some embodiments, as further discussed in detail below, the golf club head 300 includes an internal lattice structure 374 (See FIG. 20) that extends within the internal volume 360 of the golf club head 300. The external lattice structure 368 may include a first layer of lattice structure 376 and a second layer of lattice structure 378 that is parallel with respect to the first layer of lattice structure 376. In the illustrated example, the first layer of lattice structure 376 includes a honey-comb shape cell to form the first layer of lattice structure 376, and the second layer of lattice structure 378 includes identical lattice configurations as the first layer of lattice structure 376. However, in some embodiments, the lattice configuration of the first layer of lattice structure 376 can be different than the second layer of lattice structure 378. In some examples, the second layer of lattice structure 378 can be disposed equidistant from the first layer of lattice structure 378 and an internal wall 382. In some examples, the second layer of lattice structure 378 can be disposed closer toward the first layer of lattice structure 376 and is separated by a gap 384. In some examples, the second layer of lattice structure 378 can be disposed closer to the internal wall 382 while being separated by the gap 384. For example, the second layer of lattice structure 378 can be inlaid above the internal wall 382 (e.g., formed integrally above the internal wall). In some examples, the internal lattice structure 374 and the external lattice structure 368 can comprise the same type of lattice configuration or can comprise a different type of lattice configuration.

As outlined above, the internal lattice structure 374 reduces the weight of the golf club head 300 and therefore allows the weights to be added to the golf club head 300. Therefore, in some embodiments, the weights added into the first and second cavities 308A, 308B may be equal to the weight saved by the internal lattice structure 374 inside the golf club head 300. The internal lattice structure 374 has a beam thickness (diameter) of between about 0.5 mm and about 10 mm, or between about 0.6 mm and about 5 mm, or between about 0.7 mm and about 3 mm, or between about 0.8 mm and about 2 mm, or between about 1.1 mm and about 1.22 mm, or at least about 0.8 mm, or at least about 1.1 mm. The beam thickness is uniform throughout the internal lattice structure 374. However, in some embodiments, the internal lattice structure 374 may have varying beam thicknesses throughout. Therefore, in such an embodiment, the internal lattice structure 374 may have varying densities throughout. In some embodiments, a unit cell size of the lattice structure and/or the beam thickness of the lattice structure can be different to vary in one or more locations.

In some embodiments, the internal volume 360 comprising the internal lattice structure 374 is filled with between about 1.0 gram and about 100.0 grams of lattice structure, or between about 5.0 grams and about 50.0 grams of lattice structure, or between about 5.0 grams and about 20 grams of lattice structure, or between about 5.0 grams and about 15.0 grams of lattice structure, or between about 8.0 grams and about 11.0 grams of lattice structure, or between about 9.0 grams and about 11.0 grams of lattice structure, or between about 9.6 grams and about 10.4 grams of lattice structure, or about 9.6 grams of lattice structure, or about 9.8 grams of lattice structure, or about 9.9 grams of lattice structure, or about 10.4 grams of lattice structure, or at least 5.0 grams of lattice structure, or at least 9.0 grams of lattice structure.

In some embodiments, the internal lattice structure 374 inside of the body 302 of the golf club head 300 saves, i.e., the difference between a golf club head with a fully solid interior core and lattice structure, between about 5.0 grams and about 150.0 grams of weight, or between about 50.0 grams and about 120.0 grams of weight, or between about 80.0 grams and about 115.0 grams of weight, or between about 90.0 grams and about 110.0 grams of weight, or between about 91.5 grams and about 105.8 grams of weight, or about 91.5 grams of weight, or about 92.8 grams of weight, or about 97.0 grams of weight, or about 99.1 grams of weight, or about 104.8 grams of weight, or about 105.8 grams of weight, or about 106.7 grams of weight, or at least 80.0 grams of weight, or at least 90.0 grams of weight. In other words, when compared to a golf club with a solid interior core, the lattice structure 374 has a weight of about 10% of a fully solid interior core. In some embodiments, the lattice structure 374 has a weight of between about 1% and about 90%, or about 1% and about 75% or about 1% and about 50% of a fully solid interior core, or between about 5% and about 20% of a fully solid interior core, or between about 7% and about 15% of a fully solid interior core.

FIG. 20 illustrates the internal volume 360 of the body 302 of the golf club head 300. More specifically, the internal volume 360 includes an inner chamber 386 and an outer chamber 388 that is divided by the internal wall 382. Referring to FIG. 21, the internal wall 382 is formed integrally with projections 390 extending transversely into the internal volume 360. For example, referring again to FIG. 19, a first projection 390A and a second projections 390B extend inwardly from the rear side 322 (e.g., rear side wall) of the body 302 at an angle 392 relative to the rear side wall defining a trapezoidal shape. In some examples, the angle of the projections 390A, 390B can be different. In some examples, the internal wall 382 may extend between the heel side 314 and the toe side 312 including curvature(s). Alternatively, in some examples, the internal wall 382 may extend diagonally between the heel side 314 and the toe side 312 at a defined angle. Alternatively, referring to FIG. 21, the internal wall 382 may extend parallel to the face plate 304 of the golf club head 300.

As described above, the internal lattice structure 374 is separated from the external lattice structure 368. In other words, the external lattice structure 368 and the internal lattice structure 374 are separate and spaced apart from one another, such that beams (or structs) of the external lattice structure 368 do not intersect or contact with beams (or structs) of the internal lattice structure 374. In other words, the internal lattice structure 374 is contained entirely within inner chamber 386 and the external lattice structure 368 is contained within the outer chamber 388. The internal wall 382 extends between the internal lattice structure 374 and the external lattice structure 368, separating the two structures. For example, in the illustrated example as shown in FIG. 21, the external lattice structure 368 forms a honey-comb shape whereas the internal lattice structures 374 form a body centered cubic shape lattice structure. The external lattice structure 368 extends outwardly from a first surface of the internal wall 382 toward the rear end of the golf club head and the internal lattice structure 374 extends oppositely from the external lattice structure from a second surface of the internal wall. The first surface of the internal wall is opposite of the second surface of the internal wall. The wall thickness between the external and internal lattice structure is between about 0.2 mm and about 10.0 mm, or between about 0.3 mm and about 5.0 mm, or between about 0.4 mm and about 1.5 mm, or between about 0.5 mm and about 1.0 mm, or between about 0.6 mm and about 0.8 mm, or about 0.7 mm, or at least about 0.5 mm, or at least about 0.6 mm, or at least about 0.7 mm.

Still referring to FIG. 21, the shape of internal lattice structure 374 of the inner chamber 386 is different from the external lattice structure 368 of the outer chamber 388. In some examples, the shape of the cell of the lattice structures can be different between the internal lattice structure 374 and the external lattice structure 368. Alternatively, the shape of the lattice structure can be identical. In some examples, the size of the lattice structure can be the same or be different. In some examples, the density of the lattice structure can be the same or be different. In some examples, one or more characteristics (e.g., shape, size, density) of the lattice structure can be the same or different. In some examples, at least a portion of the external lattice structure 368 can be formed integrally with the internal wall 382.

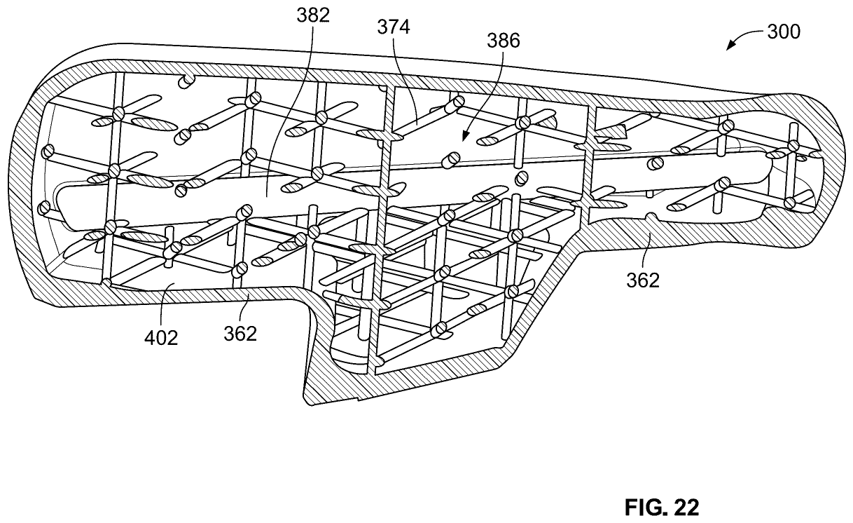

Referring to FIGS. 22-25, the internal lattice structure 374 and/or the external lattice structure 368 may be connected to at least the internal wall 382, the cavity wall 362, or an internal surface 398 (See FIG. 20) of the front side 316 of the body 302 (e.g., front side wall). Referring to FIG. 22, the cross-section of the golf club head 300 illustrates a cavity 308 defined by the cavity wall 362. Accordingly, the internal lattice structures are built around the cavity 308 and the internal lattice structure 374 abuts with an internal surface 402 of the cavity wall 362. Furthermore, at least one of the external lattice structure 368 extends from the internal wall 382 of the lattice structure.

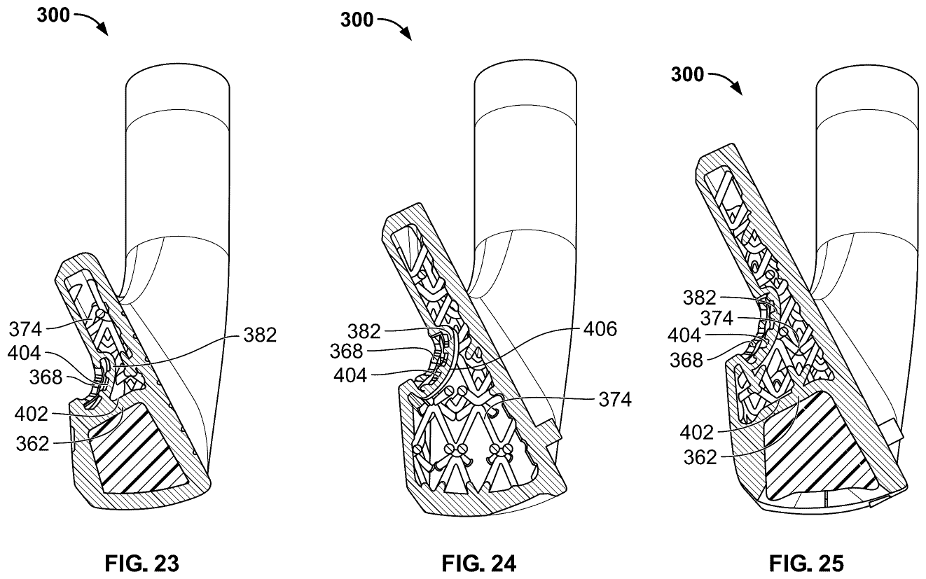

Referring to FIGS. 23-25, cross-sectional views along the heel-to-toe direction of the golf club head 300 are shown. Referring to FIG. 23, a cross-section of the golf club head 300 by the heel region 328 illustrates a cavity 308 along the lower region and the cavity wall 362 abutting with the internal wall 382. In some embodiments, the cavity wall 362 can be formed integrally with the internal wall 382. Referring to FIG. 24, a cross-section of the golf club head 300 within the medial region 326 highlights at least one of the external lattice structure 368 extending from an external side 404 of the internal wall 382 and at least one of the internal lattice structure 374 extending from an internal side 406 of the internal wall 382. In the illustrated example, the internal lattice structure 374 extends along the entire height of the golf club head within the internal volume 360. Referring to FIG. 25, a cross-section of the golf club head 300 by the toe region 324 illustrates at least one lattice portion of the internal lattice structure extending outwardly from the cavity wall 362.

As discussed above, the golf club head includes two separate lattice structures (or elements), i.e., the external lattice structure 368 and the internal lattice structure 374. In some embodiments, the golf club head 300 may include more than two lattice structures. For example, the golf club head can include three, four, five, six, seven, eight, or more separate (or connected) lattice structures. These lattice structures can be positioned externally or internally on the golf club head 300. In some embodiments, the golf club head may only include the internal lattice structure 374. Therefore, in some embodiments, the golf club head 300 may not include the external lattice structure 368 and only include the internal lattice structure 374 inside the body 302 of the golf club head 300. In some embodiments, the golf club head 300 may not include the internal lattice structure 374 or the external lattice structure 368, i.e., the golf club head may include no lattice structure. Further, in some embodiments, the golf club head 300 may just include the external lattice structure 368, i.e., the golf club head 300 may not include an internal lattice structure 374.

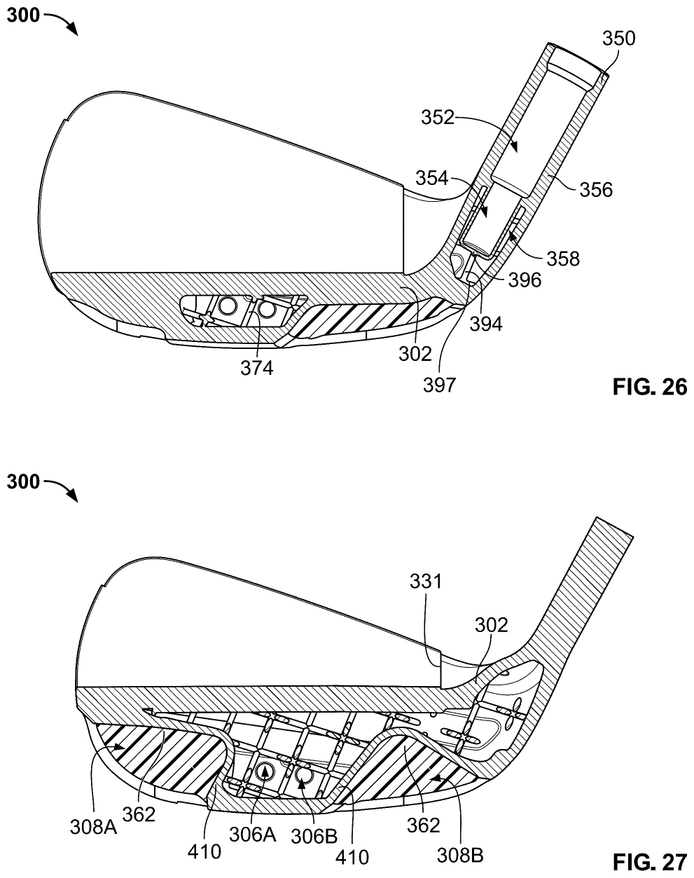

Furthermore, the inner chamber 386 can be interconnected and/or be in communication with a hosel chamber 352 of the hosel 350. Referring to FIG. 26, the hosel chamber 352 includes a suspended internal cup or internal receptacle 354 connected by at least one beam(s) 394 of the internal lattice structure 374 to an outer hosel wall 356. Gaps 358 are formed between the internal cup 354 and the outer hosel wall 356. The suspended internal cup 354 in the hosel chamber 352 can be supported by the at least one beam(s) 394 of the internal lattice structure 374. The at least one beam(s) can be positioned at the bottom relative to the internal cup 354. Specifically, the at least one beam(s) 394 can be positioned to support the internal cup 354 while the golf club head 300 is additively manufactured. The best results are achieved when at least one beam should be placed at a lowermost point 396 of the suspended internal cup 354 in order to support the suspended internal cup 354 and to allow the suspended internal cup 354 to build properly around the outer hosel wall 356.

In some examples, the at least one beam(s) 394 can extend coaxially with the internal cup 354 between the lowermost point 396 of the internal cup 354 and a lowermost transitioning point 397 of the hosel 350. In some examples, the at least one beam(s) can extend from a lattice portion (e.g., beam) of the internal lattice structure 374. In some examples, the beams of the lattice portion forming the at least one beams may be equidistantly spaced from the outer hosel wall 356. In some examples, the beams of the lattice portion forming the at least one beams may be angled relative to the outer hosel wall 356 (e.g., orthogonal). In some examples, the internal cup 354 is configured to receive a hosel weight (not shown). For example, the internal cup 354 can receive a plurality of hosel weights (e.g., stacked weight plates).

As described above, the cavity walls 362 can extend at different angles to define the shape of the cavities 308A, 308B and the weights can be formed conformal to the shape of the cavities. In the illustrated example, referring to FIG. 27, the shape of the first cavity 308A and the shape of the second cavity 308B can be different. Between the first and second cavities 308A, 308B, an internal bridge 410 can be formed by the cavity walls 362 of the first and second cavities 308A, 308B. In some examples, the internal bridge 410 (sole portion between the cavities) can be slanted relative to the inset edge 331 of the body 302. In some examples, the internal bridge is formed integrally with the cavity walls 362. Further, the first and second aperture 306A, 306B can be disposed between the cavity walls 362 of the first and second cavities 308A, 308B. In other words, the first and second apertures 306A, 306B is disposed within the internal bridge 410 of the body 302. In some examples, the first and second aperture 306A, 306B are placed such that the first and second apertures 306A, 306B does not intersect with the beams of the internal lattice structures.

As discussed above, the golf club head can be manufactured through an additive manufacturing process, e.g., 3D printing. The entire golf club, the golf club head, the shaft, the grip, and/or any component on or portion of the golf club or golf club head can be manufactured via an additive manufacturing process and include any of the features disclosed herein. Therefore, a component, e.g., a weight, a sensor, caps on the tungsten weights, a face, a portion of the golf club head, and/or a section of the golf club, can be manufactured through an additive manufacturing process and then added to the golf club and/or golf club head thereafter. As noted herein, a component of the golf club or golf club head can include any portion, section, or item on the golf club and/or can be the entire head of the golf club. In some embodiments, a sensor may be added to the golf club head and/or the golf club. In some embodiments, extra stock material can be added to the golf club head during the printing process. The extra stock material is added to this section of the golf club head because extra support during the manufacturing process is built in this area to assist in the 3D printing of the golf club head. The removal of this extra support creates a rougher surface that takes more polishing to clean up. Therefore, the extra material is applied to the golf club head to make sure that the extra polishing does not hinder or affect the intended finished part shape. In some embodiments, this extra stock material can minimize the support needed on the golf club head during 3D printing.

Further, in some embodiments, a component of the golf club head and/or the golf club can be 3D printed separate to the golf club head and/or the golf club. Therefore, the 3D printed component can be added to the golf club head and/or the golf club after the golf club head and/or the golf club is formed. In some embodiments, the golf club head can include a first portion and a second portion. The first portion may be formed through an additive manufacturing process, i.e., 3D printed, and the second portion may be formed through a traditional manufacturing process, i.e. casted, forged, MIM, etc., and not through an additive manufacturing process. Therefore, the first portion, which may be 3D printed, can be added to the second portion, which may not be 3D printed. For example, in some embodiments, a lattice element/component may be 3D printed separately and attached to a body of the golf club head as a separate element after the body of the golf club head is formed. The body of the golf club head can be formed through casting, forging, MIM, etc. and may not be formed through a 3D printing process. In some embodiments, the body of the golf club head may be formed through a 3D printing or additive manufacturing process. Any component on the golf club can be 3D printed or formed through an additive manufacturing process and include a lattice or non-lattice configuration.

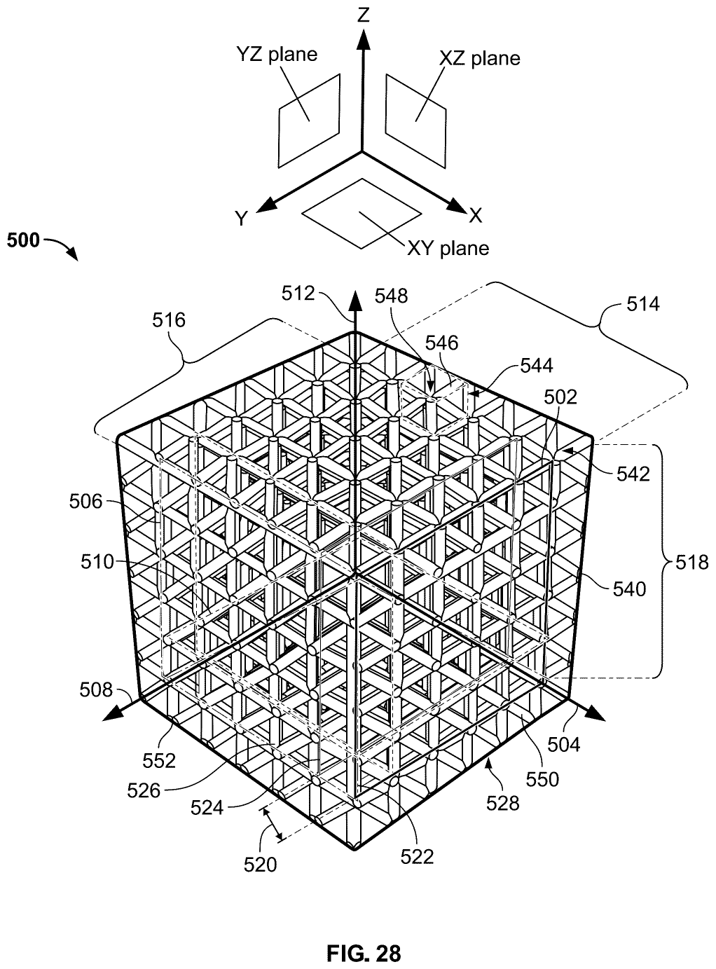

Referring to FIG. 28, a lattice environment 500 can be implemented to the three-dimensional model of the golf club head to optimize the location of a lattice structure within the internal volume. The lattice environment 500 includes a first plane or X-plane 502 along the X-direction 504, a second plane or Y-plane 506 along the Y-direction 508, and a third plane or Z-plane 510 along the Z-direction 512. The X-plane 502 includes a plurality of X-planes 514 spaced along the X-direction 504 and parallel with each other. The Y-plane 506 includes a plurality of Y-planes 516 spaced along the Y-direction and parallel with each other. The Z-plane 510 includes a plurality of Z-planes 518 spaced along the Z-direction and parallel with each other. In some embodiments, a spacing 520 between the plurality of planes along the same direction can be identical. For example, in the illustrated embodiment, the spacing 520 between the plurality of planes along the X-direction 504, the Y-direction 508, and the Z-directions are all identical (e.g., square-shaped). Alternatively, in some embodiments, the spacing 520 between the plurality of planes can be different. For example, the spacing 520 along the X-direction 504 can be greater than the spacing 520 along the Y-direction 508. In some examples, the spacing 520 between a first layer 522 and a second layer 524 of the plurality of X-planes 514 can be greater than the spacing between a second layer 524 and the third layer 526 of the plurality of X-planes 514.

As described above, the plurality of X-planes 514, the plurality of Y-planes 516, and the plurality fo Z-planes are intermeshed with one another to for a lattice array 528 including a plurality of nodes 540. For example, the plurality of Y-planes 516 is laterally orthogonal to the plurality of X-plane 514 and the plurality of Z-plane 518 is vertically orthogonal to the plurality of X-plane 514. The arrangement of the plurality of nodes 540 within the lattice environment 500 defines the shape of the lattice array 528. In the illustrated example, a body centered cubic (BCC) lattice array is shown. The plurality of nodes 540 is located at corners 542 of a cube 544, and there is an intersecting lattice point 546 at a center 548 of the cube 544. A plurality of beams 550 extend diagonally from one corner of the cube 544 to the opposite corners of the cube while intersecting the lattice point 546 at the center 548 of the cube 544. Furthermore, in some embodiments, edges 552 of the cube 544 can be connected by the plurality of beams 550 along the vertical direction 338 or lateral direction 330. In other words, the plurality of beams 550 can connect the plurality of nodes 540 in a single direction, or in multiple directions. Accordingly, the plurality of beams 550 extending diagonally between the corners of the cube 544 are longer than the plurality of beams 550 extending between the edges 552 of the cube 544. In some embodiments, the edges 552 of the cube 544 may not be connected by the plurality of beams.

In some embodiments, the lattice array 528 may include different patterns of plurality of beams 550 along different directions (e.g., X-direction, Y-direction, or Z-direction) to form the lattice environment 500. Furthermore, a thickness of the plurality of beams 550 along different directions can be different. For example, the plurality of beams 550 along the X-direction may be about 1.12 mm whereas the plurality of beams 550 along the Y-directions may be about 1.22 mm. In some examples, different patterns of the plurality of beams 550 between the plurality of nodes 540 can vary the shape of a cell of the lattice array 528 forming the lattice environment 500. As described above, the density of the lattice environment 500 can be controlled by the spacing 520 between the plurality of planes 514, 516, 518 of the lattice environment 500. Accordingly, the lattice array 528 can vary in at least the pattern, size, shape, density, or the like. In some embodiments, the lattice environment 500 can be designed accordingly to the swing characteristics of a user or the type of the golf club. For example, the lattice array 528 can include larger spacing around the faceplate region while including smaller spacing around the hosel and the edge of the golf club head. In some examples, a beam thickness of the lattice array 528 can vary to control the spacing between the lattice array 528. For example, the beam thickness of the lattice array 528 can be thicker toward the edge of the golf club head whereas the beam thickness of the lattice array 528 is thinner around a striking region of the golf club head. In some examples, the beam thickness of the lattice array 528 can be vary throughout the length of the beam of the lattice array. In some examples, the lattice array 528 can be denser about the desired location (e.g., medial region, central region, lower region, upper region, heel region, toe region) of the golf club head to shift the Center of Gravity (CG) or the Moment of Inertia (MOI).

Once the lattice array 528 in designed within the lattice environment 500, the three-dimensional model of the golf club head can be inlaid onto the lattice environment 500 to identify the configuration of the lattice structure within the internal volume of the golf club head. Referring to FIGS. 28-31, different views of inlaying the three-dimensional model onto the lattice environment 500 is shown. For example, the lattice environment 500 can be manipulated using a three-dimensional software to rotate the lattice array 528 to establish connection points 560 along the body of the golf club head. In some embodiments, the connection points 560 can be the plurality of nodes 540 forming the lattice array 528. In some embodiments, the connection points can be a portion of the plurality of beams 550. The location of connection points 560 can be determined by the designer (e.g., designer can select the exact location and shape of the lattice structure) or can be determined by an optimization program (e.g., topology optimization).

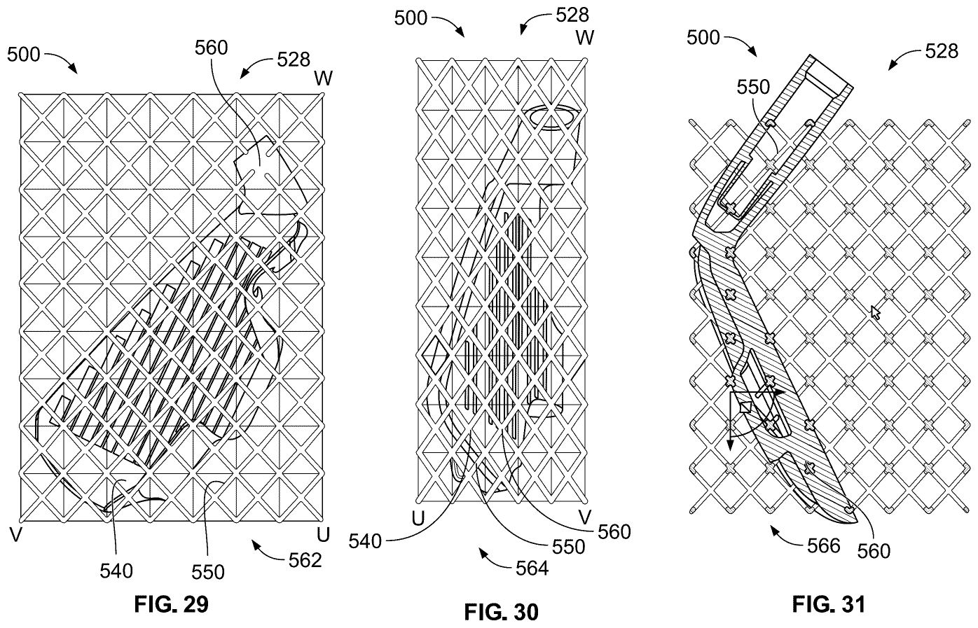

For example, referring to FIG. 29, the lattice array 528 is positioned such that plurality of beams 550 extends transversely from a topline of the golf club head when viewed from the front side of the golf club head. As illustrated in FIG. 29, a portion of the plurality of beams 550 are configured to establish connection points with the body of the golf club head. Once the connection points 560 along a first plane 562 are determined, the connection points 560 along a second plane 564 can be determined. For example, the lattice environment 500 can be rotated in order to provide the shape of the lattice array 528 based on the connection points 560 determined along the first plane 562. Referring to FIG. 30, a second plane 564 based on the connection points 560 determined along the first plane 562 (e.g., with respect to FIG. 29) illustrates how two connection points 560 may be established along the second plane.

In some examples, the user can also position the plurality of beams 550 of the lattice array 528 based on the plurality of planes (e.g., cross-sections). For example, referring to FIG. 31, a single plane 566 along the plurality of planes forming the lattice array is illustrated inlaid onto the cross-section of the body of the golf club head. This allows the user to manipulate the connection points 560 of the lattice array 528 layer-by-layer. In some examples, the connection points 560 of a single plane 566 can be manipulated in view of the additive manufacturing process. Since the process of additive manufacturing is performed layer-by-layer, the plurality of beams 550 and the connection points 560 can be manipulated in accordance with the printing path of the 3D printer.

Once a position of the lattice array 528 is secured, i.e., the connection points 560 between the nodes and the plurality of beams 550 are established with the golf club head, a lattice structure based on the lattice array 528 is generated. In other words, the lattice array protruding beyond the boundary of the golf club head is removed from the design space of the CAD software. In some examples, the lattice structure can be conformal to the shape of the golf club head. In other words, the lattice structure will be constructed such that the lattice structure is generated around cutouts, grooves, apertures, or the like.

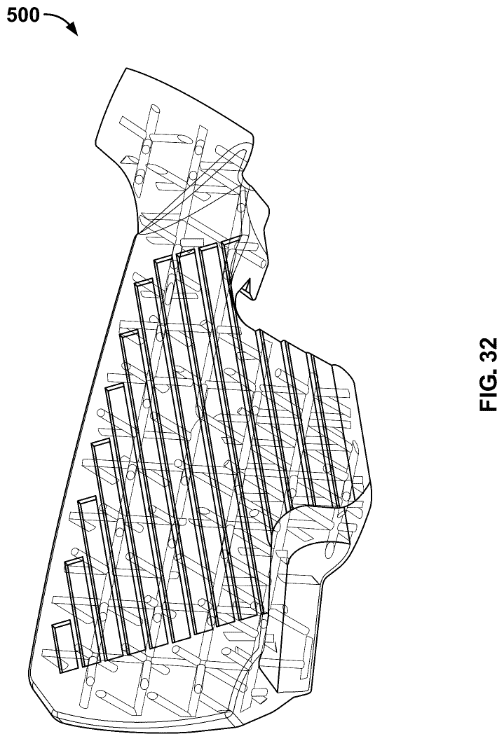

Referring to FIG. 32, a solid core is shown (e.g., three-dimensional model of the body created for printing the golf club head) inlaid with the lattice structure. Once the lattice structure is generated, the user can identify whether additional beams need to be reinforced between the lattice structure formed by the lattice array. For example, the user can extend a length of a beam when one end of the beam is not in contact with a part of the golf club head. Alternatively, the user can cut of unwanted lattice structure (e.g., make the beam length short) to reduce the weight of the golf club head.

In some examples, the printing conditions include beam angle relative to build plane, length, thickness, reinforcement/radius connection with the body, etc. Coordinates can be implemented into the computer system to define a selection of volume of the lattice structure that will be within the golf club head. The beam segments outside of this volume can be removed, i.e., the beam segments of the lattice structure not within the golf club head can be removed. Further, although the lattice frameworks have uniformity in one or more directions (same length in X direction of each beam, same length in Y direction of each beam, same length in Z direction of each beam, same length and thickness, and/or same unit cell size), the lattice framework can also be selectively varied throughout the golf club head. For example, certain sections of the golf club head may include a denser concentration of beams than in another section.

In some examples, additional lattice environment can be partitioned by different lattice arrays formed in different regions of the golf club head. For example, lattice environment can include a first lattice array that is separated by the internal wall such that the first lattice array is formed within the inner chamber of the internal volume and also include a second lattice array that is separated by the internal wall such that the second lattice array is formed within the outer chamber of the internal volume. In some examples, the first lattice array can be different in at least size, shape, density from a second lattice array. In some examples, the thickness of the beams can be different between the first and second lattice arrays. In some examples, the first and second lattice arrays can be identical.

In the illustrated example, referring back to FIG. 3, the orientation of the internal lattice structure needs to take into account two important factors for manufacturability. First, it is important to make sure there is no unsupported walls that will not be able to be built (portions of the head that are generally more than 45 degrees off from a normal axis of a build plane or less than 45 degrees from the build plane). Second, as described above, if there is an inner chamber in the head design, it is important to make sure that powder removal holes (e.g., first and second apertures) that lead to this chamber are free from lattice intersections. It has been found advantageous (e.g., to provide improved fluid flow performance) to have the two apertures offset or spaced apart from the lattice beams on the interior of the golf club head.

Aspects of the present disclosure includes systems and methods for providing an inventory of golf club equipment, such as golf clubs or components thereof, with more varying characteristics that are selectable by a user compared to currently available golf club equipment. For example, a golf club manufacturer can provide golf club sets with golf club components, such a golf club head, that can be produced based on a user's selection of predetermined ranges of golf club head specifications. By limiting the provided predetermined ranges of golf club head specifications made available to the user, the golf club manufacturer can more easily form the selected golf club head via an additive manufacturing process while providing a larger range of customizable golf club characteristics to the user than currently available golf club heads that are formed using traditional manufacturing methods.

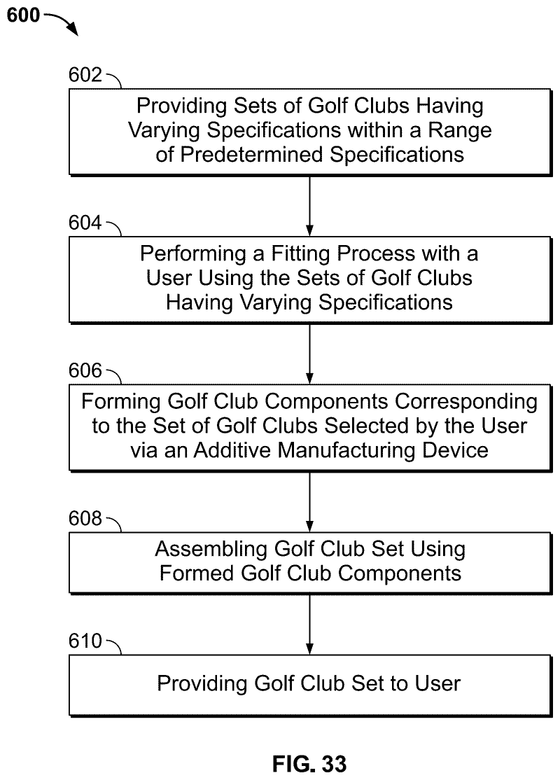

Turning now to FIG. 33, a method 600 of providing golf club sets according to an embodiment of the present disclosure is shown, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 602, sets of golf clubs having varying specifications within a range of predetermined specifications are provided. For example, the sets of golf clubs can have golf club components, such as golf club heads, that have varying specifications within each set of golf clubs.

Golf club component specifications of the provided golf club sets that can be varied within a predetermined range of specifications can include any one or more of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head Center of Gravity location, club head Moment of Inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

The sets of golf clubs provided in block 602 can be provided to a golf club fitter that can use the sets of golf clubs in a fitting process for a user. Accordingly, block 604 includes performing a fitting process with a user using the sets of golf clubs having varying specifications. The fitting process of block 604 can include a wide range of fitting steps or methods. The user can test the sets of golf clubs and determine, with the assistance of the fitter, which particular specifications provided in a particular golf club set of the provided varying golf club sets is ideal for the user's swing characteristics. In some embodiments, the fitting process of block 604 can utilize a golf simulator.

Block 606 of method 600 includes forming golf club components corresponding to the set of golf clubs selected by the user via an additive manufacturing device. For example, block 606 can include forming golf club heads having specifications that correspond to the specifications of the golf club heads of the selected golf club set by the user. In some embodiments, the method 600 can include one or more additional steps before golf club components are formed in block 606. For example, in such embodiments, the method 600 can further include preparing design files corresponding to the golf club components for printing via the additive manufacturing device, which can include adding polishing stock to certain areas, machining stock to certain areas or extra material where the build supports connect to the golf club head (such as, e.g., to areas where additive manufacturing build supports will be placed during printing), among others.

With the golf club components formed in block 606, block 608 of method 600 includes assembling the golf club set using the formed golf club components. For example, block 608 can include assembling a golf club shaft and grip with the formed golf club heads to produce the user selected golf club set, which can be provided to the user as in block 610.

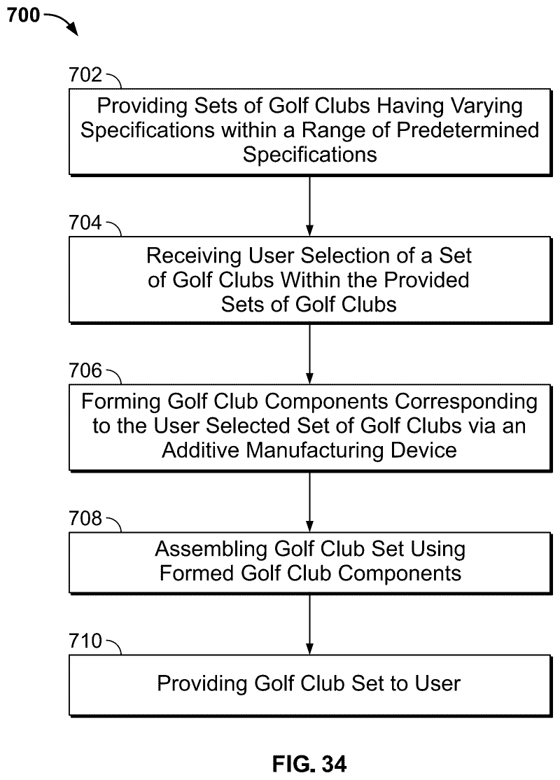

It is contemplated that in some embodiments a user may select a golf club set from provided sets of golf clubs having varying specifications without visiting a fitter. Accordingly, FIG. 34 illustrates another method 700 of providing golf club sets according to an embodiment of the present disclosure, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 702, sets of golf clubs having varying specifications within a range of predetermined specifications are provided. The provided sets of golf clubs in block 702 can have varying specifications as described with reference to block 602 of method 600. The provided sets of golf clubs in block 702 can be provided to a user in physical form or can be otherwise listed for a user to select, such as on a website, a catalogue, etc.

Block 704 includes receiving a user selection of a set of golf clubs within the provided sets of golf clubs in block 702. For example, block 704 can include receiving an order from the user for a particular set of golf clubs such as an online order. Block 706 of method 700 includes forming golf club components corresponding to the set of golf clubs selected by the user via an additive manufacturing device. For example, block 706 can include forming golf club heads having specifications that correspond to the specifications of the golf club heads of the selected golf club set by the user. In some embodiments, the method 700 can include one or more additional steps before golf club components are formed in block 706. For example, in such embodiments, the method 700 can further include preparing design files corresponding to the golf club components for printing via the additive manufacturing device, which can include adding polishing stock to certain areas, machining stock to certain areas or extra material where the build supports connect to the golf club head (such as, e.g., to areas where additive manufacturing build supports will be placed during printing), among others. In some embodiments, other types of polishing methods can be used remove imperfections and scratches to enhance the appearance of the golf club head. For example, various polishing processes such as tumbling polishing, mechanical polishing, chemical polishing, vibratory polishing, or the like, can be added to certain areas of the golf club head to enhance the appearance of the golf club head. In some embodiments, different types of post-processing techniques can be implemented. In some embodiments, there may be no need for post-processing techniques to be implemented.

With the golf club components formed in block 706, block 708 of method 700 includes assembling the golf club set using the formed golf club components. For example, block 708 can include assembling a golf club shaft and grip with the formed golf club heads to produce the user selected golf club set, which can be provided to the user as in block 710.

Aspects of the present disclosure further includes systems and methods for selecting and fabricating golf club equipment, such as golf clubs or components thereof. A user, e.g., a golfer, can utilize such systems to design and have fabricated a wide variety of golf equipment ranging from a specifically constructed golf club head to a full set of golf clubs with combinations of desired components common throughout the set. In some aspects, systems of the present disclosure can allow novice or average golfers to experience the benefits of professional fitting and custom clubs commonly used by professional golfers. In particular, the user can select various characteristics of the golf club head that may be optimal for his or her swing characteristics or level of skill. In some embodiments, systems of the present disclosure can include fabrication equipment, such as an additive manufacturing machine, used to form customized components golf clubs. In other embodiments, systems of the present disclosure result in the output of design parameters or a design model that can be used by an additive manufacturing machine to produce the desired golf club components.

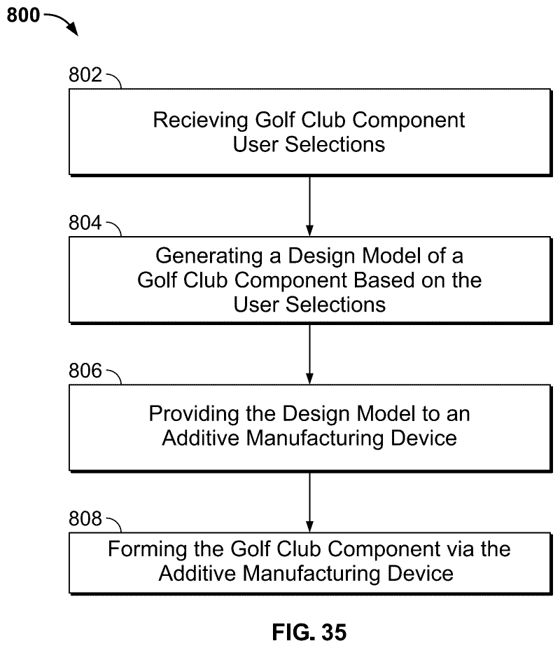

Turning now to FIG. 35, a method 800 for providing golf club components according to an embodiment of the present disclosure is shown, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 802 golf club component selections are received by a user. A user may be the end user of the golf components, e.g., a golfer, or the user may be a professional fitter or other golf professional. Golf club component selections can be selected by a user and can include any one or more of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head Center of Gravity location, club head Moment of Inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

At block 804, a design model of a golf club component can be generated based on the user selections received at block 802. As discussed in greater detail below, the design model can be a virtual object or a set of parameters of the golf club component. In some embodiments, the design model can be a set of instructions for an additive manufacturing machine to form a physical object of a virtual object or set of parameters. In some embodiments, the design model can be displayed to the user (via, for example, a display screen) and updated in real-time while the user makes the golf club component selections prior to block 802. In some embodiments, the golf club component can be one or more of a golf club head, such as, e.g., an iron-type head or driver-type head, a golf club shaft, or a golf club grip.

At block 806, the design model generated in block 804 is provided to an additive manufacturing machine or system. The additive manufacturing machine can be any machine configured to perform any of the additive manufacturing processes described herein. In some embodiments, the design model can be provided directly to the additive manufacturing machine. In some embodiments, the additive manufacturing machine is connected to a network and the design model is provided to the additive manufacturing machine via the network. In some embodiments, the design model can be provided to a user and the user can provide the design model to the additive manufacturing machine. It is contemplated that the additive manufacturing network may include a plurality of additive manufacturing systems distributed across a geographical area and selected based on proximity to a shipping address provided by the user in connection with the design model. In some embodiments, the additive manufacturing system is selected based on availability as determined by a software program or algorithm considering various production factors, e.g., geographic location, materials required, production time, surface finish, and/or quantity.

At block 808, the golf club component is formed via the additive manufacturing machine. The golf club component can be formed via any one or more of the additive manufacturing processes and any one or more of the materials described herein. In some embodiments, the additive manufacturing machine can be part of a manufacturing system that can include other machines that perform other manufacturing processes to form or finish the golf club component. In some embodiments, one or more components of the golf club component can be additively manufactured and assembled with other components to form the golf club component. In some embodiments, the golf club component can be a golf club head and a lattice structure can be formed integrally with the golf club head.

It should be appreciated that the method 800 can include additional steps corresponding to a user's determination of the golf club component selections in block 802. For example, in some embodiments, a user conducts a fitting session and data obtained during the fitting session can be used to generate recommended golf club component selections for the user to select. In some embodiments, the user's golf club component selections can be referenced with one or more databases before the design model is generated. In some embodiments, the method 800 can further include, before the golf club component is formed in block 808, preparing design files corresponding to the golf club components for printing via the additive manufacturing device, which can include adding polishing stock to certain areas, machining stock to certain areas or extra material where the build supports connect to the golf club head (such as, e.g., to areas where additive manufacturing build supports will be placed during printing), among others.

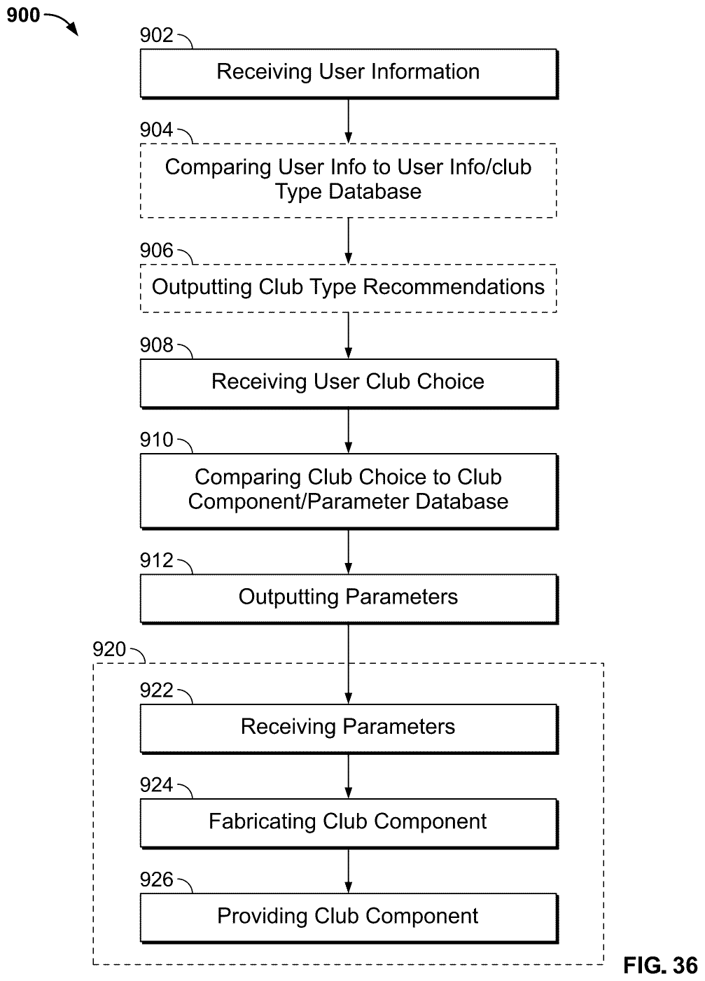

Referring now to FIG. 36, a flowchart of a method 900 for selecting golf club components according to an embodiment of the present disclosure is shown, which includes fewer or more steps than depicted. Further, the following steps may be performed in any order or sequence and may further include pauses or spans of time in between. The following steps may be performed by a single entity, a single device or system, multiple entities, or multiple devices or systems. Beginning at block 902 information is received from a user. A user may be the end user of the golf components, e.g., a golfer, or the user may be a professional fitter or other golf professional. The user may enter any of the below-listed information, as it would be helpful in determining the best golf club component for the user or assuring that the selected golf club components are to the user's liking and delivered to the user (or a third party) in a timely manner. The information may be selected from: name, address, height, weight, sex, handedness, age, geographic location, golf score handicap, physical limitations, annual income, frequency of play, frequency of airline travel, favorite color, alma matter, current clubs or any combination thereof.

A user may input additional information relevant to a selection of golf club components, such as a preference for any of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head Center of Gravity location, club head Moment of Inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, club price, number of clubs of the golf club set, and manufacturing information.

In some embodiments, the user may input swing metrics relevant to a selection of golf club components, such as any of the following: swing speed, club head angle of attack, face closure rate, consistency of impact, swing path relative to target, angle of head rotation prior to impact, club head acceleration curve, average impact location, among others. In such embodiments, swing metrics can be recorded and calculated during a fitting process (such as, e.g., via launch monitors) or entered by the user if already known. In some embodiments, a user may upload still or moving images of a golf swing, e.g., a video of the user swinging a golf club. The user may provide information about ball trajectories or flight distances. In some embodiments, the ball trajectory information may be provided by an optical, IR, or ultrasonic camera, or from a pressure pad, e.g., information from a golf simulator. In some embodiments that receive images or flight data, additional components of the system (not shown) may analyze the images or flight data to produce metrics used in subsequent steps of method 900 to output club type recommendations. For example, in some embodiments, a standard club (i.e., a control club) can be swung by the user during a fitting process and recordings/data from the fitting process can be provided to a computer (e.g., an algorithm operated by the computer) that is configured to analyze the recordings/data and provide recommendations that help guide the user to club selections that may maximize their performance.

At block 904 the information provided by the user is compared to a database relating player information and golf club components (i.e., a user info and club type database). Based upon the comparison in block 904, one or more golf clubs, or golf club components, are output to the user at block 908. Blocks 904 and 908 are optional, however, as the method 900 may simply require the user to input information which is received at block 902 and then the method 900 proceeds to block 910 where a user club choice is received, as described in greater detail below. In some embodiments, the user info and club type database in block 904 may include club types or golf club sets with a predetermined range of varying specifications, similar to block 602 of method 600 and to block 702 of method 700.

The user info and club type database in block 904 provides club component options based upon information provided by the user. A variety of user info and club type databases may be used with method 900 of the present disclosure. For example, the user info and club type database in block 904 may be as simple as a look-up table relating shaft length to golfer height. In other instances, the user info and club type database in block 904 may correlate different styles of club heads with user information about age and golf score handicap. In some embodiments, the user info and club type database in block 904 may comprise algorithms that suggest particular types of club components based upon combinations of user information. For example, values of height, weight, age, sex, handedness, and handicap may be combined to produce a value for comparison to the user info and club type database.

At block 910, user choices of golf clubs or golf club components are received. The choices may be selected from the recommendations output in block 708, or club component choices may be received independently of the recommendations from the user. The user choices may include any of the following: club type, club shaft type, club shaft length, club shaft stiffness, club shaft material (e.g., steel, graphite, composite, or combinations thereof), club shaft shape (e.g., cylindrical, elliptical or ovular, tapered, single bend, double bend, etc.), club shaft color, club grip type, club grip thickness, club grip length, club grip material, club grip color, club head type, club head color, club head loft angle, club head lie angle, club head weight, club head size, club head volume, club head shape, club head material, club head surface roughness, club head reflectivity, club head alignment aid configuration, club head toe support lines, club head sole bounce, club head sole design, club head sole width or camber, club head crown design, club head Center of Gravity location, club head Moment of Inertia value, club head product of inertia values, club head coefficient of restitution, club head face angle, club head face thickness, club head face size, club head face design, club head face profile shape, club head offset, club head topline thickness, club head length, club head blade length, club head scoreline length, club head scoreline spacing, club head scoreline pattern, club head scoreline location, club head hosel length, club head hosel configuration, club head hosel design, club head blade profile shape, club head leading edge type, club head par area length, club head groove type, club head groove design, club head impact point location, club head impact sound, club head impact feel, club head filler material, club head filler density, club head weight receptacles and weight members attachable thereto (e.g., number of weight receptacles, arrangement of weight receptacles, size of weight receptacles and corresponding weight members, weight member material, weight member density, etc.), club head weight members, club head finish type (e.g., anodized, painted, plated, physical vapor deposition (PVD), etc.), club head insignia, club head medallion design, number of clubs of the golf club set, and manufacturing information.

Additionally, a software interface can allow the user to edit aspects of the golf club or component thereof, e.g., club head design, specifications, shape, etc., based on user preferences. For example, in some embodiments, golf club component design files generated based on user choices received in block 710 can be updated by a human using software (or an interface thereof) at the direction of the user (i.e., a consumer or a fitter) in real-time. An algorithm can then compute the expected mass properties of the golf club head and advises the user of end results. Also, the algorithm may highlight areas to add material (or volume), and areas to remove material to achieve desired characteristics. Starting templates can be utilized to help quickly shape the club. Virtual construction lines can be used to graphically illustrate dimensional limits, or boundaries for preventing the user from creating non-conforming clubs according to the United States Golf Association (USGA) rules, as well as exceeding traditional design guidelines with respect to head weight. Personalization features can be graphically incorporated and erased. Digital renderings can be utilized to give realistic feedback of the final product. In some embodiments, the final product can be produced as a virtual object to be viewed by the user.

At block 912, the golf club component selections are compared to a database correlating club components to a parameter database (i.e., a club component and parameter database). The parameters may include specific information about golf club components or entire clubs. For example, the club component and parameter database in block 912 may include combinations of stock components (such as, e.g., shafts, grips, club heads, ferrules, hosels or hosel adapters, etc.) that can be assembled to produce a golf club of the user's choosing. Thus, a user selection of a golf club can be correlated with specific components and instructions needed to construct the club. In some embodiments, the club component and parameter database in block 912 may include club types or golf club sets with a predetermined range of varying specifications, similar to block 602 of method 600 and to block 702 of method 700. In some embodiments, the parameters include schematics, for example, a design file such as computer-aided drafting (CAD) files, that can be used to fabricate, form, or construct golf clubs or golf club components. The parameters may include specific materials, tolerances, etc. to accompany the schematics. The parameters may include instructions or computer code for controlling machines used to fabricate clubs or club components, for example additive manufacturing machines. In some embodiments, the design files include specifications for forming a golf club head or components thereof using an additive manufacturing machine.

In some embodiments of the method 900, parameters regarding the golf club or golf club components, e.g., design files, are output at block 912. In some embodiments, the parameters will not be output to the user, but rather they will be retained for order fulfillment or sent to a third party, such as a fabricator, manufacturer, or assembler. In other embodiments, the parameters output at block 912 can be provided directly to a user and the user can fabricate the golf club component and assemble a golf club with the component. For example, in some embodiments, the user can form the golf club head using an additive manufacturing machine and can assemble the golf club using other components obtained by the user, such as, the shaft and grip.

In some embodiments, the output parameters are sent to a fabricator 920, as indicated by dashed boxes, where the golf club or golf club components will be fabricated. In some embodiments, the fabricator is owned by the owner of the system, i.e., the entity that controls the servers used to perform the recited methods as discussed below. In other embodiments, the fabricator is independent of the owner of the system, but the actions of the fabricator are controlled by the owner of the system, either by contract or because the fabricator is acting as an agent of the owner of the system. In some embodiments, the fabricator is the user that purchases the golf club (i.e., the parameters or design files of the golf club) and fabricates the golf club or components thereof using a machine owned by the user, such as an additive manufacturing machine. Thus, the method 900 is illustrated to include blocks 922, 924, and 926 in dashed box 920 even when the fabricator is geographically or legally separate from the owner of the method 900.

At block 922, the fabricator receives parameters of the golf clubs or golf club components that were selected by the user. Using the parameters, the fabricator then fabricates the golf clubs or components thereof at block 924. The fabrication process may include casting, forging, bending, stamping, cutting, milling, polishing, plating, grinding, welding, drilling, gluing, extruding, injecting, or sintering. For example, in some embodiments, the fabricating block 924 includes forming a golf club head via one or more additive manufacturing process such as, e.g., any of the additive manufacturing processes using any of the materials described herein. Using such additive manufacturing processes, a wide variety of club shapes and configurations can be constructed, even shapes that are not attainable using conventional machine tools. For example, using additive manufacturing processes, it is possible to form a club head having a void with a lattice structure formed therein. Additive manufacturing processes may be used in combination with other processes, for example cutting, welding, or polishing, etc. Components of clubs that are specially fabricated for the user via an additive manufacturing process or otherwise may be combined with other components that are “off the shelf,” for example, a commercially available golf club grip.

In some embodiments, method 900 can include one or more additional steps after the fabricator receives the parameters, as in block 922, and before the golf clubs or components are fabricated, as in block 924. For example, in such embodiments, method 900 can further include preparing design files for printing, which can include adding polishing stock to certain areas, machining stock to certain areas or extra material where the build supports connect to the golf club head such as, e.g., to areas where additive manufacturing build supports will be placed during printing, among others. Once the fabrication process is complete, the club component is provided in block 926. The component may be provided to the user directly, e.g., via direct shipping, or the component may be provided to an assembler who will combine the fabricated component with other fabricated components or other commercially available components to achieve the user club choice. In some instances, the provided component may be packed, e.g., in a box, and labeled for delivery. In some embodiments, the method 900 may not include block 926 in instances in which the user is the fabricator.

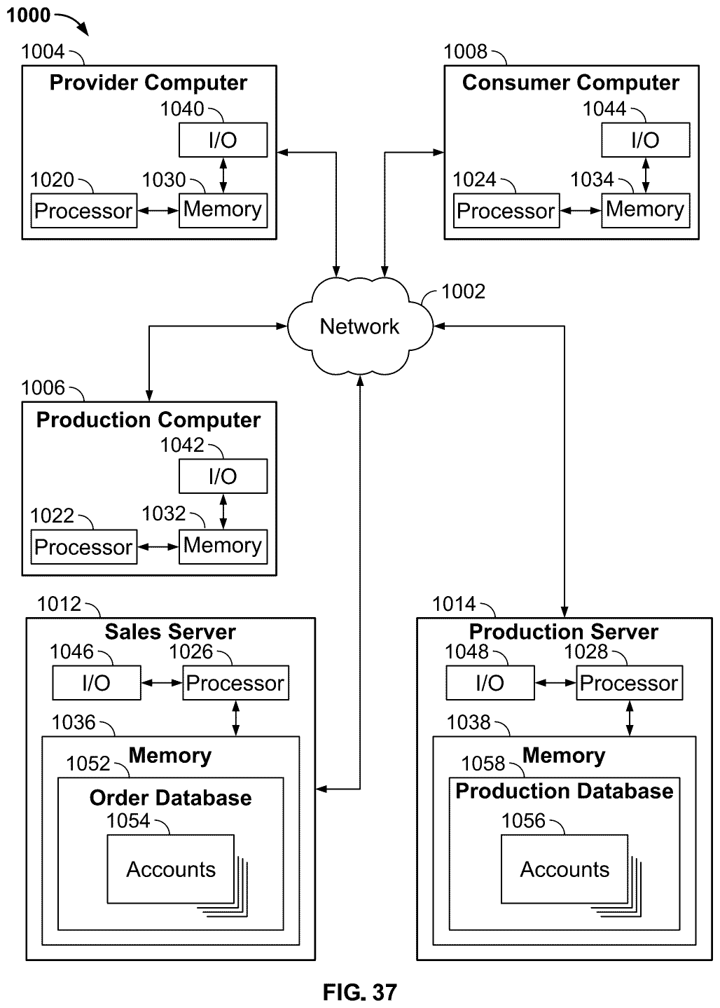

A system of the present disclosure can include at least a processor and a computer readable medium having instructions for the processor to carry out tasks according to methods of the present disclosure. However, in practice, a system of the present disclosure will typically include other components such as graphical interfaces, input/output devices, transitory computer readable media, and a network. Systems of the present disclosure may additionally include fabrication equipment, such as an additive manufacturing machine. FIG. 37 shows components in an exemplary system for selecting customized golf clubs or golf club components. As shown in FIG. 37, a system 1000 generally includes one or more computers, communicably coupled via a network 1002. Systems and methods of the present disclosure may generally be implemented through the use of one or more computers such as any combination of a provider computer 1004, a production computer 1006, and a user computer 808 along with, for example, a sales server 1012 and a production server 1014. A computer generally includes a processor (e.g., 1020, 1022, 1024, 1026, 1028) operably coupled to a memory (e.g., 1030, 1032, 1034, 1036, 1038) and configured to send or receive information via an input-output device (e.g., 1040, 1042, 1044, 1046, 1048).

One of skill in the art will recognize that a processor may be provided by one or more processors including, for example, one or more of a single core or multi-core processors. In certain embodiments, any of provider computer 1004, production computer 1006, or user computer 1008 may be a desktop or laptop computer, tablet, or mobile device. Input-output devices generally includes one or a combination of monitor, keyboard, mouse, data jack (e.g., Ethernet port, modem jack, HDMI port, mini-HDMI port, USB port), Wi-Fi card, touchscreen (e.g., CRT, LCD, LED, AMOLED, Super AMOLED), pointing device, track pad, microphone, speaker, light (e.g., LED), or light/image projection device.

In certain embodiments, a user's selection of options is received via the user's use of user computer 1008 and the selection is received at sales server 1012 and stored in memory 1036. Sales server 1012 uses a network card for input/output 1046 to received data. Sales server 1012 maintains order database 1052 which may include accounts 1054 where user information is stored (e.g., for payment and delivery information). After orders are received and ready for production, digital files can be transferred via input/output 1046 from sales server 1012 to production server 1014 via input/output 1048, which may also be a network card or other data transfer mechanism. In some examples, the input/output can be an email or an email including a link to a cloud server. Order information (e.g., orders 1056) is stored in production database 1058 in memory 1038. Processor 1028 executes computer program instructions stored in memory 1038 to perform order batching and to initiate production.

A production facility may be equipped with a production computer 1006 which either automatically coordinates the operation of machines or provides information to production employees, e.g., via input/output 1042, which could include, for example, a monitor or laser printer. The production computer 806 may also be directly connected to fabrication equipment, such as an additive manufacturing machine.

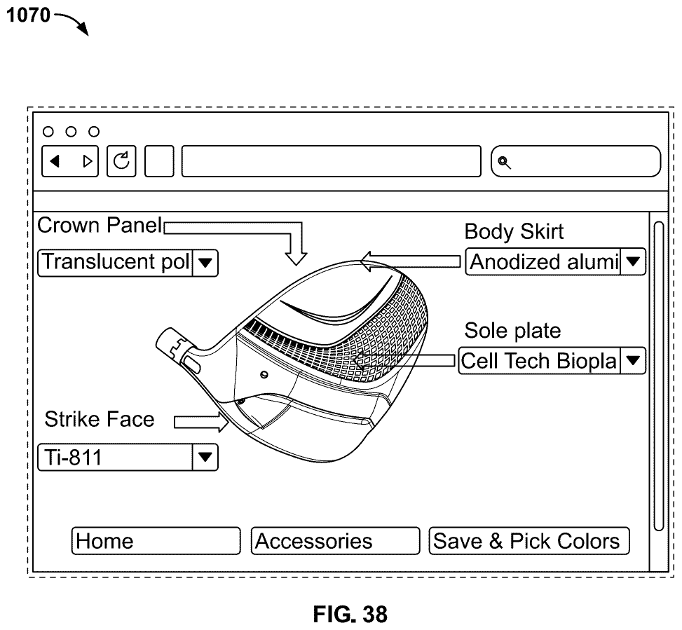

Many of the steps and functions described herein can be planned or coordinated by a provider personnel using provider computer 804. For example, engineers or sales personnel can prepare and upload information (e.g., digital files) that, for example, lists options for features for user selection. That is, in certain embodiments, provider personnel use provider computer 1004 to “set up” what options are available, for example, within a display such as the one shown in FIG. 38. Such uploaded information may be saved in memory 1036 on sales server 1012 and can be used, for example, by processor 1026 to cause a display to be rendered such as that shown in FIG. 38 on input/output 1044 on consumer computer 1008. Input/output 1044 can include a monitor displaying a view of a web browser. A user's selection of options can be stored in one of accounts 1054 in order database 1052 by writing a file in memory 1036.

Memory generally refers to one or more storage devices for storing data or carrying information, e.g., semiconductor, magnetic, magneto-optical disks, or optical disks. Information carriers for a memory suitable for embodying computer program instructions and data include any suitable form of memory that is tangible, non-transitory, non-volatile, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); magneto-optical disks; and optical disks (e.g., CD and DVD disks). Memory may also be external to the device and reside on a server or disk in an alternative location, i.e., “the cloud.” The processor and the memory can be supplemented by, or incorporated in, special purpose logic circuitry.

The subject matter described herein can be implemented in a computing system that includes a back-end component (e.g., sales server 1012 or production server 1014), a middleware component (e.g., an application server or sales sever 1012), or a front-end component (e.g., consumer computer 1008 having a graphical user interface or a web browser through which a user can interact with an implementation of the subject matter described herein), or any combination of such back-end, middleware, and front-end components. The components of the system can be interconnected through network 802 by any form or medium of digital data communication, e.g., a communication network such as an email. Examples of communication networks include cell network (e.g., 4G or 5G), a local area network (LAN), and a wide area network (WAN), e.g., the Internet.

The subject matter described herein can be implemented as one or more computer program products, such as one or more computer programs tangibly embodied in an information carrier (e.g., in a non-transitory computer-readable medium) for execution by, or to control the operation of, data processing apparatus (e.g., a programmable processor, a computer, or multiple computers). A computer program (also known as a program, software, software application, app, macro, or code) can be written in any form of programming language, including compiled or interpreted languages (e.g., C, C++, etc.), and it can be deployed in any form, including as a stand-alone program or as a module, component, subroutine, or other unit suitable for use in a computing environment. Systems and methods of the invention can include instructions written in any suitable programming language known in the art. In certain embodiments, systems and methods of the invention are implemented through the use of a mobile app. As used herein, mobile app generally refers to a standalone program capable of being installed or run on a smartphone platform such as Android, IOS, etc. Functionality of the invention can be implemented by a mobile app or a software application or computer program in other formats included scripts, shell scripts, and functional modules created in development environments.

A computer program does not necessarily correspond to a file. A program can be stored in a portion of a file that holds other programs or data, in a single file dedicated to the program in question, or in multiple coordinated files (e.g., files that store one or more modules, subprograms, or portions of code). A computer program can be deployed to be executed on one computer or on multiple computers at one site or distributed across multiple sites and interconnected by a communication network.

A file can be a digital file, for example, stored on a hard drive, SSD, CD, or other tangible, non-transitory medium. A file can be sent from one device to another over network 1002 (e.g., as packets being sent between a server and a client, for example, through a Network Interface Card, modem, wireless card, email, text message or similar). Writing a file according to the invention involves transforming a tangible, non-transitory computer-readable medium, for example, by adding, removing, or rearranging particles (e.g., with a net charge or dipole moment into patterns of magnetization by read/write heads), the patterns then representing new collocations of information about objective physical phenomena desired by, and useful to, the user (e.g., a physical arrangement of particles that indicates that a specific, new club head is to be constructed from a certain set of multiple components and sent to a user). In some embodiments, writing involves a physical transformation of material in tangible, non-transitory computer readable media (e.g., with certain optical properties so that optical read/write devices can then read the new and useful collocation of information, e.g., burning a CD-ROM). In some embodiments, writing a file includes transforming a physical flash memory apparatus such as NANO flash memory device and storing information by transforming physical elements in an array of memory cells made from floating-gate transistors. Methods of writing a file can be invoked manually or automatically by a program or by a save command from software or a write command from a programming language.

An embodiment for a user interface 1070 for a system of the present disclosure (such as, e.g., input-output 1044 of system 1000 of FIG. 37) is shown in FIG. 38. The interface 1070 may be a website, a smart phone or tablet application. Using the interface 1070, a user can select properties of a customized head that will be fabricated and provided to the user or assembled into a golf club. The interface 1070 can include options for multiple features that are available with a club head. The interface 1070 can receive selections from a user of various options and then retrieve suitable design parameters for fabricating the customized head. FIG. 38 generally shows an exemplary display as could be shown on a screen, for example, of a computer or smartphone, discussed in more detail below. In certain embodiments, FIG. 38 represents a display rendered in a web browser (e.g., a web page).

As shown in FIG. 38, the interface 1070 can include elements such as pull-down menus for choosing options. Any method of offering options and receiving selections is included, such as, for example, point-and-click selection, keyboard entry, radio buttons, and confirmation of suggested options. A selection of an option can include selecting a given option from a set of possibilities and it can also include selecting whether or not to include a certain feature at all. For example, a user can be offered whether or not they would like a removable crown panel on their club head and, if they choose so, they can then be offered a list. Options can be offered and selections received for any aspect of a club head including all of those discussed herein. For example, the choices of crown panel materials in FIG. 38 could include clear plastic, translucent plastic, composite, carbon fiber, titanium, aluminum, or other alloys. Although the interface 1070 of FIG. 38 depicts a wood-type club head, it will be appreciated that the system 1000 and interface 1070 are not limited to a particular type of club head and, thus, can be used in connection with any club head type, including iron-type club heads (see FIGS. 1-9) and putter-type club heads.

The same or other interfaces will provide the user with a variety of design choices with respect to a number of components (such as, e.g., club shaft, club grip, club head). A plurality of interfaces may be used to design a set of clubs or a single interface can be used to select, e.g., shaft and grip, and then a plurality of nested interfaces or pop-ups can be used to select individual club heads for the set. A user could be offered choices of bodies and body materials. Choices of certain bodies may govern the availability of certain other choices. For example, some bodies may have a forward member for supporting a strike face and a body skirt member upon which a crown panel and sole plate are to be installed. Where a user chooses such a body, they may then be offered a choice of sole plate (e.g., with choice of style, material, color, etc.). Other features a user could choose include overall finish of surface (e.g., anodized, painted, decal set, plated, PVD, etc.), strike face, removable/interchangeable weight members, reconfigurable shaft, setting indicator window, user-uploaded photo printed on surface (e.g., as uploaded digitally), number of club heads (e.g., user orders entire set or matching clubs/sets for whole families), etc.

As shown in FIG. 38, receiving user options can be done via a series of related screens. For example, a user can choose materials for parts in a first screen, choose optional accessories in another screen, and save their choices and pick colors in another screen. However, in other embodiments, all choices are made on a single screen or a different combination of screens. In certain embodiments, choices are offered based upon input information such as height, weight, and age, as discussed above. In certain embodiments, choices are suggested based on inferences made according to computer program rules about a user's likely preference. For example, if a user orders a shaft in a given color (e.g., orange), a club head can be shown and suggested with a given matching or complementary color (e.g., orange main material with blue contrast finish details, or all green panels).

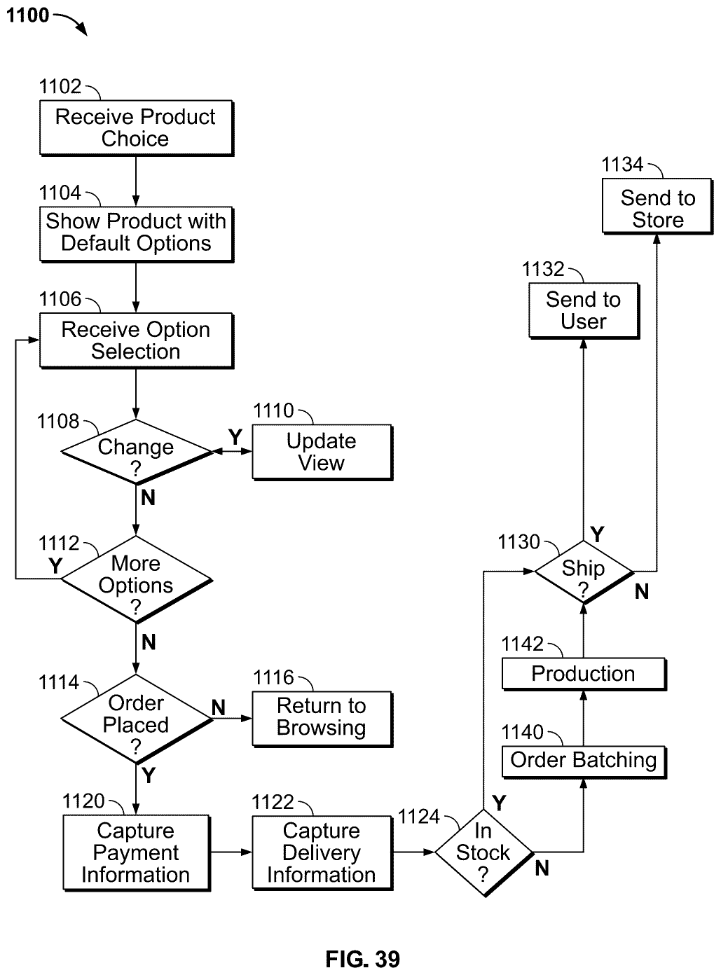

Given the variety of options a user may choose and the variety of numbers a user may order, this disclosure provides methods of receiving and preparing customized orders. Referring now to FIG. 39, a flowchart of a process 1100 of providing a customized club head according to certain embodiments of the disclosure is illustrated, which includes fewer or more steps than depicted. Further, the following steps may be performed in any order or sequence and may further include pauses or spans of time in between. The following steps may be performed by a single entity, a single device or system, multiple entities, or multiple devices or systems. The process 1100 can include receiving a user's choice of a product (e.g., product line driver club head), as in block 1102, and showing the user a product example (such as, e.g., a virtual object displayed on the display screen of FIG. 38), as in block 1004. A user's selections of an option are received in block 906 and can be saved in a memory (e.g., one or more of the memory 1030, 1032, 1034, 1036, 1038 of FIG. 37). At decision block 1108, if the selection reflects a change from what was previously shown (e.g., one or more customized features that different from the product with default options shown in block 1104 or one or more new selections by user in block 1106), the displayed product view can be updated to show what the user has chosen, as in block 1110, or the user can be shown more options, as in decision block 1112. If the user selects new features at decision block 1112, the process 1100 can return to block 1106, and this can be repeated for as many features as are customizable or as many features as the user chooses to select options for in block 1112.

Once the user is satisfied with the selected options (i.e., block 1112=NO), the process 1100 can move to decision block 1114, where the user decides whether to place an order of the customized product selected in block 1106. In some embodiments, the user may decide to first purchase a physical prototype or proof of the customized product that is configured for assessment and feedback, after which the user can vary any of the selected options before proceeding to decision block 1114. In some embodiments, the user may purchase a virtual prototype, such as an interactive digital model that can be engaged using augmented reality (AR) devices or virtual reality (VR) devices. For example, the user may conduct a functional simulation of the prototype in a virtual golf simulator or using a simulation joystick that provides haptic feedback tuned to reflect the specifications of the customized product. After such virtual simulation, the user may vary any of the selected options before proceeding to decision block 1114. If the user ends up not placing an order (i.e., block 1114=NO), the user can be returned to browsing (e.g., shown a web page home screen or another product screen), as in block 1116, and the user's choices can be saved and displayed to them at a later web page visit.

If the user places an order (i.e., block 1114=YES), the process 1100 can move to block 1120, which can include capturing information from the user about how they will pay for the product, and then to block 1122, which can include capturing information from the user about how the user will receive the purchased product. For example, a user can provide a credit card number over a computer network (e.g., by typing into a payment web page) in block 1120, and then choose direct shipping and provide their home address in block 1122. Or, alternatively, a user can indicate that they wish to use a corporate account (e.g., they are purchasing a dozen club heads that are printed with a corporate logo for which they have uploaded an image file such as a TIFF) in block 1120 and they can specify delivery to some site in block 1122. A user can also choose in-store pickup in block 1122. In certain embodiments, the process 1100 of providing a customized club head is operable in conjunction with a special event, and block 1122 of the process 1100 can include capturing delivery information about providing the club heads at the special event.

After delivery information is captured in block 1122, the process 1100 can proceed to decision block 1124, in which it is determined whether the ordered item is already in stock, as-ordered. If the ordered item in in stock (i.e., block 1124=YES), the process 1100 can proceed to decision block 1130, in which the ordered item is shipped or prepared for delivery according to the user's delivery information. For example, if the user chooses in block 1122 that the product be delivered directly to them (i.e., block 1130=YES), the purchased item can be sent to the user, as in block 1132. On the other hand, if the user chooses in block 1122 that the product be picked up in store (i.e., block 1130=NO), the purchased item can be sent to a store closest to the user, as in block 1134.

If the ordered item is not in stock (i.e., block 1124=NO), the process 1100 can proceed to block 1140, in which the order is batched. After order batching in block 1140, order information (e.g., information regarding batches, production schedules, and individual orders of club heads, including design files thereof) is transmitted to a production system or facility, and the ordered club heads are produced (such as, e.g., by an additive manufacturing machine or system or by the fabricator 920 of FIG. 36), as in block 1142. In some embodiments in which an additive manufacturing machine or system are utilized, the process 1100 can include one or more additional steps after order batching, as in block 1140, and before club heads are produced, as in block 1142. For example, in such embodiments, the process 1100 can further include preparing design files for printing, which can include adding polishing to stock items, machining material from stock items (such as, e.g., on a face of an iron-type club head), adding material to stock items (such as, e.g., to areas where additive manufacturing build supports will be placed during printing), among others. In some instances, a recording device, e.g., a camera or webcam, captures a recording of steps of the production system during the production of the component being produced, such as the club head.

After production is complete in block 1142, the process 1100 can proceed to decision block 1130, in which the produced club heads are sent to the user according to the user's choice in block 1122. If a user has ordered a club to be shipped to their home in block 1122, the club is sent to the user directly, as in block 1132. If a user has requested in-store pickup in block 1122, the club is sent to the store, as in block 1134. If a user has requested another delivery option in block 1122, it is so initiated. In some embodiments, the produced club heads may be shipped to another facility where they are assembled into clubs, or the club heads may be assembled into clubs on site. In some embodiments, block 1122 can include options for delivery of a digital design model of the purchased golf club head in block 1120 to the user. In such embodiments, the user can produce the purchased golf club head in block 1120 via an additive manufacturing machine or system that receives the digital design model the golf club head. Further, the recording or a link (e.g., a URL) to the recording of the production of the component, e.g., the purchased club head, may be provided to the user via digital delivery, e.g., by email or text message.

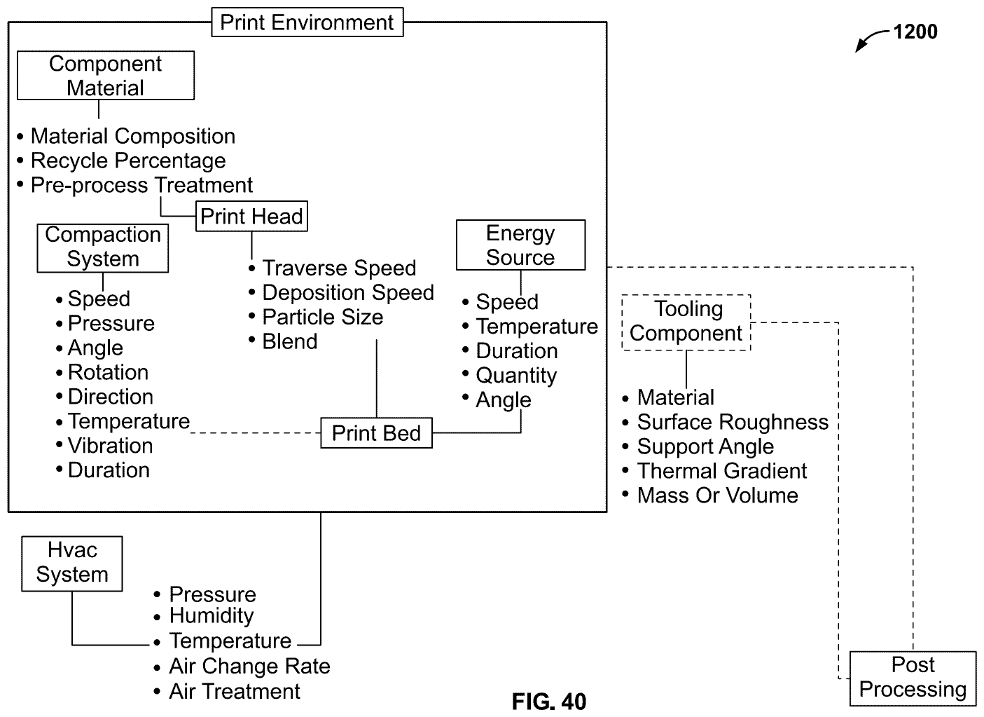

FIG. 40 illustrates a schematic representation of an additive manufacturing system 1200 including various components and parameters suited for modifications. A material composition, mass or volume percentage of recycled material, or pre-process treatment of a component material can be configured or selected to produce the predetermined surface roughness. In some embodiments, multiple component materials may be input to the print head. A material composition, mass or volume percentage of recycled material, or pre-process treatment of material can be configured or selected to produce a predetermined surface roughness. In some embodiments, one or more inputs to a print head are selected. A traverse speed, deposition speed, particle size, or blend of materials, such as, e.g., a ratio of component material, can be selected or configured to produce the predetermined surface roughness. In some embodiments, the print head is configured to vary a depth or thickness of the deposited layer, or to vary the blend or material composition in certain regions of the deposited layer. In some embodiments, the system 1200 includes an elongated or extended axis, such as an extended vertical axis, e.g., Z axis, to produce parts of elongated or extended shape. It is contemplated that an increased quantity of such elongated parts can be formed at one time by the system 1200 due to the extended axis.

Still referring to FIG. 40, a speed, pressure, angle of application, rotation direction or speed, direction of application, temperature, vibration rate, or duration of a compaction system may be selected or configured to produce the predetermined surface roughness. A speed, temperature, duration, angle of application, or quantity of an energy source (e.g., intensity of laser) may be selected or configured to produce the predetermined surface roughness and mechanical properties of the printed part. In some embodiments, multiple energy sources are provided. An HVAC system may be configured to achieve or maintain the printing environment at a setpoint for pressure, humidity, temperature, air change rate, or air treatment, such as, e.g., filtering, ionization, or maintaining inert mediums/conditions, to produce the predetermined surface roughness.

With continued reference to FIG. 40, in some embodiments, the print head is manipulated to print, layer by layer, a golf club component. Once the golf club component is printed, the tooling component can be configured with a material, surface roughness, support angle, thermal gradient, mass, or volume prior to and/or after post processing. In this way, the printed golf club component can be produced with a surface finish that is aesthetically pleasing, corrosion and weather resistant, aerodynamic, and of a measured roughness capable of being compliant with USGA requirements for impact areas, without the need for additional post-processing or conventional finishing methods, such as sand blasting, brushing, milling, or polishing.

For example, isostatic pressing methods may be used as part of a heat treatment process, in which the sintered part is subjected to high, isostatic pressures in addition to elevated temperatures. Hot isostatic pressing (HIP) can involve pressures of about 200-500 MPa and temperatures of about 1800-200 degrees Celsius; warm isostatic pressing (WIP) can involve pressures of about 300-500 MPa and temperatures of 200-300 degrees Celsius. In some instances, cold isostatic pressing (CIP) is employed on the sintered part at ambient temperatures, without requiring the furnace to heat the component. CIP can involve pressures of about 20 to 400 MPa. The isostatic pressing methods can reduce porosity, increase density, and improve uniformity of the components. Although isostatic pressing typically involves the use of gas as the medium to exert pressure on the component, it is contemplated that a liquid medium may also be used, e.g., oil or water.

In some embodiments, the additive manufacturing systems and methods described herein are part of a decentralized, on-demand-production ecosystem that is accessed by the user and/or manufacturer to fabricate a component, e.g., the golf club components or tooling components. For example, a user may build or customize a golf club component, e.g., a golf club head, using a graphical user interface (GUI), such as the interface 1070 of FIG. 38, that is displayed on a computing device, such as the computer 1008 of FIG. 37.

After payment and delivery information are received, as in blocks 1120 and 1122, a production server, such as the server 1014, can determine the most suitable additive manufacturing system or machine, or a combination of machines, to fabricate the component as requested. To do so, the production server 1014 may consider various inputs and data, including any of the following: proximity of additive manufacturing machine to delivery address, transport and shipping paths, materials required to fabricate component, surface finish of component, quantity of components, production or fabrication time, post-processing steps, availability of materials, availability of additive manufacturing machines, emissions due to shipping, emissions due to production or fabrication, energy consumption due to production or fabrication, energy consumption due to shipping, similarity to inventory, similarity to other orders, or end-use of component (e.g., prototype or finished product). In some instances, the production server 1014 may optimize the production cycle to minimize the total emissions generated due to fabrication and shipping. In some instances, the production server 1014 may optimize the production cycle to minimize the energy consumption due to fabrication and shipping. In some instances, the production server 1014 may optimize the production cycle to achieve the earliest delivery date, which may involve selecting additive manufacturing systems that are relatively farther from the delivery address but have sooner availability to start fabrication and have access to faster shipping paths. In some instances, the production server 1014 may utilize the additive manufacturing machine that is closest in proximity to the delivery address, thereby allowing the user to pick-up the finished component to reduce shipping costs.

In some instances, the additive manufacturing system may be carried by a mobile vehicle, such as a truck, that can travel to various locations, such as, e.g., golf courses, retail stores, fitting locations, tournaments, promotional events, and the like. The additive manufacturing systems described herein may be at least partially carried by the mobile vehicle to permit on-demand, walk-up ordering and manufacturing of golf club components as part of the decentralized, on-demand-production ecosystem.

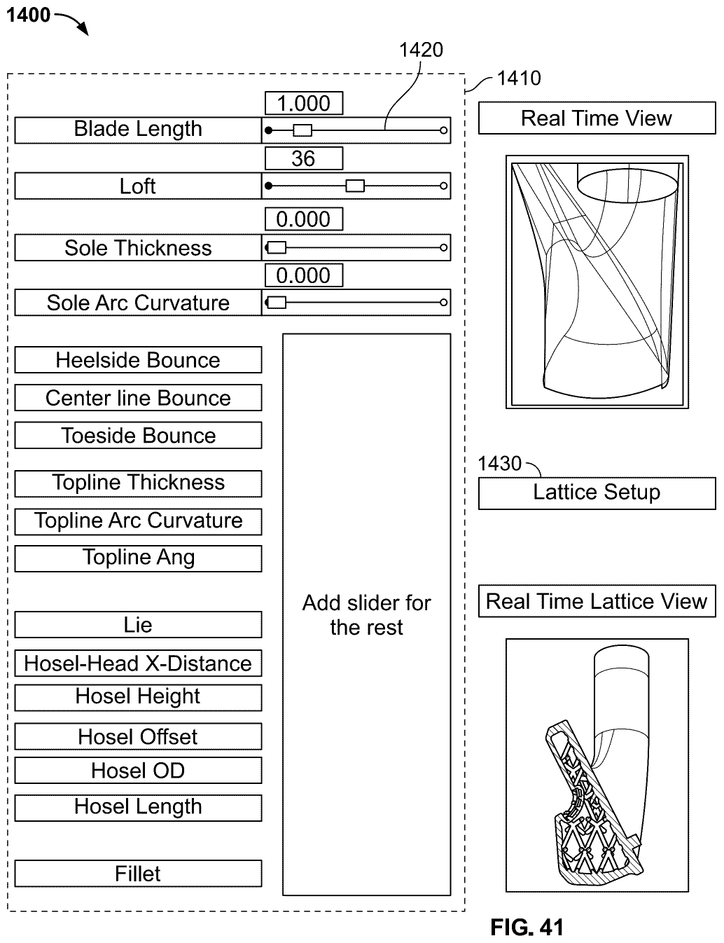

In some instances, the user can further customize the golf club head prior to the manufacturing process according to the needs of the user. In some examples, the user can provide swing characteristics to customize different parameters of the golf club head. Referring to FIG. 41, an interface 1400 may include various types of parameters that defines the shape of the golf club head. The parameters 1410 can be blade length, loft, sole thickness, sole arc curvature, heelside bounce, centerline bounce, toeside bounce, topline thickness, topline arc curvature, topline angle, lie, hosel-head X-distance, hosel height, hosel offset, hosel outer diameter, hosel length, fillet or the like. Further, the parameters can be different based on the type of the golf club head (e.g., driver, wood, hybrid, iron, putter). The various types of parameters 1410 have a respective slider 1420 that the user can move or manipulate to change the shape of the golf club head. As the slider 1420 is moved for a chosen parameter 1410, a real-time image is generated according to the elected parameter values. In some examples, the interface 1400 may further include lattice setup button 1430. The lattice setup button further allows the user to manipulate the lattice structure as shows in FIGS. 29-32. Further, a real-time image of the golf club head including the lattice structure is also shown in accordance with the manipulation of the parameters of the golf club head. In some examples, the lattice structure of the golf club head can be automatically adjusted to correspond to a Center of Gravity (CG) or Moment of Inertia (MOI). For instance, the user can populate a lattice structure of the golf club in accordance to a desired CG location that can be based on the user's swing characteristics.

In some examples, as described above, the golf club can be manufactured by receiving user information (e.g., swing characteristics) through a user interface. In some examples, the information can be manually entered, retrieved from a server, or can be retrieved through a software. Once the user information is retrieved at least one parameter of the golf club head listed above can be selected to be modified by the user. The at least one parameter is selected from a plurality of parameters that may be relevant to the shape of the golf club head. In some examples, as the parameters are modified, a real-time model can be illustrated in the user interface as shown in FIG. 41. Accordingly, a design model (3D CAD model) of the golf club is generated based on the user information or at least one parameter of the golf club. Once the design model is generated, a three-dimensional lattice environment is created including a lattice array, and the design model of the golf club head is inlaid into the three-dimensional lattice environment. Once the design model is inlaid into the three-dimensional lattice environment, the lattice array is reorientated according to the user information or according to the preference of the user. Once the lattice array defines the connection points with the design model to establish a lattice structure within the internal volume, the golf club head is printed layer-by-layer using an additive manufacturing device. In some examples, the changes made to a single golf club can be implemented to the entire set of clubs. For instance, one loft of a set can be adjusted and other golf club head in the set will follow suit. In some examples, further customization can be implemented such that the entire set of clubs can have different characteristics (e.g., loft) in comparison to other golf clubs.

As noted herein, any of the structures illustrated or described in one of the golf club heads herein may be used or may be included in any of the other golf club heads described herein. In some embodiments, all of the golf club heads described herein are the same and are just illustrated at different steps during the manufacturing process or illustrated by actual images or 3D renderings, i.e., CAD models. As further noted herein, the golf club heads described herein may be similar to the golf club heads disclosed in U.S. Pat. Nos. 11,618,213 and 11,618,079, both of which are hereby incorporated by reference in their entirety.

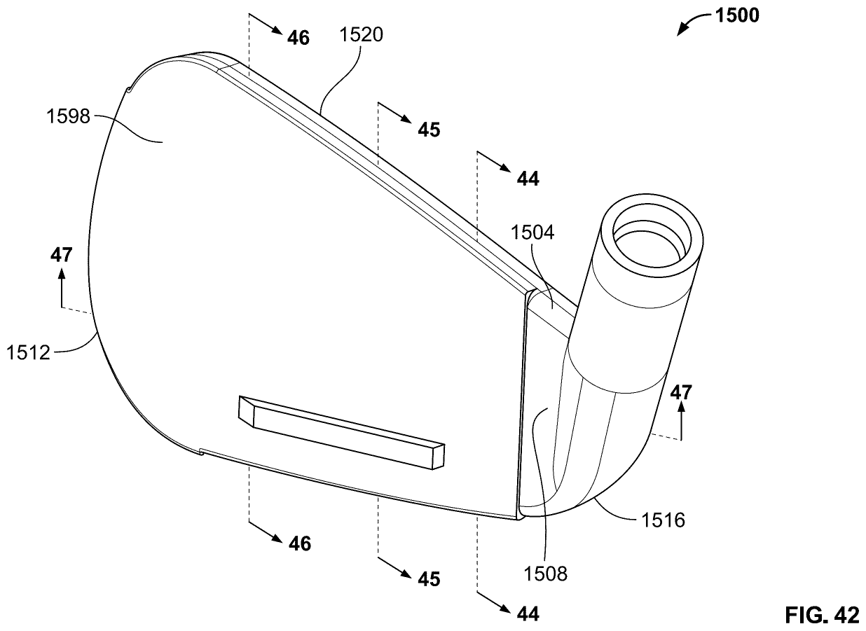

Now referring to FIGS. 42-47, a golf club head 1500 is illustrated, which is one particular example of a golf club head similar to the golf club head 100 illustrated in FIGS. 1 and 2. The golf club head 1500 includes a body with apertures configured to aid in the removal of powdered material from within the body. Further, the golf club head 1500 includes the apertures within pockets that are configured to receive weight elements, as will be described herein.

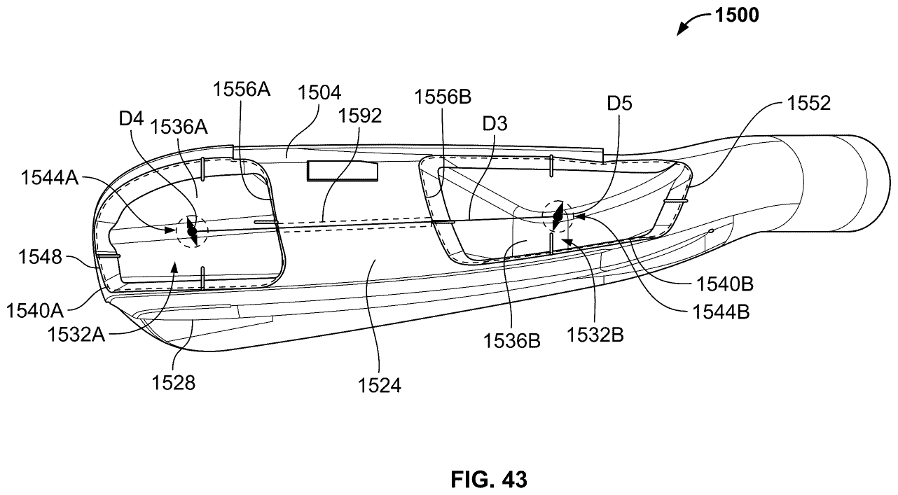

Referring to FIG. 42, the golf club head 1500 includes a body 1504 having a front side 1508, a toe side 1512, a heel side 1516 that is opposite the toe side 1512, and a top side 1520. Referring to FIG. 43, the golf club head 1500 further includes a bottom side 1524 that is opposite the top side 1520 and a rear side 1528 that is opposite the front side 1508.

Continuing with FIG. 43, the bottom side 1524 of the body 1504 includes at least one pocket, such as, a toe pocket or first cavity 1532A (e.g., a first pocket) located in a toe region and a heel pocket or second cavity 1532B (e.g., a second pocket) located in a heel region. The toe pocket 1532A is partially defined by a first wall or cavity wall 1536A and the heel pocket 1532B is at least partially defined by a second wall or cavity wall 1536B. The first wall 1536A of the toe pocket 1532A can include multiple walls that are shaped to receive a weight element 1540A (indicated by the dashed line). Similarly, the second wall 1536B of the heel pocket 1532B can include multiple walls that are shaped to receive a weight element 1540B (indicated by the dashed line). In some examples, the weight elements 1540A, 1540B and the first and second pockets 1532A, 1532B can be arranged or shaped differently than shown. For example, the first and second pockets 1532A, 1532B can differ in one or more dimensions so as to be larger or smaller in size.

Still referring to FIG. 43, at least one aperture extends through a body and is in fluid communication with an internal cavity of the body. The at least one aperture is at least partially defined by a wall, and the at least one aperture extends through the wall of the at least one pocket. For example, the toe pocket 1532A includes a first aperture 1544A and the heel pocket 1532B includes a second aperture 1544B in fluid communication with an internal cavity of the body 1504. The first aperture 1544A extends through the first wall 1536A of the toe pocket 1532A and the second aperture 1544B extends through the second wall 1536B of the heel pocket 1532B. The first aperture 1544A and the second aperture 1544B are spaced apart in a lateral direction by a distance D3 that is measured center-to-center. In some embodiments, the distance D3 is less than a total heel-toe distance of the golf club head 1500. In other embodiments, the distance D3 is less than a distance between a toe edge 1548 of the toe pocket 1532A and a heel edge 1552 of the heel pocket 1532B. In some embodiments, the distance D3 is greater than a distance between a medial edge 1556A of the toe pocket 1532A and a medial edge 1556B of the heel pocket 1532B. Locating the first aperture 1544A and the second aperture 1544B within the toe pocket 1532A and the heel pocket 1532B, respectively, enables the apertures 1544A and 1544B to have an increased size (e.g., diameter), as compared with locating the apertures on an externally-facing surface of the body 1504 due to the need for compatibility with post-processing and finishing methods. The increased size of the apertures 1544A and 1544B allows for easier removal of internal debris, such as excess powdered material, which can save time during post-processing, avoid undesirable sound caused by loose powder within the golf club head 1500, and permits recycling of the excess powdered material in subsequent additive manufacturing processes.

Referring to FIG. 43, the at least one pocket 1532 and the at least one aperture 1544 are both located in a toe region of the golf club head 1500, such that a distance between the toc edge 1548 and the aperture 1544 is smaller than a distance between the heel edge 1552 and the aperture 1544. The at least one pocket 1532 can include the first pocket 1532A (e.g., toe pocket) and the second pocket 1532B (e.g., heel pocket). The at least one aperture 1544 can have the first aperture 1544A having a first diameter D4 in the first pocket 1532A and a second aperture D5 having a second diameter D5 in the second pocket 1532B, and the first and second diameters D4, D5 are equal. For example, the first aperture 1544A has the first diameter D4 and the second aperture 1544B has the second diameter D5. The first diameter D4 is smaller than a heel-toc dimension of the toe pocket 1508A and a front-rear dimension of the toe pocket 1532A. Similarly, the second diameter D5 is smaller than a heel-toe dimension of the heel pocket 1532B and a front-rear dimension of the heel pocket 1532B. In some embodiments, the first and second diameters D4 and D5 are not equal. For example, the first diameter D4 is greater than the second diameter D5. In other examples, the first diameter D4 is smaller than the second diameter D5. In some embodiments, the first and second diameters D4 and D5 are equal. The first diameter D4 and the second diameter D5 are between about one millimeter and five millimeters. In some embodiments, the first aperture 1544A and the second aperture 1544B can be shaped differently. For example, the first aperture 1544A and the second aperture 1544B can provided in the shape of a rectangle, a triangle, an oval, an ellipse, a polygon, or with an irregular shape, or combinations thereof.

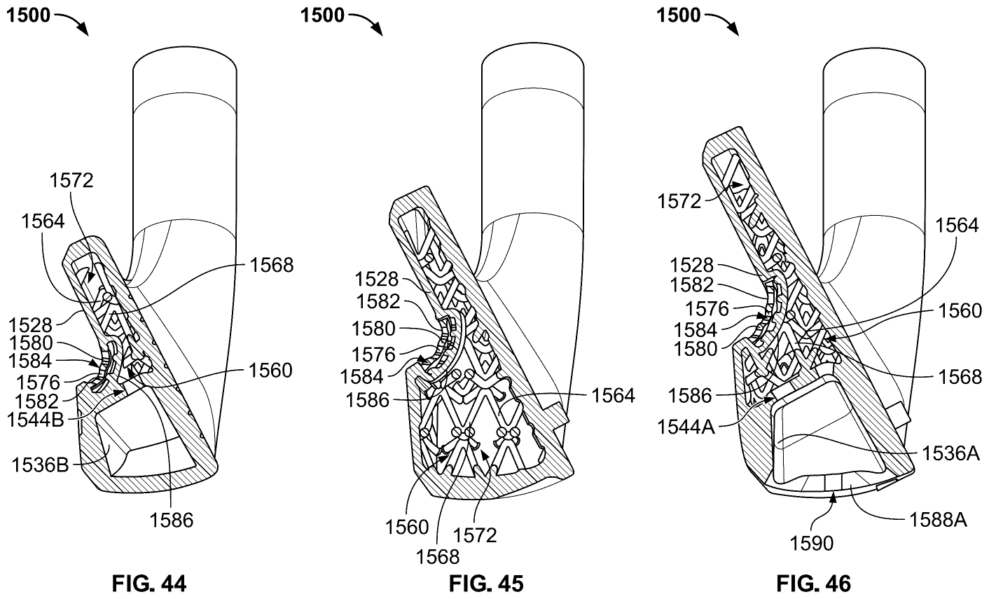

Referring to FIGS. 44-46, the body 1504 defines an internal cavity or inner chamber 1560 that includes an internal support structure 1564 (e.g., a first structure). The internal support structure 1564 is disposed within the internal cavity 1560 and includes a plurality of beams 1568 that are interconnected to one another and define a plurality of voids 1572 that are interconnected to one another within the internal cavity 1560. Similarly, the internal cavity 1560 can be described as an interconnected void. Accordingly, the internal support structure 1564 may be referenced herein as a lattice structure, a segmented support structure, a scaffolding, a network of ribs, a web of ribs, or a complex geometric support structure. The plurality of voids 1572 are interconnected to one another through tortuous or circuitous paths extending among the plurality of beams 1568 in the internal cavity 1560. In some embodiments, the internal cavity 1560 is partitioned or divided into regions, such as an internal heel region or an internal toe region, where the regions are separated by walls or partitions (not shown). When fabricated using powder-based additive manufacturing methods (e.g., direct metal laser sintering or metal binder jetting), the apertures (e.g., 1544A or 1544B) are provided for each of the regions of the divided internal cavity 1560 so that excess or loose powder can be removed.

Still referring to FIGS. 44-46, the rear side 1528 of the body 1504 defines an external cavity or outer chamber 1576. An external support structure 1580 (e.g., a second structure) is disposed within the external cavity 1576 and is visible from an exterior view of the rear side 1528 of the body 1504 of the golf club head 1500. The external support structure 1580 includes a plurality of beams 1582 that are interconnected to one another and define a plurality of voids 1584 that are interconnected to one another within the external cavity 1576. Accordingly, the external support structure 1580 may be referenced herein as a lattice structure, a segmented support structure, a scaffolding, a network of ribs, a web of ribs, or a complex geometric support structure. The plurality of voids 1584 are interconnected to one another through tortuous or circuitous paths extending among the plurality of beams 1582 in the external cavity 1576. The external support structure 1580 is separated from the internal support structure 1564 by a rear wall 1586 of the body 1504. In the illustrated embodiment, the rear wall 1586 is a solid, continuous wall that prevents fluid communication between the internal cavity 1560 and the external cavity 1576, although other configurations are possible.

The first aperture 1544A and the second aperture 1544B are in fluid communication with the internal cavity 1560 of the body 1504. The first aperture 1544A and the second aperture 1544B are positioned in spaced relation to the plurality of beams 1568 of the internal support structure 1564 to avoid interference, such that the plurality of beams 1568 do not occupy or extend within the first aperture 1544A and second aperture 1544B. In other words, the first aperture 1544A and the second aperture 1544B are selectively spaced away from the plurality of beams 1568 of the internal support structure 1564, thereby allowing the first and second apertures 1544A, 1544B to establish unobstructed fluid communication with the internal cavity 1560 and the plurality of voids 1572 that are interconnected to one another within the internal support structure 1564.

As described above, in some embodiments, the internal cavity 1560 has multiple regions separated by partition or dividing walls (not shown). In some embodiments, each region of the internal cavity 1560 includes a portion of the internal support structure 1564 and the plurality of voids 1572. Put another way, there can be a plurality of internal support structures 1564 and a plurality of interconnected voids within the internal cavity 1560. In some instances, one or more of the regions does not include the internal support structures. In some instances, the internal support structure 1564 varies in one or more aspects, such as beam thickness or density, among the multiple regions in the internal cavity 1560. In some embodiments, the external cavity 1576 can have multiple regions separated by partition or dividing walls (not shown). In some embodiments, each region of the external cavity 1576 includes a portion of the external support structure 1580 and the plurality of voids 1584. Put another way, there can be a plurality of external support structures and a plurality of interconnected voids within the external cavity 1576. In some instances, one or more of the regions does not include the external support structure 1580. In some instances, the external support structure 1580 varies in one or more aspects, such as beam thickness or density, among the multiple regions in the external cavity 1576.

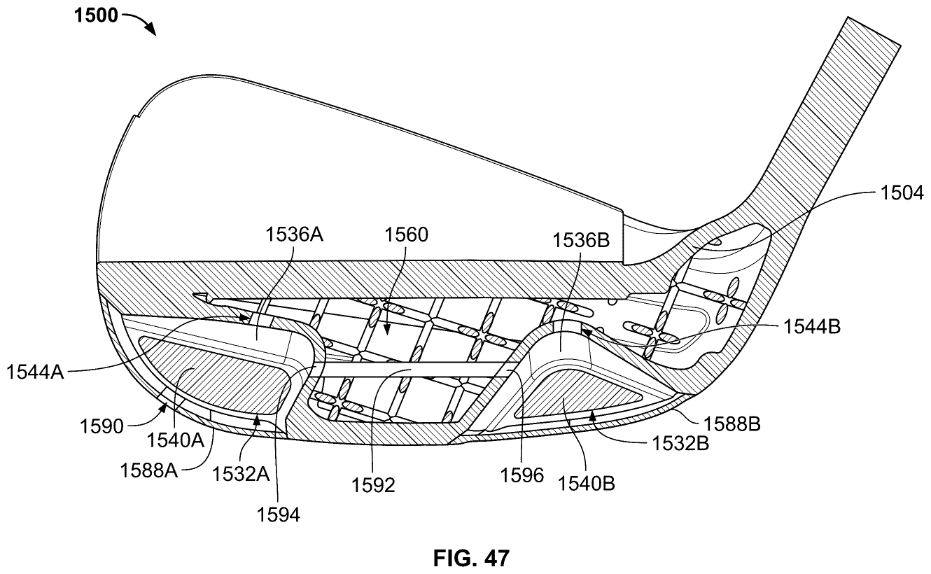

Referring to FIG. 47, the golf club head 1500 includes a cap 1588A and a cap 1588B. The cap 1588A defines at least one cap opening 1590 extending therethrough. The cap 1588A is configured to be attached to the toe pocket 1532A to retain the weight 1540A. The weight 1540A is configured to be introduced into the toe pocket 1532A through the cap opening 1590. The cap opening 1590 is in fluid communication with the toe pocket 1532A and the first aperture 1544A. The cap 1588B is configured to be attached to the heel pocket 1532B to retain the weight 1540B. In some examples, the cap 1588B can define at least one cap opening (e.g., cap opening 1590) extending therethrough. The weight 1540B can be configured to be introduced into the heel pocket 1532B through the cap opening. The cap opening is in fluid communication with the heel pocket 1532B and the second aperture 1544B.

Referring to FIG. 47, a conduit 1592 extends laterally through the internal cavity 1560 to interconnect the toe pocket 1532A and the heel pocket 1532B. The conduit 1592 extends continuously from a first end 1594 that forms an opening through the first wall 1536A of the toc pocket 1532A to a second end 1596 that forms an opening through the second wall 1536B of the heel pocket 1532B. The conduit 1592 defines a distance D7 between the first end 1594 and the second end 1596. As shown, the conduit 1592 extends between and connects the toe pocket 1532A and the heel pocket 1532B to establish fluid communication therebetween. The conduit 1592 is constructed as a solid, tubular structure with an interior that is not open to the internal cavity 1560. In some embodiments, the conduit 1592 is disposed in other areas of the golf club head 1500. For example, the conduit 1592 may connect the cap opening 1590 with the first aperture 1544A. In some embodiments, the conduit 1592 establishes a connection between the toe pocket 1532A and the internal cavity 1560, or the heel pocket 1532B and the internal cavity 1560, or the internal cavity 1560 and the external environment around the golf club head 1500. In some embodiments, the conduit 1592 may be provided as a plurality of conduits arranged in parallel with one another. In some embodiments, the conduit 1592 may vary in size or shape between the first and second ends 1594, 1596.

As previously discussed, a byproduct of the additive manufacturing processes includes excess material, such as powdered material, that must be removed from the printed part and, due to the small particle size and quantity, may remain in a golf club head. For example, manufacturing a lattice array that has a plurality of voids or plurality of openings in which excess material can be become trapped can present a challenge for removing the excess powdered material from within the golf club head. Additionally, manufacturing a lattice array may require sacrificial material to sufficiently support cantilevered segments that extend at an angle relative to the build plane, and the sacrificial material must be removed from the printed part during post-processing steps. Referring to FIG. 47, at least one aperture is configured for removal of excess powdered material from within an internal cavity. For example, the first aperture 1544A and the second aperture 1544B are configured for removal of excess material, e.g., debris or powdered material that is deposited during an additive manufacturing process, from within the internal cavity 1560. In some embodiments, the excess powdered material has a density that is substantially equal to a density of a material used to form the body 1504. In some embodiments, the excess powdered material has a density that is different from a density used to form a face plate 1598, shown in FIG. 42. In some embodiments, the excess powdered material has a density that is different from a density used to form the weight element 1540A and 1540B, shown in FIG. 43, that is configured to be received within at least one pocket, such as, the toe pocket 1532A and heel pocket 1532B, respectively.

In an example use, one of the first and second apertures 1544A and 1544B are configured as an inlet and the other is configured as an outlet. Referring to FIG. 47, the first aperture 1544A is configured as an inlet and the second aperture 1544B is configured as an outlet, or vice versa. Pressurized gas, pressurized fluid, or an abrasive media is configured to flow through the inlet to remove the excess powdered material within the internal cavity 1560 through the outlet.

The toe pocket 1532A is configured to receive the toe weight element 1540A and the heel pocket 1532B is configured to receive the heel weight element 1540B after the excess material is removed. In some embodiments, the toe weight element 1540A and the heel weight element 1540B have a density that is greater than a density of a material used to form the body 1504. In some embodiments, the body 1504 can include one pocket to receive one weight element. For example, in some embodiments the body 1504 can include the toe pocket 1532A and the toe weight element 1540A. In some embodiments, the body 1504 can include the heel pocket 1532B and the heel weight element 1540B.

In an example use of adding weight elements 1540A and 1540B, a filler material is introduced to the toe pocket 1532A through the toe cap opening 1590 that extends through the toe cap 1588A, as shown in FIG. 47. The conduit 1592 that extends from the toe pocket 1532A and the heel pocket 1532B, receives the filler material that is first introduced to the toe pocket 1532A, and subsequently introduced to the heel pocket 1532B through the conduit 1592 to define the toe weight element 1540A and the heel weight element 1540B. The toe cap opening 1590 can be closed by the introduction of additional material, a heat treatment process (e.g., welding), or combinations thereof. In some embodiments, the weight elements 1540A and 1540B are made of a filler material that is provided as a viscous fluid composed of tungsten and polymer. The viscous fluid is configured to be injected into the toe pocket 1532A and through the conduit 1592 in a fluid state. Further, a heat treatment process can be used to cure the weight elements. It is beneficial to add the weight elements 1540A and 1540B by injecting a filler material in a liquid or semi-liquid state to ensure the internal volume of the toe pocket 1532A and heel pocket 1532B is substantially or entirely filled and to ensure conformity to the geometry thereof. Further, the injection of the weight elements 1540A, 1540B reduces the number of steps associated with assembling the golf club head 1500. For example, the weight elements 1540A, 1540B being injected using the filler material avoids a step of gluing the weights 1540A and 1540B in the toe pocket 1532A and the heel pocket 1532B.

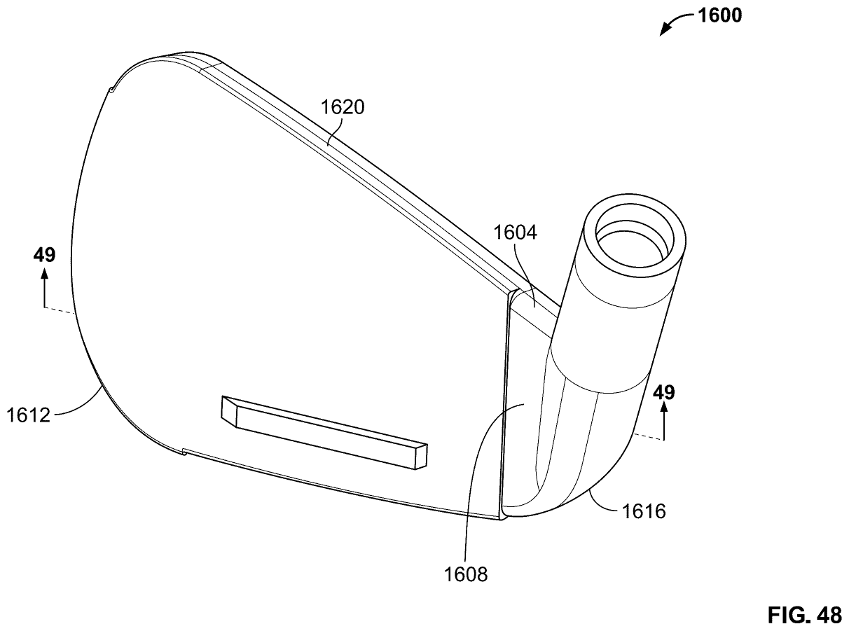

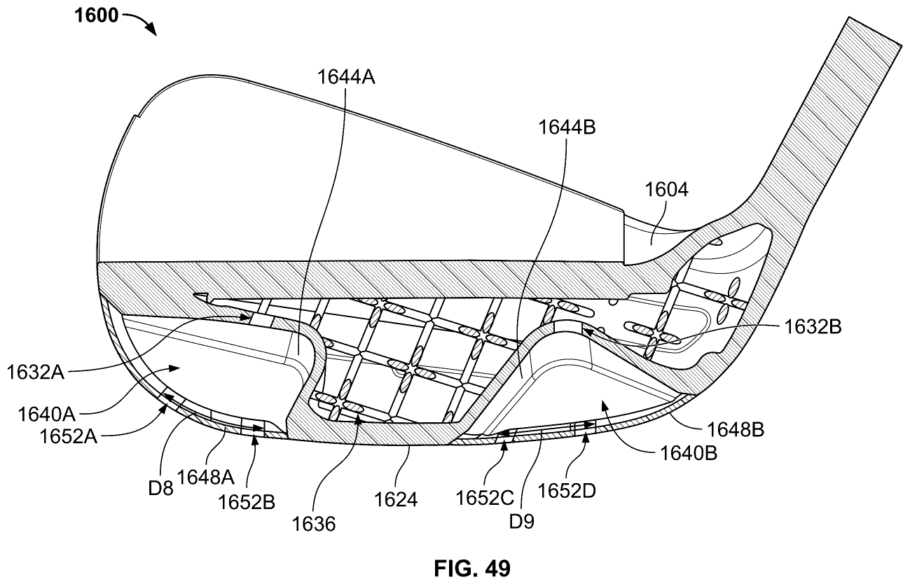

Now referring to FIGS. 48 and 49, a golf club head 1600 is illustrated, which is one particular example of a golf club head that is similar to the golf club head 1500 illustrated in FIGS. 42-47. The golf club head 1600 is described below as having a body including apertures to aid in the removal process of internal powdered material and, further, a configuration to retain weights within pockets.

Referring to FIG. 48, the golf club head 1600 has a body 1604 with a front side 1608, a toe side 1612, a heel side 1616 that is opposite the toe side 1612, and a top side 1620. Referring to FIG. 49, the golf club head 1600 includes a bottom side 1624 that is opposite the top side 1620. The golf club head 1600 includes a rear side (e.g., rear side 1528 shown in FIG. 43) that is opposite the front side 1608.

Referring to FIG. 49, the golf club head 1600 includes a first aperture 1632A and a second aperture 1632B. In some embodiments, the first aperture 1632A and the second aperture 1632B are configured as an inlet and an outlet. In some embodiments, the first aperture 1632A can be configured as the inlet and the second aperture 1632B can be configured as the outlet. In some embodiments, the first aperture 1632A can be configured as the outlet and the second aperture 1632B can be configured as the inlet. Similar to the golf head 1500, pressurized gas, fluid, or media is configured to flow through the inlet to remove the excess powdered material within the internal cavity 1636 through the outlet.

Referring to FIG. 49, the bottom side 1624 of the body 1604 includes a toe pocket 1640A and a heel pocket 1640B. The toe pocket 1640A is at least partially defined by a first wall 1644A. The heel pocket 1640B is at least partially defined by a second wall 1644B. A toe cap 1648A is configured to be attached to the toe pocket 1640A to retain a weight element (e.g., weights 1540A and 1540B shown in FIGS. 43 and 47). A first toe cap opening 1652A (e.g., an inlet) and a second toe cap opening 1652B (e.g., an outlet) extends through the toe cap 1648A and the first wall 1644A of the toe pocket 1640A. The first toe cap opening 1652A and the second toe cap opening 1652B are spaced a distance D8 apart. A heel cap 1648B is configured to be attached to the heel pocket 1640B to retain another weight element. A first heel opening 1652C (e.g., an inlet) and second heel opening 1652D (e.g., an outlet) extend through the heel cap 1648B and the second wall 1644B of the heel pocket 1640B. The first heel opening 1652C and the second heel opening 1652D are spaced apart by a distance D9 that is measured center-to-center.

Referring to FIG. 49, the first toe opening 1652A and the second toe opening 1652B of the toe pocket 1640A, and the first heel opening 1652C and the second heel opening 1652D of the heel pocket 1640B are in fluid communication with the internal cavity 1636 of the body 1604 through the first aperture 1632A and the second aperture 1632B, respectively. For example, pressurized fluid, gas, or media can flow through the first toe opening 1652A or the second toe opening 1652B of the toe pocket 1640A through the first aperture 1632A to remove excess powdered material through the second aperture 1632B through the first heel opening 1652C or the second heel opening 1652D of the heel pocket 1640B.

In an example use to add weights to the golf club head 1600 and as shown in FIG. 49, filler material is introduced to the toe pocket 1640A through the first toe opening 1652A and excess filler material flows through the second toe opening 1652B, or vice versa. Filler material is also introduced to the heel pocket 1640B through the first heel opening 1652C and excess filler material can flow through the second heel opening 1652D, or vice versa. The first toe opening 1652A, the second toe opening 1652B, the first heel opening 1652C, and the second heel opening 1652D can all be closed by a heat treatment process (e.g., welding). In some embodiments, the first toe opening 1652A, the second toe opening 1652B, the first heel opening 1652C, and the second heel opening 1652D can be closed by installation of a plug made of non-metal or metal.

In some examples, a conduit (e.g., the conduit 1592 as shown in FIG. 47) can connect the first toe opening 1652A or the second toe opening 1652B to the first aperture 1632A. Another conduit can connect the first heel opening 1652C or the second heel opening 1652D to the second aperture 1632B. In this way, the additional conduit provides another flow path for the pressurized fluid to remove excess powdered material from the internal cavity 1636.

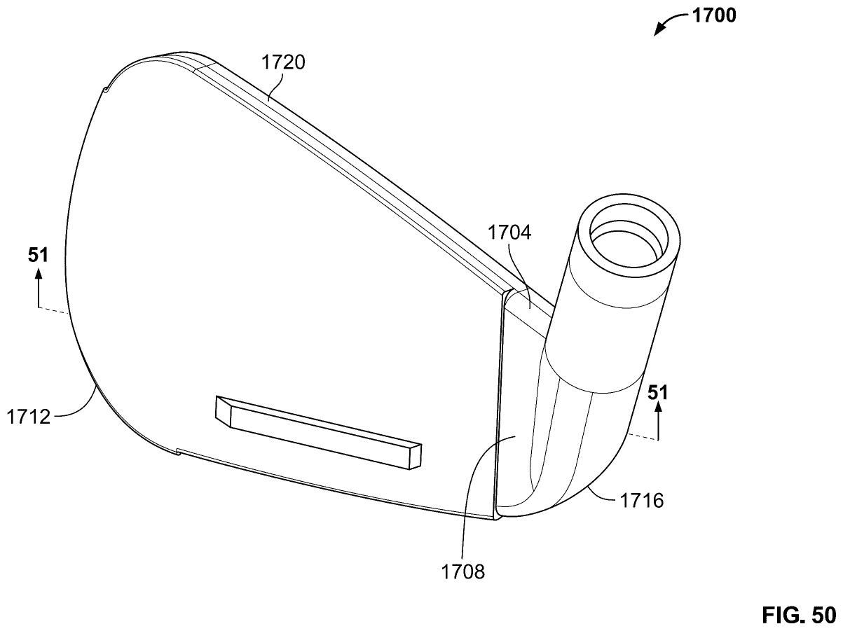

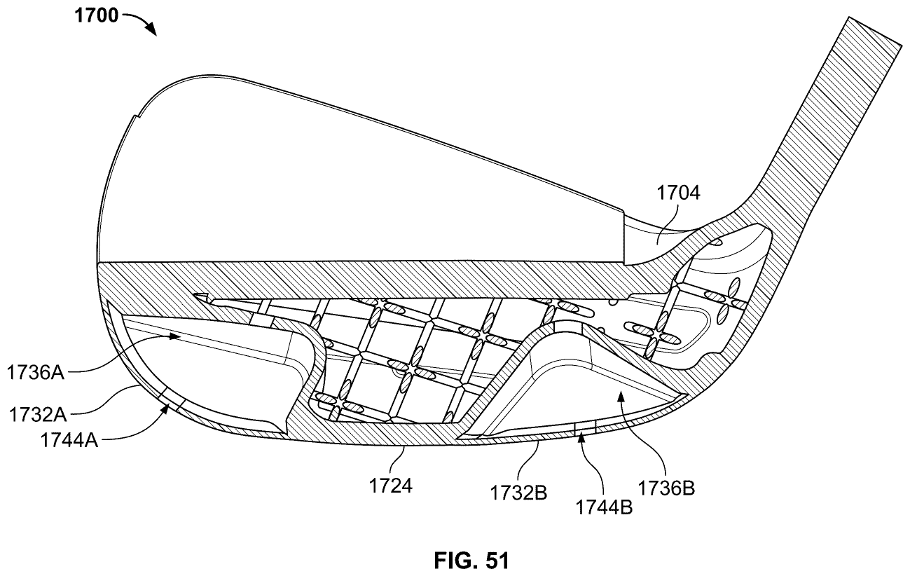

Now referring to FIGS. 50 and 51, a golf club head 1700 is illustrated, which is one particular example of a golf club head that is similar to the golf club head 1500 illustrated in FIGS. 42-47. The golf club head 1700 is described below as being configured to retain weights within pockets.

Referring to FIG. 50, the golf club head 1700 includes a body 1704 having a front side 1708, a toe side 1712, a heel side 1716 that is opposite the toe side 1712, and a top side 1720. Referring to FIG. 51, the golf club head 1700 includes a bottom side 1724 that is opposite the top side 1720. The golf club head 1700 includes a rear side (e.g., rear side 1528 as shown in FIG. 43) that is opposite the front side 1708.

Referring to FIG. 51, a toe cap 1732A is configured as a unitary structure with the body 1704 to define a toe pocket 1736A to retain a first weight element (e.g., weight 1540A shown in FIGS. 43 and 47). A heel cap 1732B is configured as a unitary structure with the body 1704 to define a heel pocket 1736B to retain a second weight element (e.g., weight 1540B shown in FIGS. 43 and 47). The toe cap 1732A includes a toe cap opening 1744A that is in fluid communication with the toe pocket 1736A. The heel cap 1732B includes a heel cap opening 1744B that is in fluid communication with the heel pocket 1736B.

Continuing with FIG. 51, the first weight element and the second weight element (e.g., weights 1540A and 1540B shown in FIGS. 43 and 47) each have a density that is greater than a density of a material that defines the body 1704. In some embodiments, the first weight element is configured to be introduced within the toe pocket 1736A through the toe cap opening 1744A. In some embodiments, the second weight element is configured to be introduced within the heel pocket 1736B through the heel cap opening 1744B.

As shown in FIG. 51, the toe cap 1732A and the heel cap 1732B can be formed with the body 1704 as a unitary structure. In some embodiments, the toe cap 1732A and the heel cap 1732B are separately formed from and attached to the body 1704.

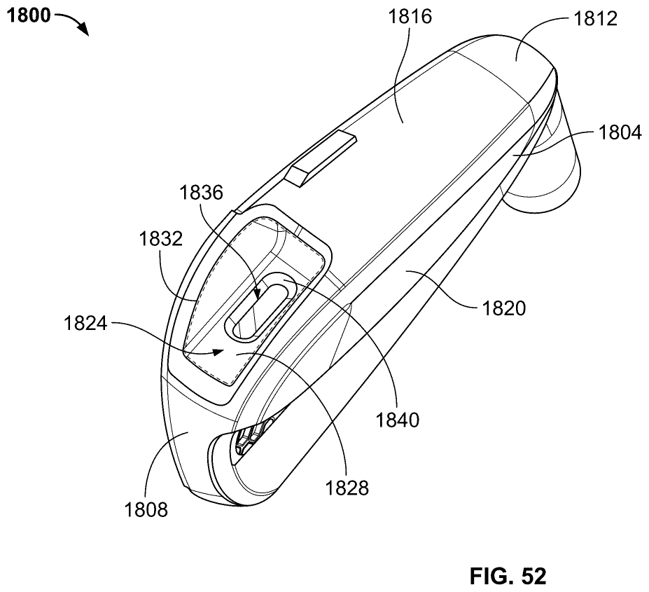

FIG. 52 illustrates another example of a golf club head 1800, according to the present disclosure. The golf club head 1800 includes a body 1804 having a front side (e.g., front side 1708 as shown in FIG. 50), a toe side 1808, a heel side 1812 that is opposite the toe side 1808, a top side (e.g., top side 1720 as shown in FIG. 50), a bottom side 1816 that is opposite the top side, and a rear side 1820 that is opposite the front side. The golf club head 1800 is described below as being configured to a retain weight within a pocket.

As shown in FIG. 52, the bottom side 1816 of the body 1804 includes a pocket 1824. The pocket 1824 is partially defined by a wall 1828. The wall 1828 of the pocket 1824 can include multiple walls that are shaped to receive a weight element 1832 (indicated by the dashed line). In some examples, the pocket 1824 and the weight element 1832 can be arranged or shaped differently than shown. In some embodiments, the pocket 1828 is positioned adjacent the heel side 1812 or centrally between the heel side 1812 and the toe side 1808.

Still referring to FIG. 52, the pocket 1828 includes an aperture 1836. The aperture 1836 extends through the wall 1828. The aperture 1836 is sized to allow for fluids, air, or other media to be introduced into the body 1804 and/or for internal debris, such as, e.g., excess or loose powder, to be removed from within body 1804. The aperture 1836 has an elongated shape with rounded corners, e.g., a stadium shape or pill shape, and a beveled edge 1840. In other examples, the aperture 1836 can be shaped differently.

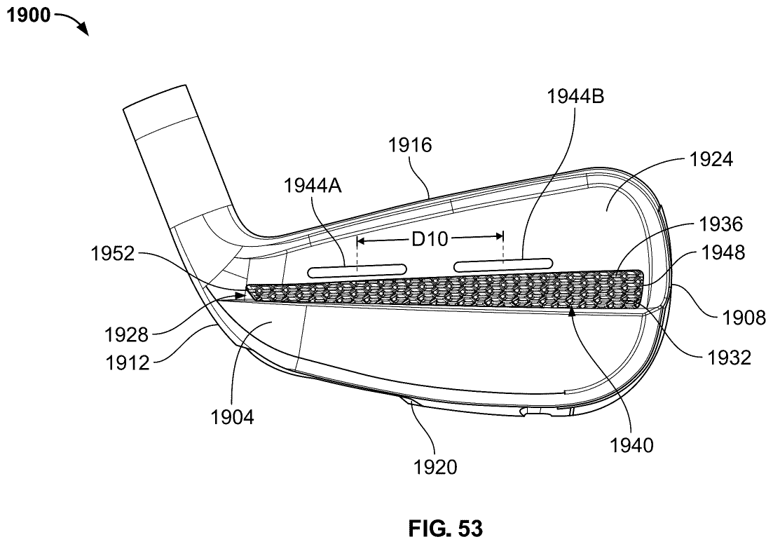

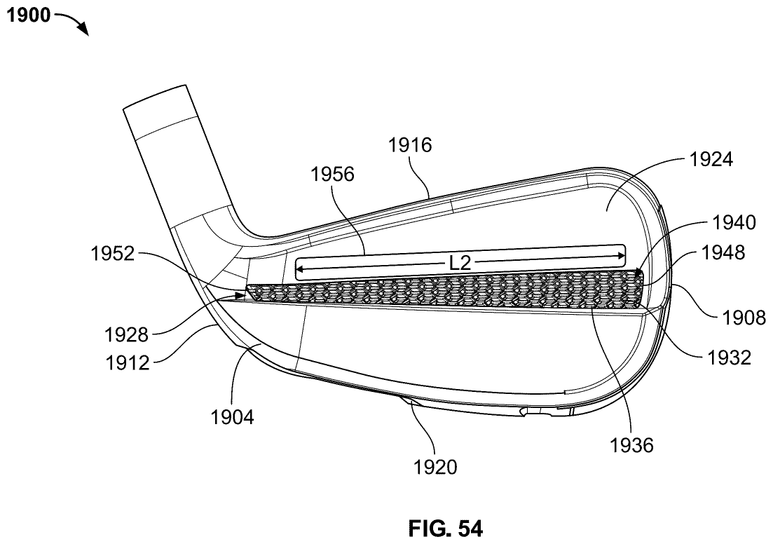

FIGS. 53 and 54 illustrate another example of a golf club head 1900, according to the present disclosure. The golf club head 1900 includes a body 1904 having a front side (e.g., front side 1708 as shown in FIG. 50), a toe side 1908, a heel side 1912 that is opposite the toe side 1908, a top side 1916, a bottom side 1920 that is opposite the top side, and a rear side 1924 that is opposite the front side.

As shown in FIGS. 53 and 54, the rear side 1924 of the body 1904 defines an external cavity 1928. An external support structure 1932 is disposed within the external cavity 1928 and is visible from an exterior view of the rear side 1924 of the golf club head 1900. The external support structure 1932 includes a plurality of beams 1936 that are interconnected to one another and define a plurality of voids 1940 that are interconnected to one another within the external cavity 1928. Accordingly, the external support structure 1932 may be referenced herein as a lattice structure, a segmented support structure, a scaffolding, a network of ribs, a web of ribs, or a complex geometric support structure. In the illustrated embodiment, a first aperture 1944A and a second aperture 1944B extend through the rear side 1924 of the body 1904. The first aperture 1944A and the second aperture 1944B are spaced apart in a lateral direction by a distance D10 that is measured center-to-center. In some embodiments, the distance D10 is less than a total heel-toe distance of the golf club head 1900. In other embodiments, the distance D10 is less than a distance between a toe edge 1948 of the external support structure 1932 and a heel edge 1952 of the external support structure 1932.

Continuing with FIG. 53, the first aperture 1944A and the second aperture 1944B are positioned above the external support structure 1932. The first aperture 1944A and the second aperture 1944B are shaped as a capsule. In some embodiments, the first aperture 1944A and the second aperture 1944B can be shaped differently. For example, the first aperture 1944A and the second aperture 1944B can be provided in the shape of a rectangle, a triangle, an oval, an ellipse, a polygon, or with an irregular shape, or combinations thereof.

In an example use, one of the first and second apertures 1944A and 1944B are configured as an inlet and the other is configured as an outlet. Referring to FIG. 53, the first aperture 1944A is configured as an inlet and the second aperture 1944B is configured as an outlet or vice versa. Pressurized gas, pressurized fluid, or an abrasive media is configured to flow through the inlet to remove the excess powdered material within an internal cavity (e.g., see internal cavity 1560) through the outlet.

Referring to FIG. 54, a medallion 1956 is placed over the apertures 1944A and 1944B to act as a seal. As illustrated, the medallion 1956 is an elongated component with a rectangular shape defining a length L2 between opposing ends. In some embodiments, the length L2 is less than a total heel-toe distance of the golf club head 1900. In other embodiments, the length L2 is less than a distance between a toe edge 1948 of the external support structure 1932 and a heel edge 1952 of the external support structure 1932. In some embodiments, the medallion 1956 is shaped differently. For example, the medallion 1956 can be shaped as an oval or a square.

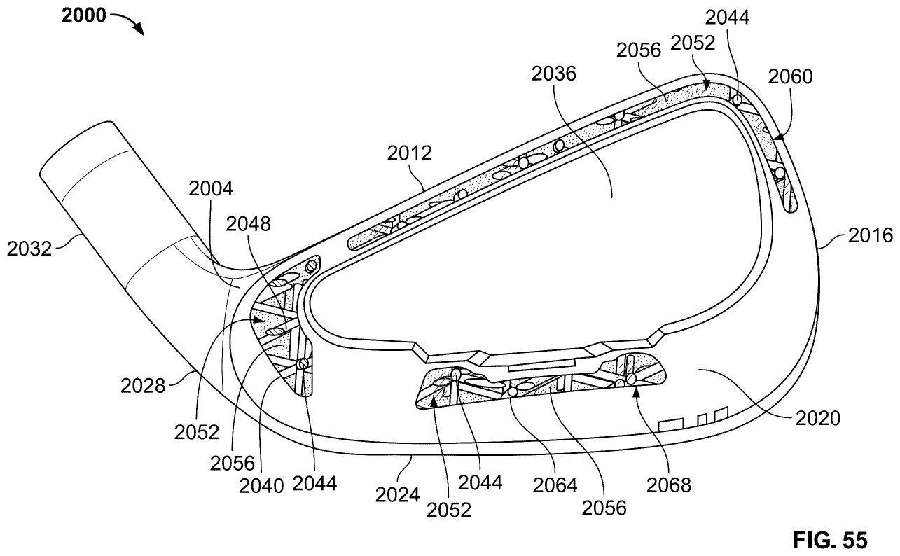

FIG. 55 illustrates another example of a golf club head 2000, according to the present disclosure. The golf club head 2000 includes a body 2004 having a front side (e.g., front side 1708 shown in FIG. 50), a top side 2012, a toe side 2016, a rear side 2020 that is opposite the front side, a bottom side 2024 that is opposite the tope side 2012, and a heel side 2028. FIG. 55 illustrates a view of the rear side 2020 of the golf club head 2000. The body 2004 includes a hosel 2032 on the heel side 2028. The body 2004 further includes a cavity 2036 on the rear side 2020. In the illustrated embodiment, the golf club head 2000 may be referred to as an iron-type golf club head with a cavity-back configuration.

Continuing with FIG. 55, the body 2004 includes a cutaway 2040 for illustrative purposes. The cutaway 2040 is a portion of the body 2004 that is hidden from view to show part of an internal support structure 2044 within the body 2004. The internal support structure 2044 includes a plurality of beams 2048 that are interconnected to one another and define a plurality of voids 2052. Accordingly, the internal support structure 2044 may be referenced herein as a lattice structure, a segmented support structure, a scaffolding, a network of ribs, a web of ribs, or a complex geometric support structure. A filler material 2056 (e.g., a polymer) fills the plurality of voids 2052 around the plurality of beams 2048.

The body 2004 includes an opening 2060. The opening 2060 is formed in the rear wall 2020 to allow transparent visibility to the internal support structure 2044. The filler material 2056 can be injected into the opening 2060. In some embodiments, the filler material 2056 fills the voids 2052 in the internal support structure 2044 and does not occupy the opening 2060, appearing as a recess. In other embodiments, the filler material 2056 fills the opening 2060.

The body 2004 includes a window 2064. The window 2064 is disposed within an opening 2068 in the rear wall 2020. The window 2064 can be made of a transparent or translucent material to provide visibility into the body 2004. In some embodiments, the window 2064 is co-molded with the internal support structure 2044 and the filler material 2056. For example, the internal support structure 2044 can be made of a metal and the filler material 2056 can be made of a polymer. The polymer fills the voids 2052 in the internal support structure 2044. The internal support structure 2044 can be in contact with and at least partially supported by the window 2064. In some embodiments, the window 2064 is co-molded with the body 2004. In some embodiments, before the window 2064 is disposed in the opening 2068, the opening 2068 is used to remove excess or loose powdered material. In some embodiments, a medallion is placed across the opening 2068 and/or the window 2064 to cover and enclose the opening 2068. In some embodiments, the medallion is made of a transparent or translucent material to provide visibility through the opening 2068 and/or the window 2064.

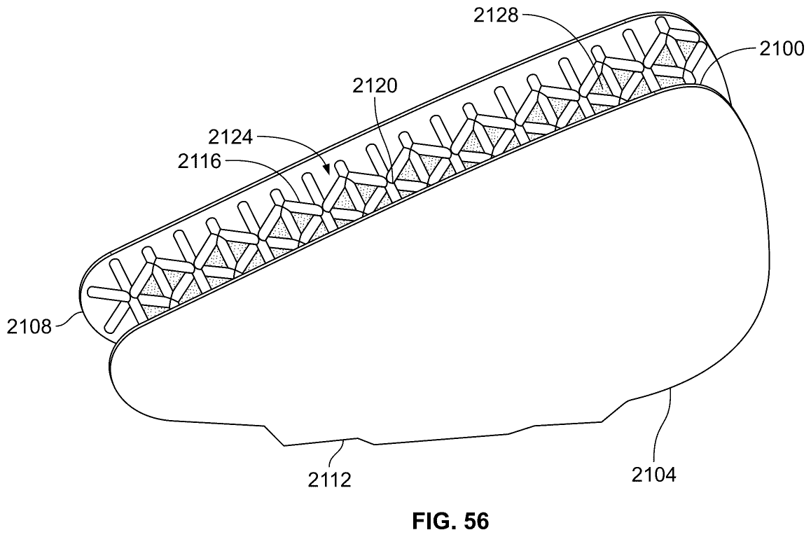

FIG. 56 illustrates a medallion component or insert 2100. The medallion component 2100 includes a body 2104 that has a front side 2108 and a rear side 2112 that is opposite the front side 2108. The medallion component 2100 is shaped to correspond with and conform to the cavity 2036 of the golf club 2000. The medallion component 2100 has an internal support structure 2116 that extends between the front side 2108 and the rear side 2112. The internal support structure 2116 includes a plurality of beams 2120 that are interconnected to one another and define a plurality of voids 2124 that are interconnected to one another. Accordingly, the internal support structure 2116 may be referenced herein as a lattice structure, a segmented support structure, a scaffolding, a network of ribs, a web of ribs, or a complex geometric support structure.

Continuing with FIG. 56, a polymer material 2128 can be poured or injected into the internal support structure 2116. The polymer material 2128 is a transparent or translucent material. In some embodiments, the medallion component 2100 is made of a metal or metal alloy. In some embodiments, the medallion component 2100 is a non-metal composite material, a natural or organic material, or combinations thereof. In some embodiments, the medallion component 2100 incudes metal and non-metal portions.

In some embodiments, the internal support structure 2116 of the medallion component 2100 is co-molded with another material to form an attachment surface that is adhesively attached to the golf club head 2000 to absorb impacts and vibrations from the golf club head 2000 (e.g., dampening). The cavity 2036 of the golf club head 2000 receives the medallion component 2100. The front side 2108 of the medallion component 2100 aligns with the front side of the of the golf club head 2000. The front side 2108 is the attachment surface that is configured to be adhered, affixed, coupled, or joined to the golf club head 2000. The rear side 2112 of the medallion component 2100 aligns with the rear side 2020 of the golf club head 2000. The rear side 2112 is exposed on the rear side 2020 of the golf club head 2000 after being attached.

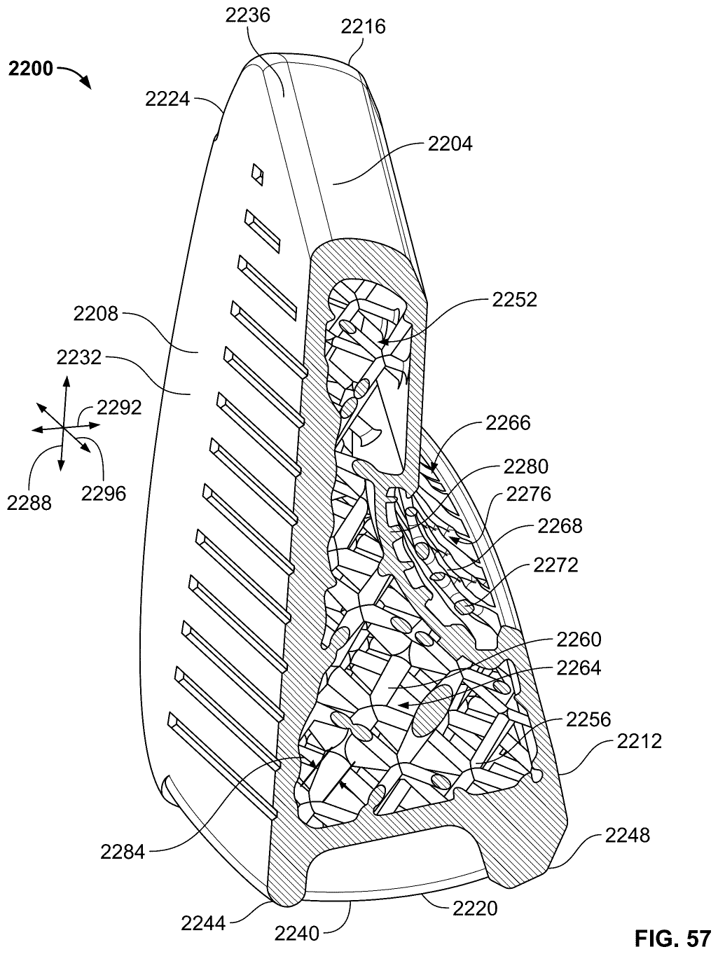

FIG. 57 illustrates a golf club head 2200 including a body 2204 that has a front side 2208 (e.g., a front surface), a rear side 2212 (e.g., a rear surface) that is opposite the front side 2208, a top side 2216 (e.g., a top surface), a bottom side 2220 (e.g., bottom surface) that is opposite the top side 2216, a toe side 2224, and a heel side (e.g., heel side 2028 as shown in FIG. 55) that is opposite the toe side 2224. FIG. 57 illustrates a cross-sectional view of the toe side 2224. The front side 2208 includes a front face 2232. The top side 2216 includes a topline 2236. The bottom side 2220 includes a sole 2240. The front side 2208 extends between the topline 2236 and the sole 2240. A leading edge 2244 extends along the bottom side 2220 and the front side 2208 in the heel-toe direction. The rear side 2212 extends between the topline 2236 and the sole 2240. A trailing edge 2248 extends along the bottom side 2220 and the rear side 2212 in the heel-toe direction.

The body 2204 defines an internal cavity 2252 that includes an internal support structure 2256. The internal support structure 2256 includes a plurality of beams 2260 that are interconnected to one another and define a plurality of voids 2264 that are interconnected to one another within the internal cavity 2252. Similarly, the internal cavity 2534 can be described as an interconnected void. Accordingly, the internal support structure 2256 may be referenced herein as a lattice structure, a segmented support structure, a scaffolding, a network of ribs, a web of ribs, or a complex geometric support structure.

The rear side 2212 of the body 2204 defines an external cavity 2266 includes an external support structure 2268. The external support structure 2268 includes a plurality of beams 2272 that are interconnected to one another and define a plurality of voids 2276 that are interconnected to one another within the external cavity 2266. Accordingly, the external support structure 2268 may be referenced herein as a lattice structure, a segmented support structure, a scaffolding, a network of ribs, a web of ribs, or a complex geometric support structure. The external support structure 2268 is separated from the internal support structure 2256 by a rear wall 2280 of the body 2204.

It is beneficial to have a support structure with a beam thickness that is varied throughout or across portions of the support structure for selectively distributing the mass of the golf club head 2200. Referring to FIG. 57, the plurality of beams 2272 of the internal support structure 2256 define a beam thickness 2284, which represents an outer dimension (e.g., diameter) of the beam that can be measured using calipers or similar measurement tools. In some embodiments, the beam thickness varies as a function of a distance of individual beams from a reference point or surface, e.g., the sole 2240, or the topline 2236, or the front face 2232, or the rear side 2212. In this way, the beam thickness 2284 varies in one or more directions as a function of a distance from the reference point or surface. It will be appreciated that the beam thickness 2284 is one of several properties or characteristics of the internal support structure 2252, which can be varied and configured to distribute mass in the golf club head 2200. Other properties or characteristics of the internal support structure 2256 include, but are not limited to, a beam length, a beam cross-sectional shape, a beam material, a beam density, unit cell size, unit cell shape, and unit cell density. One or more of the properties or characteristics of the internal support structure 2256 can be varied in addition to or in lieu of the beam thickness 2284.

In some instances, the beam thickness 2284 of the internal support structure 2256 can be varied to concentrate mass proximate the topline 2236, or proximate the sole 2240, which allows the center of gravity (CG) to be relocated or adjusted in a sole-topline direction 2288 from a default position associated with a solid configuration of the golf club head 2200. Concentrating mass proximate the topline 2236 by increasing beam thickness 2284 moves the center of gravity (CG) location to a higher position in the golf club head 2200 to be farther from the sole 2240. Similarly, concentrating mass proximate the sole 2240 by increasing beam thickness 2284 moves the center of gravity (CG) location to a lower position in the golf club head 2200 to be closer to the sole 2240.

In some instances, the beam thickness 2284 of the internal support structure 2256 can be varied to concentrate mass proximate the front face 2232, or proximate the rear side 2212, which allows the center of gravity (CG) to be relocated or adjusted in a front-rear direction 2292 from a default position associated with a solid configuration of the golf club head 2200. Concentrating mass proximate the front face 2232 by increasing beam thickness 2284 moves the center of gravity (CG) location to a forward position in the golf club head 2200 to be farther from the rear side 2212. Similarly, concentrating mass proximate the rear side 2212 by increasing beam thickness 2284 moves the center of gravity (CG) location to a rearward position in the golf club head 2200 to be closer to the rear side 2212.

In some instances, the beam thickness 2284 of the internal support structure 2256 can be varied to concentrate mass proximate the toe side 2224 or the heel side (not shown, but see 2028 in FIG. 55). In this way, the center of gravity (CG) location can be relocated or adjusted in a heel-toe direction 2296 from a default position associated with a solid configuration of the golf club head 2200.

Continuing with FIG. 57, the beam thickness 2284 of the internal support structure 2256 varies between about 0.75 mm and about 5.00 mm. In some embodiments, the beam thickness 2284 varies between about 0.20 mm and about 10.00 mm, about 0.40 mm and about 8.00 mm, or about 0.60 mm and about 6.00 mm. The beam thickness 2284 varies along the sole-topline direction 2288 and the heel-toe direction 2296. The total mass of the internal support structure 2256 depends in part on the head size and volume of the golf club. In some embodiments, the total mass of the internal support structure 2256 is between about 10.50 grams and about 11.50 grams.

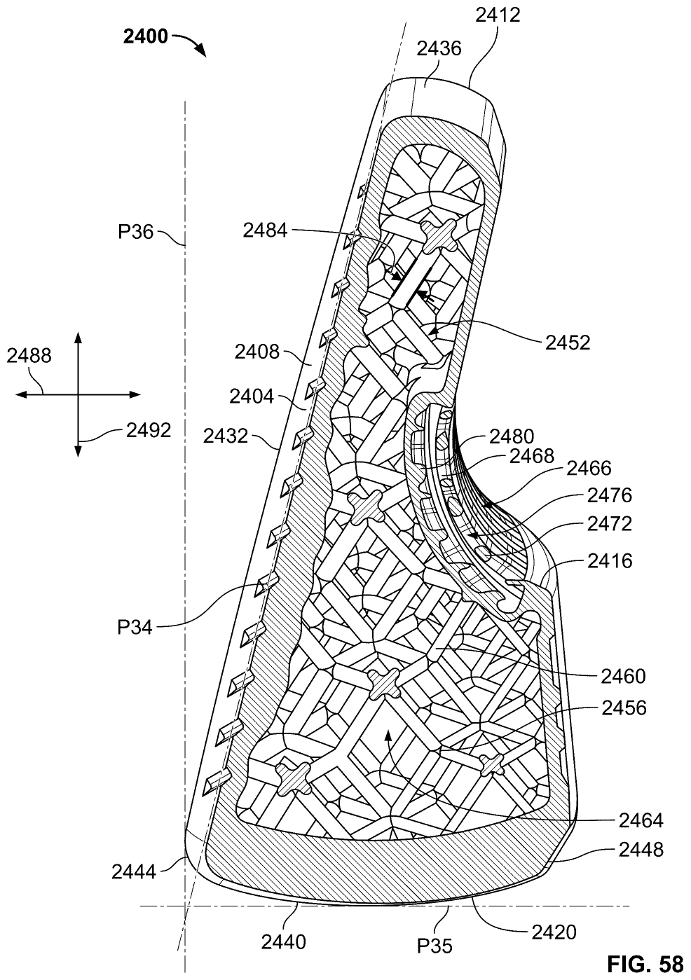

Now referring to FIG. 58, a golf club head 2400 is illustrated, which is one particular example of a golf club head that is similar to the golf club head 2200 illustrated in FIG. 57. The golf club head 2400 is described below as having a body with a support structure configuration.

Referring to FIG. 58, the golf club head 2400 includes a body 2404 that has a front side 2408 (e.g., a front surface), a top side 2412 (e.g., a top surface), a rear side 2416 (e.g., a rear surface) that is opposite the front side 2408, a bottom side 2420 (e.g., a bottom surface) that is opposite the top side 2412, a toe side (e.g., toc side 2016 shown in FIG. 55), and a heel side (e.g., heel side 2028 shown in FIG. 55) that is opposite the toe side. FIG. 58 illustrates a cross-sectional view of the toe side. The front side 2408 includes a front face 2432 along a face plane P34. The top side 2412 includes a topline 2436. The bottom side 2420 includes a sole 2440. The front side 2408 extends between the topline 2436 and the sole 2440. The rear side 2416 extends between the topline 2436 and the sole 2440. A leading edge 2444 extends along the bottom side 2420 and the front side 2408 in the heel-toe direction. A trailing edge 2448 extends along the bottom side 2420 and the rear side 2416 in the heel-toe direction. A ground plane P35 is tangent and coplanar with the sole 2440 when the golf club head 2400 is at address. A vertical plane P36 is tangent and coplanar with the leading edge 2444 and is orthogonal to the ground plane P35.

Continuing with FIG. 58, the body 2404 defines an internal cavity 2452 that includes an internal support structure 2456. The internal support structure 2456 includes a plurality of beams 2460 that are interconnected to one another and define a plurality of voids 2464 that are interconnected within the internal cavity 2452. Similarly, the internal cavity 2534 can be described as an interconnected void. Accordingly, the internal support structure 2456 may be referenced herein as a lattice structure, a segmented support structure, a scaffolding, a network of ribs, a web of ribs, or a complex geometric support structure.

The rear side 2416 of the body 2404 defines an external cavity 2466 includes an external support structure 2468. The external support structure 2468 includes a plurality of beams 2472 that are interconnected to one another and define a plurality of voids 2476 that are interconnected to one another within the external cavity 2466. Accordingly, the external support structure 2468 may be referenced herein as a lattice structure, a segmented support structure, a scaffolding, a network of ribs, a web of ribs, or a complex geometric support structure. The external support structure 2468 is separated from the internal support structure 2456 by a rear wall 2480 of the body 2404.

It is beneficial to have a support structure with a varying beam thickness as a function of a front-rear direction from a face plane. The support structure 2456 has a beam thickness 2484, which represents an outer dimension (e.g., a diameter) of the beam that can be measured using calipers or similar measurement tools. The beam thickness 2484 of the plurality of beams 2472 is constant proximate to and across the front face 2432 that is defined by the face plane P34. Further, the beam thickness 2484 decreases in a front-rear direction 2488 as a function of a distance from the face plane P34. The higher weight near the front side to allow for increase in stability of off-center hits. Continuing with FIG. 58, a beam thickness 2484 of the internal support structure 2456 varies as a function of distance from the face plane P34. For example, the beam thickness 2484 varies in the front-rear direction 2488 and is constant in the sole-topline direction 2492 (e.g., constant thickness across the face plane P34). The beam thickness 2484 is about 1.3 mm starting at the face plane P34 and reduces to about 0.7 mm at the rear side 2416. In some embodiments, the beam thickness is about 2 mm starting at the face plane P34 and reduces to about 0.2 mm at the rear side 2416. The beam thickness can range from 0.1 mm to 5 mm. The total mass of the internal support structure 2456 depends on the size and volume of the golf club head. In some embodiments, the total mass of the internal support structure 2456 is between about 10.5 grams and about 11.5 grams.

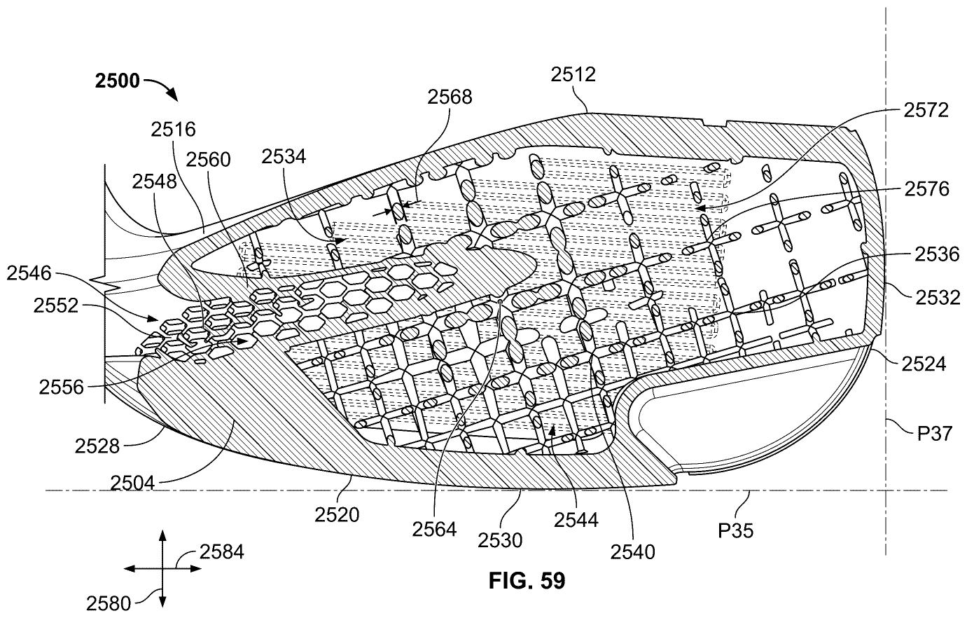

Now referring to FIG. 59, a golf club head 2500 is illustrated, which is one particular example of the golf club head 2200 illustrated in FIG. 57. The golf club head 2500 is described below as having a body 2504. As described further below, the golf club head 2500 is another lattice configuration.

Referring to FIG. 59, the golf club head 2500 includes the body 2504 having a front side (e.g., front side 2208 shown in FIG. 57), a top side 2512, a rear side 2516 opposite the front side, a bottom side 2520 opposite the top side 2512, a toe side 2524, and a heel side 2528 opposite the toe side 2524. A ground plane P35 is tangent and coplanar with a sole 2530 when the golf club head 2500 is at address. A Z plane P37 is tangent and coplanar with a toe edge 2532 and is orthogonal to the ground plane P35.

Continuing with FIG. 59, the body 2504 defines an internal cavity 2534 that includes an internal support structure 2536. The internal support structure 2536 includes a plurality of beams 2540 that are interconnected to one another and define a plurality of voids 2544 that are interconnected to one another within the internal cavity 2534. Similarly, the internal cavity 2534 can be described as an interconnected void. Accordingly, the internal support structure 2536 may be referenced herein as a lattice structure, a segmented support structure, a scaffolding, a network of ribs, a web of ribs, or a complex geometric support structure.

The rear side 2516 of the body 2504 defines an external cavity 2546 that includes an external support structure 2548. The external support structure 2548 includes a plurality of beams 2552 that are interconnected to one another and define a plurality of voids 2556 that are interconnected to one another within the external cavity 2546. Accordingly, the external support structure 2548 may be referenced herein as a lattice structure, a segmented support structure, a scaffolding, a network of ribs, a web of ribs, or a complex geometric support structure. The external support structure 2548 is separated from the internal support structure 2536 by a rear wall 2560 of the body 2504.

It is beneficial to include a support structure with one or more properties that varies as a function of a distance from a reference point, such as the geometric center of the body or the face, to manipulate or selectively adjust a location of the center of gravity (CG) of the golf club head. Continuing with FIG. 59, the body 2504 has a geometric center 2564 of a face (e.g., face 2432 in FIG. 58). The geometric center 2564 is located at the middle of a scoring area, 15 mm up from the ground plane P35 and can be somewhere along the ground plane in a front-rear direction (e.g., a front-rear direction 2488 in FIG. 58). As illustrated in FIG. 59, the geometric center 2564 is of a face in the front-rear direction. In other embodiments, the geometric center 2564 is at a halfway point in the front-rear direction. A beam thickness 2568 of the internal support structure 2536 varies as a function of distance from the geometric center 2564 in one or more directions. The internal support structure 2536 defines a unit cell 2572 with a size of about 11.9 mm by about 11.9 mm by about 11.9 mm with a bend radius 2576 of about 0.15 mm. The beam thickness 2568 varies in a sole-topline direction 2580 from the geometric center 2564 and in a heel-toe direction 2584 from the geometric center 2564, starting at about 2.75 mm proximate the geometric center 2564 and reducing to about 0.8 mm. The total mass of the internal support structure 2536 depends on the golf club head size and volume. In some embodiments, the total mass of the internal support structure 2536 is between about 10.5 and about 11.5 grams.

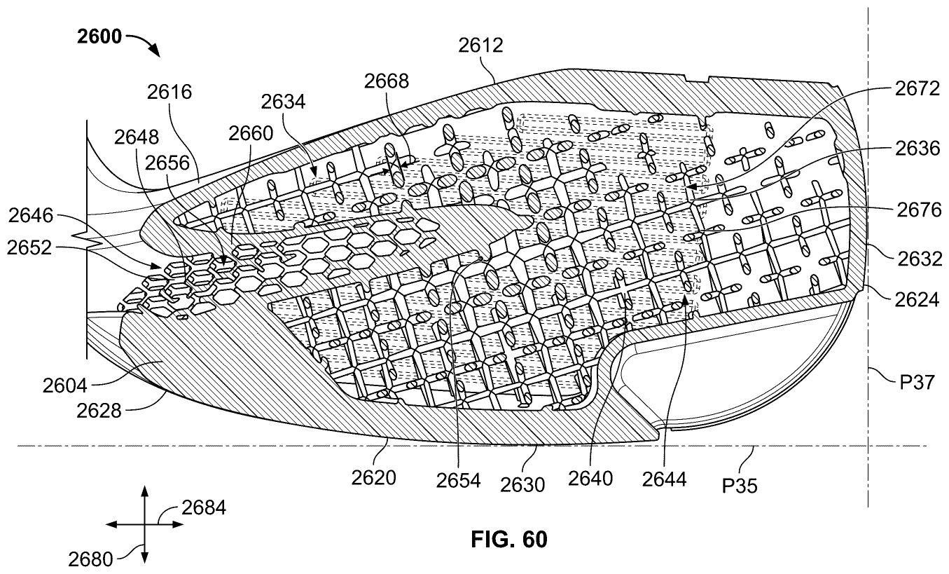

Now referring to FIG. 60, a golf club head 2600 is illustrated, which is one particular example of the golf club head 2200 illustrated in FIG. 57. The golf club head 2600 is described below as having a body 2604. As described further below, the golf club head 2600 is another lattice configuration.

Continuing with FIG. 60, the golf club head 2600 includes the body 2604 having a front side (e.g., front side 2208 shown in FIG. 57), a top side 2612, a rear side 2616 opposite the front side, a bottom side 2620 opposite the top side 2612, a toe side 2624, and a heel side 2628 opposite the toe side 2624. A ground plane P35 is tangent and coplanar with a sole 2630 when the golf club head 2600 is at address. A Z plane P37 is tangent and coplanar with a toe edge 2632 and is orthogonal to the ground plane P35.

The body 2604 defines an internal cavity 2634 that includes an internal support structure 2636. The internal support structure 2636 includes a plurality of beams 2640 that are interconnected to one another and define a plurality of voids 2644 that are interconnected to one another within the internal cavity 2634. Similarly, the internal cavity 2634 can be described as an interconnected void. Accordingly, the internal support structure 2636 may be referenced herein as a lattice structure, a segmented support structure, a scaffolding, a network of ribs, a web of ribs, or a complex geometric support structure.

The rear side 2616 of the body 2604 define an external cavity 2646 that includes an external support structure 2648. The external support structure 2648 includes a plurality of beams 2652 that are interconnected to one another and define a plurality of voids 2656 that are interconnected to one another within the external cavity 2646. Accordingly, the external support structure 2648 may be referenced herein as a lattice structure, a segmented support structure, a scaffolding, a network of ribs, a web of ribs, or a complex geometric support structure. The external support structure 2648 is separated from the internal support structure 2636 by a rear wall 2660 of the body 2604.

As described above, it is beneficial to construct a golf club head with a support structure that varies in one or more properties or characteristics as a function of a distance from a geometric center to manipulate the center of gravity (CG) location of the golf club head in ways that influence a performance, such as, e.g., a ball's launch characteristics. Continuing with FIG. 60, the body 2604 has a geometric center 2654 of a face (e.g., face 2432 in FIG. 58). The geometric center 2654 is located at the middle of a scoring area, 15 mm up from the ground plane P35 and can be somewhere along the ground plane in a front-rear direction (e.g., a front-rear direction 2488 in FIG. 58). As illustrated in FIG. 60, the geometric center 2654 is located on the face of the body 2604 in the front-rear direction. In other embodiments, the geometric center 2654 is at a halfway point in the front-rear direction. A beam thickness 2668 of the internal support structure 2636 varies as a function of distance from the geometric center 2654. The internal support structure 2636 is configured as a cell 2672 with a size of about 10.1 mm by about 10.1 mm by about 10.1 mm with a bend radius 2676 of about 0.15 mm. The beam thickness 2668 varies in a sole-topline direction 2680 from the geometric center 2654 and in a heel-toe direction 2684 from the geometric center 2654, starting at about 2 mm proximate the geometric center 2654 and reducing to about 0.75 mm. The total mass of the internal support structure 2636 depends on the size and volume of the golf club head. In some embodiments, the total mass of the internal support structure 2636 is between about 10.5 and about 11.5 grams.

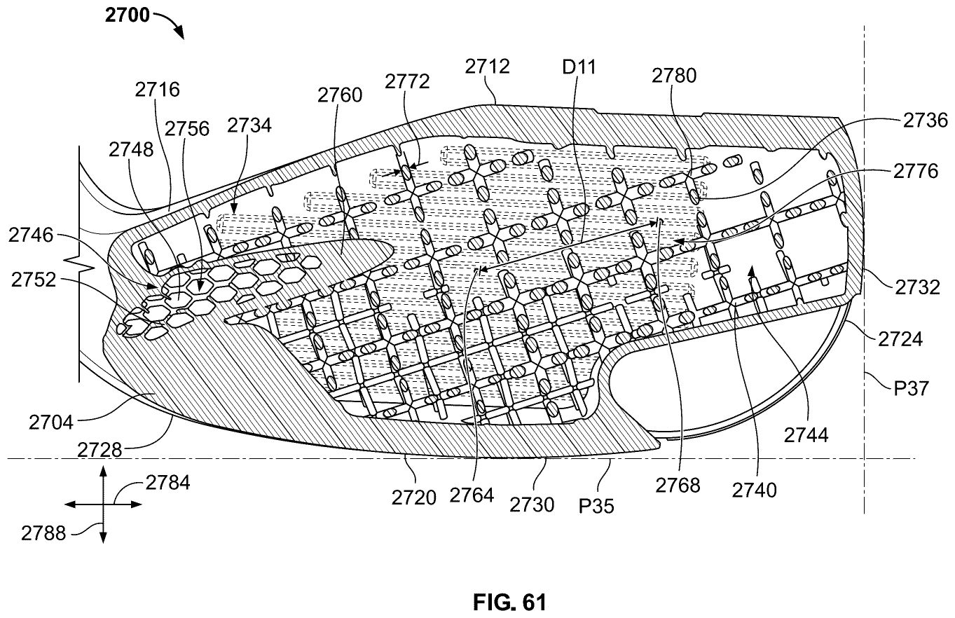

Now referring to FIG. 61, a golf club head 2700 is illustrated, which is one particular example of the golf club head 2200 illustrated in FIG. 57. The golf club head 2700 is described below as having a body 2704. As described further below, the golf club head 2700 is another lattice configuration.

Continuing with FIG. 61, the golf club head 2700 includes the body 2704 having a front side (e.g., front side 2208 shown in FIG. 57), a top side 2712, a rear side 2716 opposite the front side, a bottom side 2720 opposite the top side 2712, a toe side 2724, and a heel side 2728 opposite the heel side 2728. A ground plane P35 is tangent and coplanar with a sole 2730 when the golf club head 2700 is at address. A Z plane P37 is tangent and coplanar with a toe edge 2732 and is orthogonal to the ground plane P35.

The body 2704 defines an internal cavity 2734 that includes an internal support structure 2736. The internal support structure 2736 includes a plurality of beams 2740 that are interconnected to one another and define a plurality of voids 2744 that are interconnected within the internal cavity 2734. Similarly, the internal cavity 2734 can be described as an interconnected void. Accordingly, the internal support structure 2736 may be referenced herein as a lattice structure, a segmented support structure, a scaffolding, a network of ribs, a web of ribs, or a complex geometric support structure.

The rear side 2716 of the body 2704 defines an external cavity 2746 that includes an external support structure 2748. The external support structure 2748 includes a plurality of beams 2752 that are interconnected to one another and define a plurality of voids 2756 that are interconnected within the external cavity 2746. Accordingly, the external support structure 2748 may be referenced herein as a lattice structure, a segmented support structure, a scaffolding, a network of ribs, a web of ribs, or a complex geometric support structure. The external support structure 2748 is separated from the internal support structure 2736 by a rear wall 2760 of the body 2704.

It is beneficial to have a support structure with one or more properties that vary as a function of a distance relative to two reference points. This is another example of manipulating the center of gravity (CG) location of a golf club head to adjust or tune the golf club head's performance, which is useful for achieving desired or improved golf ball launch characteristics. Continuing with FIG. 61, the body 2704 has a geometric center 2764 of a face (e.g., face 2432 in FIG. 58) and a toe point 2768. The geometric center 2764 is located at the middle of a scoring area, 15 mm up from the ground plane P35 and can be somewhere along the ground plane in a front-rear direction (e.g., a front-rear direction 2488 in FIG. 58). As illustrated in FIG. 61, the geometric center 2764 is located on the face of the body 2704 in the front-rear direction. In other embodiments, the geometric center 2764 is at a halfway point in the front-rear direction. The location of the toe point 2768 may be selected by a user via a graphical user interface (GUI) of a computer-aided design (CAD) program, or the toe point 2768 may be determined by operation of an algorithm of the CAD program, or the toe point 2768 may be determined by a combination of user and algorithmic input. The location of the toe point 2768 and geometric center 2764 can be selected or customized based on a variety of parameters, including club type, user information, fit data, or combinations thereof. As illustrated in FIG. 61, the location of the toe point 2768 is halfway between the geometric center 2764 and the Z plane P37 and halfway between the front-rear direction along the ground plane P35. A beam thickness 2772 of the internal support structure 2736 varies as a function of a distance D11 from the geometric center 2764 and the toe point 2768. The internal support structure 2736 is configured as a unit cell 2776 with a size of about 11 mm by about 11 mm by about 11 mm with a bend radius 2780 of about 0.15 mm. The beam thickness 2772 varies in a sole-topline direction 2784 from the distance D11 and in a heel-toe direction 2788 from the distance D11, starting at 1.6 mm proximate the geometric center 2764 and reducing to about 0.89 mm. The total mass of the internal support structure 2736 depends on the size and volume of the golf club head. In some embodiments, the total mass of the internal support structure 2736 is between about 10.5 and about 11.5 grams.

Any of the embodiments described herein may be modified to include any of the structures or methodologies disclosed in connection with different embodiments. Further, the present disclosure is not limited to golf clubs of the type specifically shown. Still further, aspects of the golf club heads of any of the embodiments disclosed herein may be modified to work with any type of golf club.

As noted previously, it will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the same. The exclusive rights to all modifications which come within the scope of the appended claims are reserved.

We claim:

1. A golf club including a golf club head, the golf club head comprising:
a body, the body defining an internal cavity, the body including a toe side, a heel side, a top side, a bottom side, a front side and a rear side; and
a first support structure disposed within the internal cavity of the body, the first support structure including a plurality of beams;
a second support structure disposed within an external cavity that is positioned on the rear side of the body, the second support structure being visible from an exterior of the body;
at least one pocket that is formed on the bottom side of the body; and
at least one aperture that extends through the body and is in fluid communication with the internal cavity of the body.

2. The golf club of claim 1, wherein the at least one pocket is at least partially defined by a wall, and wherein the at least one aperture extends through the wall of the at least one pocket.

3. The golf club of claim 2, wherein the at the least one pocket and the at least one aperture are both located in a toe region of the golf club head, such that a distance between a toe edge and the aperture is smaller than a distance between a heel edge and the aperture.

4. The golf club of claim 1, wherein the at least one pocket has a first pocket and a second pocket, wherein the at least one aperture has a first aperture having a first diameter in the first pocket and a second aperture having a second diameter in the second pocket, and the first and second diameters are equal.

5. The golf club of claim 4, wherein the first diameter and the second diameter are between about 1 millimeter and about 5 millimeters.

6. The golf club of claim 1, wherein the at least one pocket has a first pocket and a second pocket, wherein the at least one aperture has a first aperture having a first diameter in the first pocket, a second aperture having a second diameter in the second pocket, and the first and second diameters are not equal.

7. The golf club of claim 5, wherein the first diameter is greater than the second diameter.

8. The golf club of claim 1, wherein at least one aperture is configured for removal of excess powdered material from within the internal cavity.

9. The golf club of claim 8, wherein the excess powdered material is powdered metal that is deposited during an additive manufacturing process.

10. The golf club of claim 8, wherein the excess powdered material has a density that is substantially equal to a density of a material used to form the body.

11. The golf club of claim 8, wherein the excess powdered material has a density that is different from a density used to form a face plate.

12. The golf club of claim 8, wherein the excess powdered material has a density that is different from a density used to form a weight element that is configured to be received within at least one pocket.

13. The golf club of claim 1, wherein at least one aperture has a first aperture and a second aperture, wherein one of the first and second apertures is configured as an inlet and the other is configured as an outlet, and wherein a pressurized fluid is configured to be introduced at the inlet to remove excess powdered material within the internal cavity through the outlet.

14. The golf club of claim 13, wherein the pressurized fluid is at least one of a gas, a fluid, or an abrasive media.

15. The golf club of claim 1, wherein the at least pocket has a first pocket and a second pocket, wherein a conduit extends from the first pocket to the second pocket, the conduit being configured to receive a filler material that is introduced in at least one of the first pocket or the second pocket.

16. The golf club of claim 1, wherein the at least one pocket has a first pocket and a second pocket, the first pocket is a toe pocket located in a toe region and the second pocket is a heel pocket located in a heel region, and wherein a toe cap is configured to be attached to the toe pocket to retain a first weight element and a heel cap is configured to be attached to the heel pocket to retain a second weight element.

17. The golf club of claim 16, wherein the toe pocket is configured to receive the first weight element, wherein the heel pocket is configured to receive the second weight element, and wherein each of the first weight element and the second weight element has a density that is greater than a density of a material that defines the body.

18. The golf club of claim 16, wherein the toe cap includes at least one cap opening extending therethrough, and wherein the weight element is configured to be introduced into the toe pocket through the cap opening.

19. The golf club of claim 16, wherein the heel cap includes at least one cap opening extending therethrough, and wherein the weight element is configured to be introduced into the heel pocket through the cap opening.

20. A golf club including a golf club head, the golf club head comprising:
a body, the body defining an internal cavity, the body including a toe side, a heel side, a top side, a bottom side, a front side and a rear side; and
a first support structure disposed within the internal cavity of the body, the first support structure including a plurality of beams;
a second support structure disposed within an external cavity that is positioned on the rear side of the body, the second support structure being visible from an exterior of the body;
a toe pocket and a heel pocket that are formed on the bottom side of the body, wherein the toe pocket is at least partially defined by a first wall and the heel pocket is at least partially defined by a second wall; and
a first aperture and a second aperture in fluid communication with the internal cavity of the body, wherein each of the first aperture and second aperture extends through the first wall of the toe pocket.

21. A golf club including a golf club head, the golf club head comprising:
a body, the body defining an internal cavity, the body including a toe side, a heel side, a top side, a bottom side, a front side and a rear side; and
a first support structure disposed within the internal cavity of the body, the first support structure including a plurality of beams;
a second support structure disposed within an external cavity that is positioned on the rear side of the body, the second support structure being visible from an exterior of the body;
a toe pocket and a heel pocket that are formed on the bottom side of the body, wherein the toe pocket is at least partially defined by a first wall and the heel pocket is at least partially defined by a second wall; and
a toe cap that is configured to be attached to the toe pocket to retain a first weight element and a heel cap that is configured to be attached to the heel pocket to retain a second weight element, wherein the toe cap has a toe cap opening that is in fluid communication with the toe pocket and a heel cap has a heel cap opening that is in fluid communication with the heel pocket.

22. The golf club of claim 21, wherein the toe pocket is configured to receive the first weight element, wherein the heel pocket is configured to receive the second weight element, wherein each of the first weight element and the second weight element has a density that is greater than a density of a material that defines the body.

23. The golf club of claim 22, wherein the weight element is configured to be introduced into the toe pocket through the toe cap opening.

24. The golf club of claim 22, wherein the weight element is configured to be introduced into the heel pocket through the heel cap opening.

25. The golf club of claim 22, wherein the weight element is a viscous fluid that comprises tungsten and polymer, and wherein the viscous fluid is configured to be injected into the toe pocket and the heel pocket in a fluid state.

26. The golf club of claim 22, wherein a heat treatment process is configured to cure the weight elements.

27. The golf club of claim 21, wherein the toe cap and the heel cap are formed with the body as a unitary structure.

28. The golf club of claim 21, wherein the toe cap and the heel cap are formed separately from and attached to the body.
